(19) United States
(12) Patent Application Publication
(10) Pub. No.: US 2012/0286057 A1
(43) Pub. Date: Nov. 15, 2012

(54) ISOLATION OF PRODUCT AND PROPELLANT IN VARIOUS DISPENSING DEVICES AND PLATFORMS ("FLAIRFRESH")

(75) Inventors: Wilhelmus Johannes Joseph MAAS, Someren (NL); Petrus Lambertus Wilhelmus HURKMANS, Someren (NL); Paolo NERVO, Duizel (NL); Aaron S. HALEVA, Oakhurst, NJ (US)

(73) Assignee: Dispensing Technologies B.V., DN Helmond (NL)

(21) Appl. No.: 13/467,971

(22) Filed: May 9, 2012

Related U.S. Application Data
(60) Provisional application No. 61/518,677, filed on May 9, 2011.
(60) Provisional application No. 61/595,472, filed on Feb. 6, 2012.
(60) Provisional application No. 61/623,492, filed on Apr. 12, 2012.

(51) Int. Cl. A01G 25/09; A62C 11/00

(52) U.S. Cl. 239/1; 239/333

(57) ABSTRACT

Dispensing platforms, both manually operated and motion sensor based, are presented. Such devices incorporate two components: (i) “Flair” “bag within a bag” technology, and (ii) a OnePak™ dispensing head (normally closed outlet valve). Such platforms can be overpressure or underpressure based, and can interface with various Flair™ bottles. In exemplary systems (i) the fluid or other dispensate, and (ii) the propellant, whether a fluid, a gas, air or other, are provided in completely separated circuits, controlled separately, and only optionally mixed at final dispensing, downstream of the outlet valve. A propellant can be used for other ancillary functions, such as cleaning a spout or output channel, making foam or spray, controlling valves, pistons, pumps, making noise, etc.

### CROSS-REFERENCE TO RELATED APPLICATIONS

This application claims the benefit of U.S. Provisional Patent Application No. 61/518,677, filed on May 9, 2011, 61/595,472 filed Feb. 6, 2012, and 61/623,492 filed Apr. 12, 2012, and also claims priority to U.S. Utility patent application Ser. No. 13/289,874, filed Nov. 4, 2011. The disclosures of each of these patent applications are hereby incorporated herein by reference.

### TECHNICAL FIELD

The present invention relates to dispensing technologies, and in particular to various dispensing platforms and devices, both metered and non-metered, such as used in air freshening, condiment dispensing, cleaner, soap and foam dispensing, toilet seat cleaning, and sanitizing contexts where the dispensate and the propellant are separately controlled.

### BACKGROUND OF THE INVENTION

In traditional dispensing systems liquid and air are uncontrolled. They are often mixed in a dispensing head, and in the container or reservoir air enters by reventing, such as, for example, in standard sprayers for window cleaner, lubricants, polishes and the like, hose end sprayers, etc. This causes degradation of whatever is being dispensed, as it continually mixes with surrounding air, or a propellant.

Moreover, valves in such devices are normally open due to the fact that the pump will not prime if there is air inside it. Additionally, users can separate a bottle or reservoir from a sprayer, for example, and refill it with any product of their choice, including those not intended for a given dispenser, and which may even damage it.

Finally, because a propellant is allowed of mix with the dispensed product, in actuality this propellant is not truly controlled, and certainly not precisely. Thus, it cannot really be used for any other purpose than reventing a reservoir bottle.

What are needed in the art are novel dispensing systems that overcome these problems.

### SUMMARY OF THE INVENTION

In exemplary embodiments of the present invention platforms from which various dispensing devices, both manually operated as well as “touch-less” (motion sensor based) are presented. Such exemplary devices incorporate two main components: (i) the “bag within a bag” Flair® technology, and (ii) a OnePak type dispensing head (with a normally closed outlet valve). Such platforms can be, for example, overpressure based or underpressure based, can have various application based features, and can interface with various exemplary Flair type bottles. Exemplary embodiments described herein relate to dispensing systems where (i) the fluid or other dispensate to be dispensed, and (ii) the propellant used to dispense it, whether said propellant is a fluid, a gas, air at atmospheric pressure, or other, are completely separated in separate circuits, controlled separately, and only optionally mixed at the final dispensing time, if desired, at a point downstream of the normally closed outlet valve. Additionally, in such devices the propellant can be used for other ancillary functions, such as, for example, cleaning a spout or output channel, making foam or spray, controlling valves, pistons, pumps, making noise, and the like. Certain of such exemplary systems utilize a unique bottle in the dispensing appliance which (i) cannot be replaced by a competitor's, or other third party's bottle which also (ii) cannot be refilled by a consumer.

### BRIEF DESCRIPTION OF THE DRAWINGS

FIG. 1 illustrates a separate control of propellant or venting media, and dispensate or liquid, according to exemplary embodiments of the present invention;

FIG. 2 further illustrates the principles of FIG. 1;

FIG. 3 illustrates dispensing using an over-pressure system according to exemplary embodiments of the present invention;

FIG. 4 illustrates dispensing using an under-pressure system according to exemplary embodiments of the present invention;

FIG. 5 illustrates the effect of surrounding pressure on a gas-containing liquid according to exemplary embodiments of the present invention;

FIG. 6 illustrates the need for a dip tube in conventional dispensing systems and the absence of a similar requirement according to exemplary embodiments of the present invention;

FIG. 7 illustrates upside down dispensing according to exemplary embodiments of the present invention;

FIG. 8 illustrates balancing pressures on either side of a membrane used as an outlet valve according to exemplary embodiments of the present invention;

FIG. 9 illustrates controlling of valves through precompression or pretension, according to exemplary embodiments of the present invention;

FIG. 10 illustrates cleaning a dispensing spout using propellant following a dispensing cycle according to exemplary embodiments of the present invention;

FIG. 11 illustrates a combination of various platforms to create multiple applications according to exemplary embodiments of the present invention;

FIG. 12 illustrate metered over-pressure systems and parallel or analogous metered under-pressure systems according to exemplary embodiments of the present invention;

FIG. 13 illustrate exemplary positioning of inlet valves according to exemplary embodiments of the present invention;

FIG. 14 illustrate the use of restrictions in both propellants and dispensates according to exemplary embodiments of the present invention;

FIG. 15 illustrate various output states obtained by non-mixing and mixing the previously separated propellant and liquid according to exemplary embodiments of the present invention;

FIG. 16 illustrate systems with a normally closed outlet valve according to exemplary embodiments of the present invention;

FIG. 17 illustrate an exemplary “One-Pak” type over-pressure dispenser according to exemplary embodiments of the present invention;

FIG. 18 illustrate various additional details of the dispenser of FIG. 17;

FIG. 19 provide detail of an exemplary nozzle of the over-pressure dispenser of FIGS. 17 through 18 and its functionality;

FIG. 20 illustrate an overview of an exemplary air freshener device according to exemplary embodiments of the present invention;

FIG. 21 illustrates an exemplary One-Pak type under-pressure dispenser according to exemplary embodiments of the present invention;

FIG. 22 provide additional details of the under-pressure dispenser of FIG. 21;

FIG. 23 provides yet additional details of the exemplary under-pressure dispenser of FIGS. 21 and 22;

FIG. 24 provides nozzle detail of the exemplary under-pressure dispenser of FIGS. 21 through 23;

FIG. 25 illustrate the detailed channel grooves according to exemplary embodiments of the present invention for under-pressure dispensers;

FIG. 26 is a summary of various dispensing system and corresponding product possibilities in over-pressure systems according to exemplary embodiments of the present invention;

FIG. 27 illustrate various air freshener, sanitizer and soap/foam dispenser platforms according to exemplary embodiments of the present invention;

FIG. 28 shows how such dispensing device platforms can be transformed to a variety of applications/solutions;

FIG. 29 illustrate an exemplary air freshener platform according to exemplary embodiments of the present invention;

FIG. 30 illustrate an exemplary piston actuation with no release membrane over-pressure system for metered mixed output, according to exemplary embodiments of the present invention;

FIG. 31 illustrate an exemplary piston actuation with release membrane system, otherwise similar to those shown in FIG. 30;

FIG. 32 illustrate an exemplary actual metered mixed dispenser to implement the exemplary system of FIG. 31;

FIG. 33 illustrates manually operated soap/foam dispensers according to exemplary embodiments of the present invention;

FIG. 34 illustrate over-pressure based metered mix dispensing systems according to exemplary embodiments of the present invention with manually operated air pumps;

FIG. 35 illustrate an exemplary actual dispenser for overpressure based metered mixed product systems with release membrane;

FIG. 36 illustrate piston actuation with no release membrane over-pressure based metered liquid only dispensing systems;

FIG. 37 illustrate piston actuation with a release membrane for metered liquid only over-pressure systems according to exemplary embodiments of the present invention;

FIG. 38 illustrate an exemplary actual dispenser for metered liquid only over-pressure based dispensing systems;

FIG. 39 illustrate manual air pump with release membrane metered liquid only over-pressure based dispensing systems according to exemplary embodiments of the present invention;

FIG. 40 shows an actual exemplary dispenser for metered liquid only over-pressure based metered dispensing systems (air exhausts from under piston) according to exemplary embodiments of the present invention;

FIG. 41 illustrate manually operated dispensers for soap/shaving foam/gel according to exemplary embodiments of the present invention;

FIG. 42 illustrates additional details of the exemplary systems of FIG. 41;

FIG. 43 shows a refill operation for the exemplary dispensers of FIGS. 41-42 according to exemplary embodiments of the present invention;

FIG. 44 illustrate non-metered liquid over-pressure dispensing systems with release valve actuation and pressure sensors according to exemplary embodiments of the present invention;

FIG. 45 illustrate exemplary systems similar to those of FIG. 44 except using a needle type outlet valve;

FIG. 46 illustrate a variant of the exemplary systems of FIG. 44 which uses micro switch actuation and no pressure sensor;

FIG. 47 illustrate a variant of the exemplary systems of FIG. 44 which uses micro switch actuation and no pressure sensor;

FIG. 48 non-metered mixed liquid/air over-pressure dispensing systems with release valve actuation and pressure sensors according to exemplary embodiments of the present invention;

FIG. 49 illustrate a variant to the exemplary system of FIG. 48 with micro switch actuation and no pressure sensor;

FIG. 50 summarizes the various types of liquid and mixed dispensates that can be produced using under-pressure systems according to exemplary embodiments of the present invention;

FIG. 51 illustrates an exemplary under-pressure system generating a metered mixed output with piston actuation and no release membrane according to exemplary embodiments of the present invention;

FIG. 52 illustrates various types of closures and how they are inter-operable with over-pressure dispensers, under-pressure dispensers, and trigger sprayer dispensing heads and various exemplary embodiments of the present invention;

FIG. 53 illustrate a bottle closure with an exemplary shuttle inlet valve according to exemplary embodiments of the present invention;

FIG. 54 illustrate how the closure with exemplary shuttle inlet valve precludes both refilling in unauthorized ways and also prevents unwanted output or leakage according to exemplary embodiments of the present invention;

FIG. 55 illustrate details of the exemplary closure with shuttle inlet valve;

FIG. 56 illustrate the use of a closure with shuttle inlet valve interfacing with an over-pressure pump type dispensing head according to exemplary embodiments of the present invention;

FIG. 57 illustrate a closure with exemplary shuttle inlet valve interfacing with an exemplary trigger sprayer under-pressure type pump according to exemplary embodiments of the present invention;

FIG. 58 illustrate exemplary dimensions of an exemplary closure with a shuttle inlet valve according to exemplary embodiments of the present invention;

FIG. 59 illustrate further details of interfacing dimensions of an exemplary closure with a shuttle inlet valve according to exemplary embodiments of the present invention;

FIG. 60 illustrate an exemplary closure with a normally closed valve according to exemplary embodiments of the present invention;

FIG. 61 provide exemplary dimensions of the exemplary closure with normally closed valve depicted in FIG. 60;

FIG. 62 illustrate an exemplary closure with normally closed valve interfacing with a dispenser (and its interface feature) according to exemplary embodiments of the present invention;

FIG. 63 illustrate exemplary interfacing dimensions of the exemplary closure with normally closed valve shown in FIG. 62;

FIG. 64 illustrates the no unwanted output feature of the exemplary closure with normally closed valve; and

FIG. 65 illustrate how the bottle or closure with normally closed valve is impervious to air entering the inside layer which thus prevents sag;

FIG. 66 illustrate how the closure with normally closed valve according to exemplary embodiments of the present invention can interface with either an over-pressure or an under-pressure type dispensing head;

FIG. 67 illustrates an exemplary trigger Flair dispensing device according to exemplary embodiments of the present invention;

FIG. 68 illustrate interfacing the exemplary closure with normally closed valve with either over-pressure and under-pressure type pumps according to exemplary embodiments of the present invention;

FIG. 69 illustrate a preform for, and fully blown, multi-liquid Flair type bottle, here having two liquids, according to exemplary embodiments of the present invention;

FIG. 70 illustrate various layers of the preform shown in FIG. 69A and how it is assembled according to exemplary embodiments of the present invention;

FIG. 71 illustrate filling operations for the exemplary multi-liquid bottle shown in FIG. 69B according to exemplary embodiments of the present invention; and

FIG. 72 illustrate the use of multi-liquid Flair type bottles in the abstract and in a Paint Flair type dispensing system according to exemplary embodiments of the present invention.

It is noted that the patent or application file may contain at least one drawing executed in color. If that is the case, copies of this patent or patent application publication with color drawing(s) will be provided by the U.S. Patent and Trademark Office upon request and payment of the necessary fee.

### DETAILED DESCRIPTION OF THE INVENTION

In exemplary embodiments of the present invention platforms from which various dispensing devices, both manually operated as well as “touch-less” (motion sensor based) are presented. Such exemplary devices incorporate two main components: (i) the “bag within a bag” Flair® technology, and (ii) a OnePak type dispensing head (with a normally closed outlet valve). Such platforms can be, for example, overpressure based or underpressure based, can have various application based features, and can interface with various exemplary Flair type bottles. Exemplary embodiments described herein relate to dispensing systems where (i) the fluid or other dispensate to be dispensed, and (ii) the propellant used to dispense it, whether said propellant is a fluid, a gas, air at atmospheric pressure, or other, are completely separated in separate circuits, controlled separately, and only optionally mixed at the final dispensing time, if desired, at a point downstream of the normally closed outlet valve. Additionally, in such devices the propellant can be used for other ancillary functions, such as, for example, cleaning a spout or output channel, making foam or spray, controlling valves, pistons, pumps, making noise, and the like. Certain of such exemplary systems utilize a unique bottle in the dispensing appliance which (i) cannot be replaced by a competitor's, or other third party's bottle which also (ii) cannot be refilled by a consumer.

It is noted that Flair® technology generally involves various bag in bag, inner container/outer container, or bag in bottle devices integrally molded from one or more performs in which a displacing medium (propellant) can be introduced between the outer container and the inner container so as to empty the contents of the inner container without said contents ever coming in contact with the displacing medium. Flair® Technology also includes valves, nozzles, pumps and other parts and ancillary equipment used in connection with such bag in bag, bag in bottle, or inner container/outer container technologies. The inner container is generally provided with a fluid to be dispensed. As noted, the present invention is directed to various uses of Flair® technology as applied to various dispensing systems where the propellant and the fluid are provided in separate circuits, are separately controlled, and do not interact except possibly optionally, when a mix of propellant and fluid is desired in a spout or outlet channel to generate a foam, dense foam or atomized spray. Further, in such exemplary systems, the propellant can also be used to control a variety of unctions, such as (i) activate a pump, (ii) control valves, such as an outlet valve; (iii) make noise when fluid is dispensed (as a signal or alarm to a user); (iv) clean an outlet line or spout, etc.

In exemplary embodiments of the present invention, precisely because the propellant (or venting medium) and the fluid to be dispensed are separated from each other, a dispensing system (and its designers) can “do anything it likes” with the propellant. This represents a significant advance over prior art systems.

In traditional dispensing systems liquid and air are uncontrolled. They are often mixed in a dispensing head, and in the container or reservoir air enters by reventing, such as, for example, in standard sprayers for window cleaner, lubricants, polishes and the like, hose end sprayers, etc. Valves in such devices are normally open due to the fact that the pump will not prime if there is air inside it. In exemplary embodiments of the present invention a different approach can be taken.

In such exemplary embodiments, described below, both the fluid and the propellent/venting medium can be separately controlled. Dispensing systems can exploit both the Flair technology for bottles and the OnePak type dispensing heads (both provided by assignee hereof, Dispensing Technologies of Helmond, The Netherlands). Such OnePak type dispensing heads, as referred to herein, have no springs in their pump or pumping device. Thus, in such dispensing heads, in a compression stroke, the volume of the liquid chamber is completely dead (zero), and air is completely removed from the dispenser. Additionally, in such systems, inlet and outlet valves are normally closed, and they only open upon application of a minimum given pressure. “Flair” and “OnePak” are trademarks used by assignee hereof.

Details of various exemplary dispensing systems and devices are next described in connection with the various figures. As noted, exemplary embodiments described herein relate to dispensing systems where (i) the liquid or other dispensate to be dispensed, and (ii) the propellant used to dispense it, whether a propellant medium, or air at atmospheric pressure, are completely separated in separate hydraulic circuits, and only mixed at the final dispensing time, if desired, at a point downstream of a normally closed outlet valve. Additionally, in such devices the propellant can be used for other ancillary functions, such as, for example, cleaning a spout or output channel, making foam or spray, controlling a pump, controlling valves and pistons and the like. It is further noted that certain of such exemplary systems utilize a unique “captive” Flair bottle that has an integrated one way valve, and thus (i) cannot be replaced in an exemplary system by a competitor's—or other third party's—bottle, and which also (ii) cannot be refilled by a consumer. In these exemplary embodiments the Flair bottle is always over pressured, and these are termed “overpressure” systems. It is also noted that for each such overpressure system an analogous “underpressure” system also exists, with different relative advantages and disadvantages. Such underpressure systems are also described.

Basic Components and Functionalities of Dispensing Systems

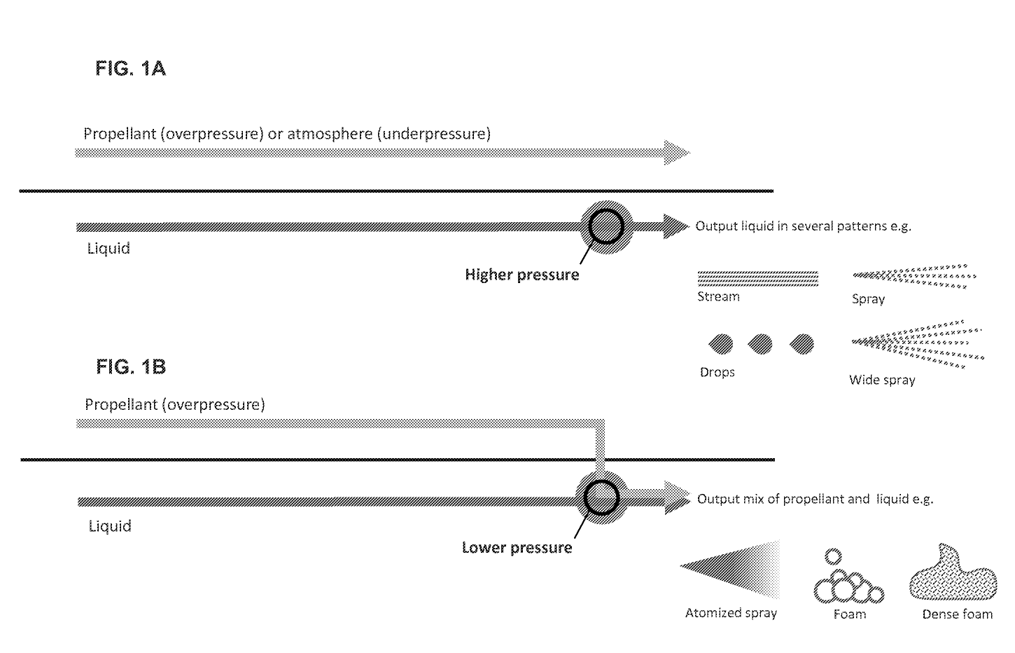

FIGS. 1 through 16 illustrate various basic functionalities for dispensing devices and systems according to various exemplary embodiments of the present invention.

With reference to FIG. 1, FIG. 1A illustrates a complete separation of the propellant and the liquid in exemplary embodiments of the present invention. As noted, in dispensing devices according to various exemplary embodiments of the present invention precise and separate control of the propellant and the liquid, and their only being combined when it is useful for the dispensing technology in question, is a desideratum. Thus, in FIG. 1A a propellant, which can be a pressurized gas, fluid, or the like, in the case of an over-pressure system, or air at atmospheric pressure in an under-pressure system, can be maintained separately from a liquid or other dispensate. The liquid can be output in a variety of patterns such as, for example, a stream, a spray, a wide spray, drops or droplets. To do this requires a relatively higher pressure than a mixed output such as shown in FIG. 1B. With reference thereto, FIG. 1B shows the same propellant and the same liquid being separately controlled except that at the time of output the propellant is used to mix with the liquid that is being dispensed to create either an atomized spray, a foam, or a dense foam, depending on various system variables. It is noted that while dispensing only liquid can be done using either overpressure or underpressure systems, dispensing a mix of propellant and liquid requires an over-pressure system.

It is understood that the term “liquid” herein refers to any type of dispensate, including cleaners, cosmetics, glues, lubricants, personal care items, foodstuffs, ice cream, beer, condiments, salad dressing, etc., of whatever type and description.

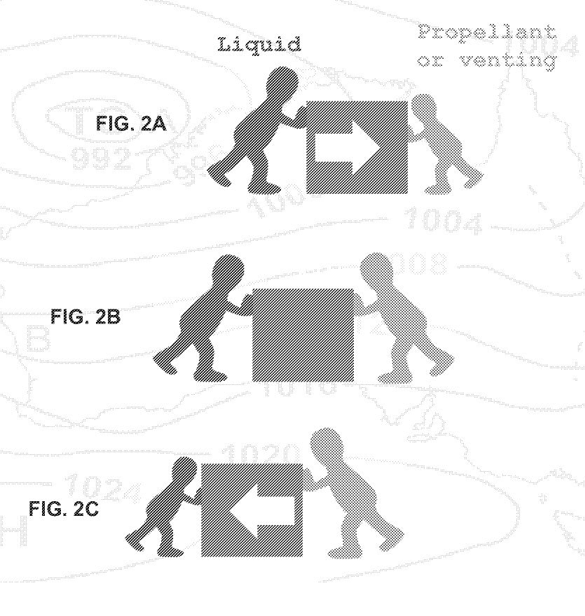

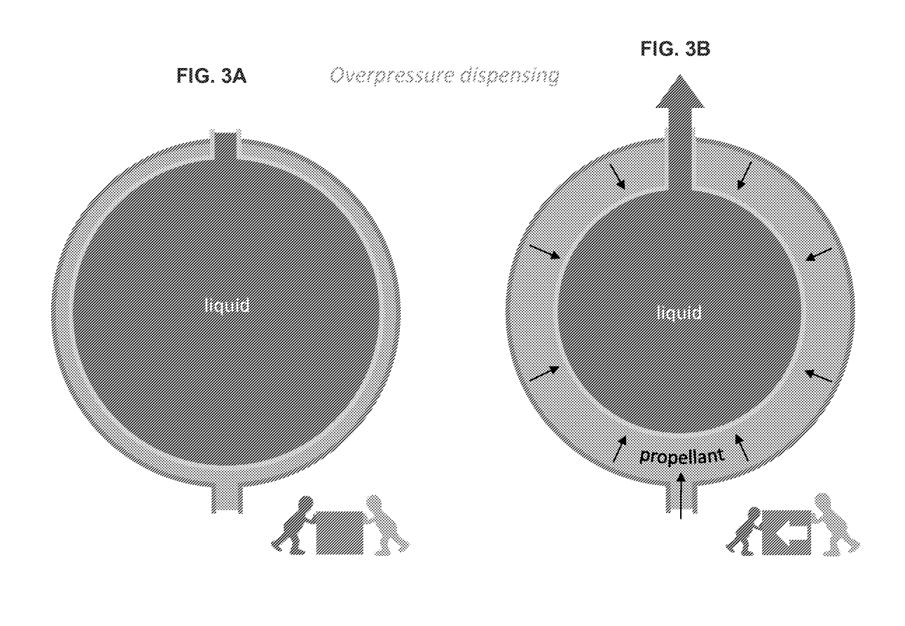

FIG. 2 illustrates the benefits of separately controlling the liquid and the propellant in exemplary embodiments of the present invention. In each of FIGS. 2A through 2C movement is created through pressure differences between the liquid and the propellant. It is noted that in an over-pressure system, as described below, the propellant is under a higher pressure than atmospheric pressure and this requires an actual propellant of some kind which can be air, for example. In an under-pressure system, as the liquid is dispensed a vent is opened that allows atmospheric pressure to fill the gap in a portion of the system; this is referred to in the figures below as “venting” or “reventing.” In FIG. 2A the liquid is under a higher pressure than the propellant and therefore it is pushed. In FIG. 2B the pressures are balanced and no movement is created whatsoever. In FIG. 2C the propellant is at higher pressure than the liquid and therefore it is contained or pushed by the greater pressured propellant.

At this juncture it is useful to describe the difference between an over-pressure system and an under-pressure system. This will be done with reference to FIGS. 3 through 7.

Because the propellant or venting medium is in a separate circuit (hydraulic circuit) it can be used for various features such as, for example, over-pressure dispensing, venting in the case of under-pressure, maintaining a saturation pressure, tubeless dispensing, upside-down dispensing, control of valves, and, for example, blowout or spout cleaning following dispensing. These functionalities will be described in more detail below.

FIG. 3 illustrate over-pressure dispensing. In an over-pressure system the pressure of the propellant is used to control the dispensing of the liquid. As shown in FIG. 3A the liquid and air are separated from each other and here have the same pressure, and are thus in static equilibrium. In FIG. 3B the air pressure is increased, such as, for example by a pump, thus displacing the liquid in the inner bag. This is the situation depicted in FIG. 2C.

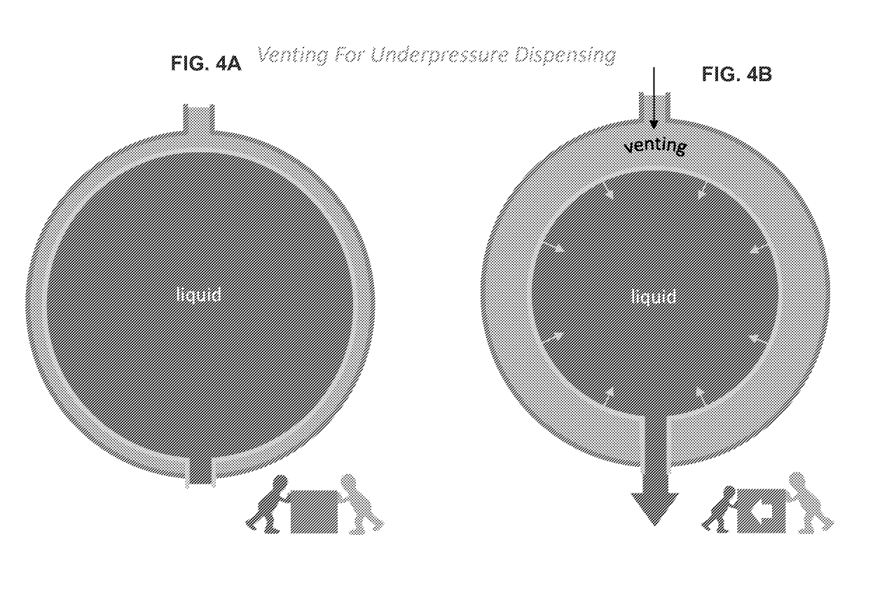

In FIG. 4A an under-pressure system is depicted. In FIG. 4A the air and the liquid are separated, as above, and the pressures are equal, resulting in static equilibrium. In FIG. 4B the liquid is evacuated by either, for example, gravity, or an under-pressure such as that delivered by a pump in fluid communication with the liquid, for example. As a result, the liquid pressure is lowered and air will be sucked in through the venting hole in order to restore the pressure balance. This is essentially the situation as shown in FIG. 2C for an under-pressure system.

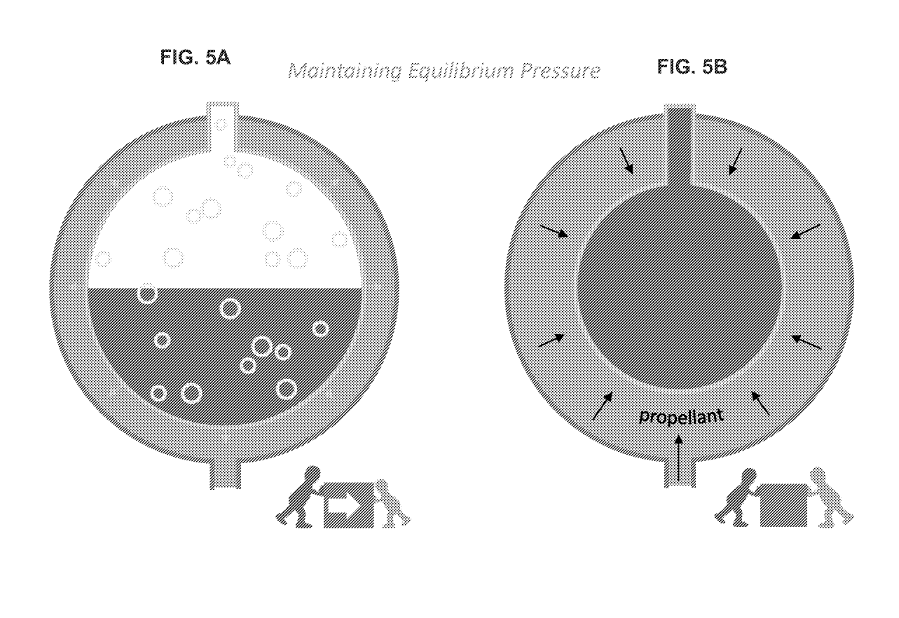

FIG. 5 illustrate maintaining an equilibrium pressure in exemplary embodiments of the present invention. With reference to FIG. 5A, when the pressure surrounding a gas containing liquid is lower than the equilibrium pressure of the gas in the liquid, gas escapes from the liquid and flows into the head space. In the case of beer, seltzer or soda, or other liquids where a dissolved gas is desired to be maintained, this is a problem, and they lose their mouth feel, sweetener balance and mouth feel. This can be solved by maintaining an equilibrium pressure, as shown in FIG. 5B. Here the pressure surrounding the gas containing liquid is increased, and thus the dissolved gas is kept inside the liquid. As noted, the liquid shown here is generic and can be, for example, any dispensable liquid such as, for example shaving foam, beer, sodas, or any other liquid where dissolved gas such as, for example carbon dioxide, oxygen, nitrogen, etc. is dissolved.

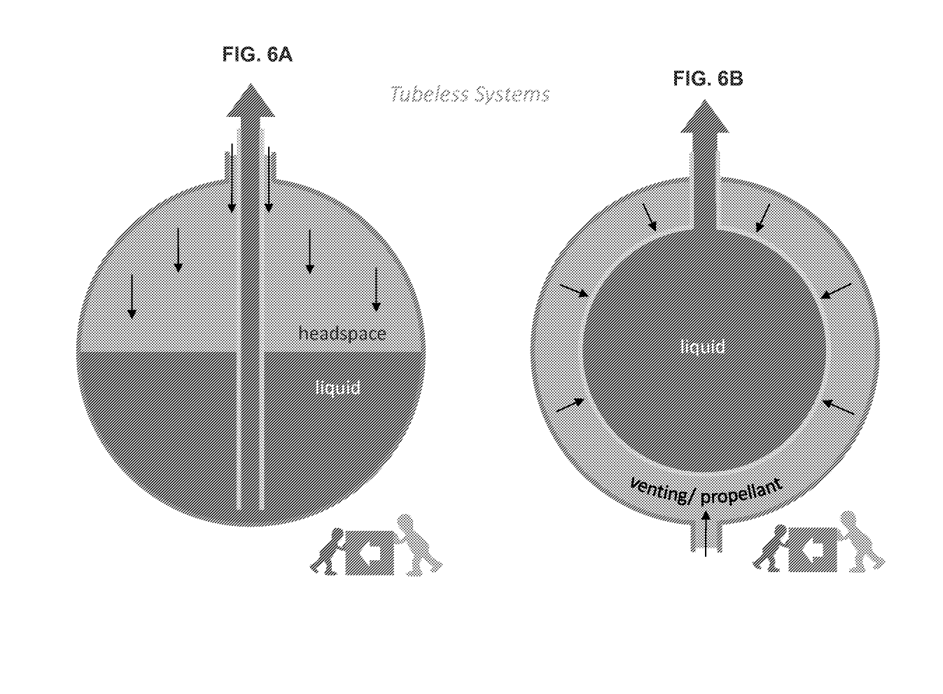

FIG. 6 illustrate tubeless dispensing, a further benefit of systems that separate the propellant and liquid, and use a Flair type container. With reference to FIG. 6A, if the venting medium or propellant is not separated from the liquid, as is the case in most sprayers of cleaning fluids, furniture polish, soaps and personal hygiene items, etc., a tube is needed and the tube must extend sufficiently vertically downward to capture the last drops of liquid in the bottom of the bottle or container, or they will not be able to be dispensed. The air or venting medium above the liquid is known as the “head space.” This can be avoided in exemplary embodiments of the present invention by simply separating the liquid or dispensate circuit from the venting or propellant circuit. As shown in FIG. 6B when the venting medium or propellant is separated from the liquid no tube is needed. This is because no significant head space will ever be formed; as the liquid is dispensed the propellant surrounding it pushes against it causing the volume of the liquid container to shrink.

As noted above, in exemplary embodiments of the present invention a Flair container within a container, or “bag within a bag” system, can be used as the reservoir or refillable bottle in which the liquid to be dispensed is contained. In a Flair system the liquid is maintained within an inner container and there is a gap between the inner container and the outer container in which a venting medium (underpressure systems) or propellant (overpressure systems) is introduced. It is by precisely by using such a Flair system that the liquid circuit and the venting/propellant circuit can in fact be kept separate.

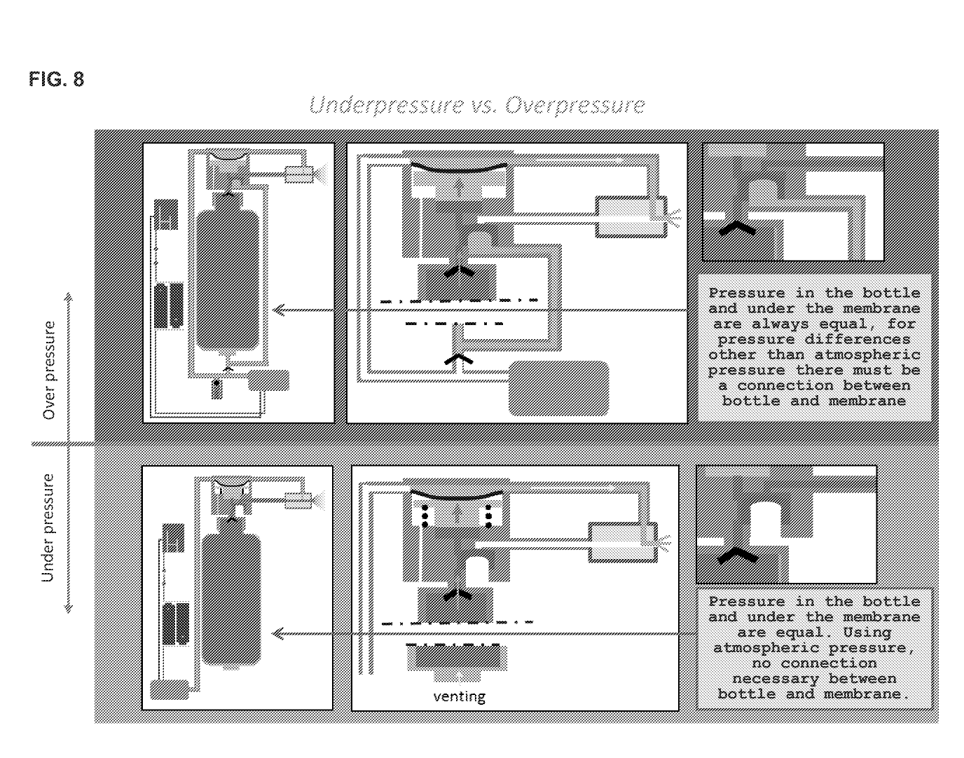

FIG. 8 illustrates yet another basic technology used in various exemplary embodiments of the present invention. This relates to controlling a membrane which serves as an inlet valve or an outlet valve, or, for example, a combination of both, by varying the pressures, i.e., creating a pressure differential, across such a membrane. This can be done in either an under-pressure system or an over-pressure system. With reference to FIG. 8, top panel shows an over-pressure system and the bottom panel an exemplary under-pressure system. In each case there is a bottle, as shown in the left column. In the over-pressure system the pressure in the bottle and under the membrane are always maintained equal. If it is desired to use pressures other than atmospheric pressure there must be a connection between the propellant circuit of the bottle and the bottom of the membrane, as shown. Thus, in the top left column of FIG. 8 there is a pump which provides a system pressure to the Flair bottle, and which also runs underneath the (bright red) dome valve. Thus, the system pressure is supplied to both sides of the dome valve. Thus, the liquid is pressurized at the same system pressure and it is pushing against the dome valve as well, as shown in the center top image. In such a case there is no fluid flow (and no motion of the membrane) because the dome valve experiences an identical pressure on either side of it. In the upper right image of FIG. 8 is an example of when there is fluid flow; this is the case when the system pressure momentarily or temporarily is higher on the upper side of the dome (here due to a piston being pushed downwards), as explained below.

With reference to the under-pressure systems shown in the bottom panels of FIG. 8, the pressure in the bottle and under the membrane are also equal but this is done by atmospheric pressure. As noted, in an under-pressure system the venting medium is used to keep the liquid in the inner container pressurized, and this is generally atmospheric pressure. Additionally, the underside of the dome valve is exposed to the atmosphere and is thus at the same atmospheric pressure. Therefore, as indicated, there is no need to connect the bottle to the underside of the membrane as is done in the over-pressure case. It is noted that in the center image on the bottom panel the venting on the bottom of the Flair bottle is shown. This allows atmospheric pressure to be maintained between the outer surface of the inner container (where the liquid is contained) and the inner surface of the outer container. It is precisely in this gap that the venting circuit occurs. In the bottom right image, when liquid is pumped out or pulled out of the inner container by creating a higher pressure than atmospheric pressure on the topside of the dome valve, there is fluid flow, as shown.

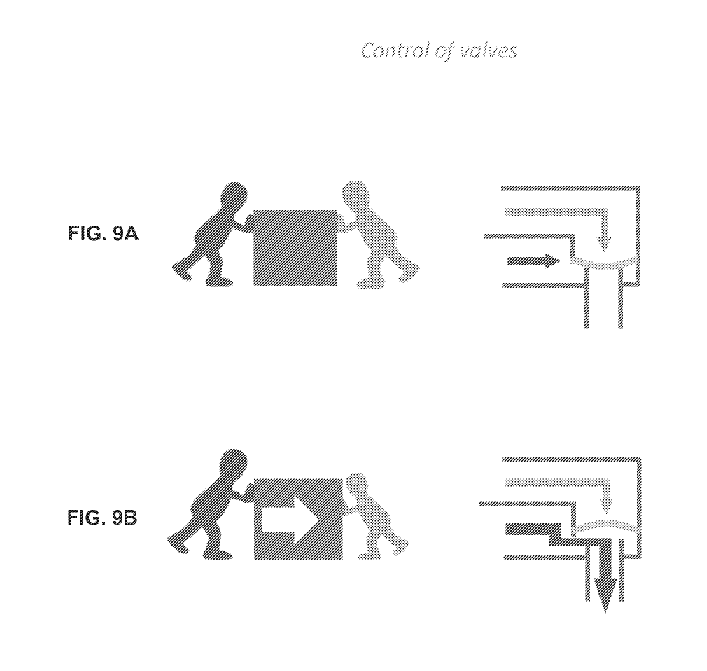

FIG. 9 illustrate how valves can be controlled by pressure differentials according to exemplary embodiments of the present invention. FIG. 9A shows a valve, in this case an elastomeric type dome valve, which is normally closed due to tension pushing it downward as shown in FIG. 9A. This prevents the liquid from exiting through the outlet tube. In FIG. 9B the liquid has sufficient pressure to overcome that of the propellant or venting (atmospheric pressure), and the pre tension or pre-compression of the valve is overcome and the valve opens.

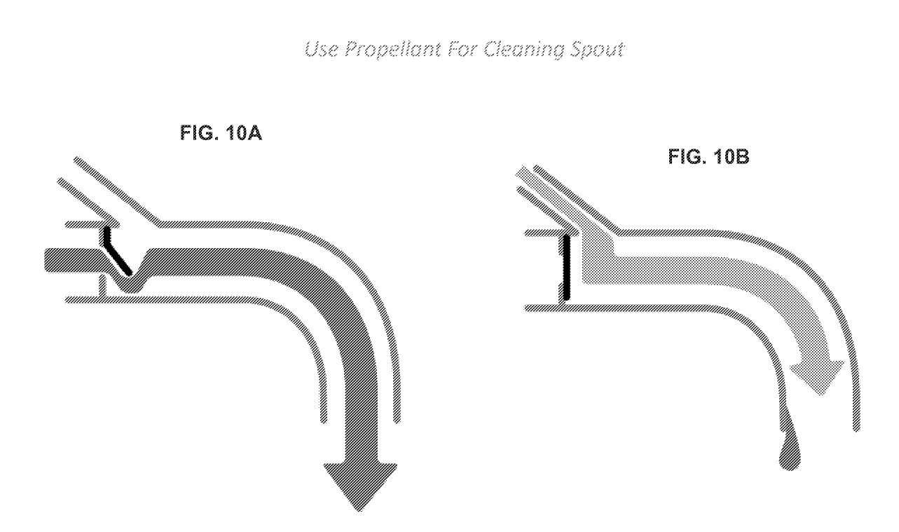

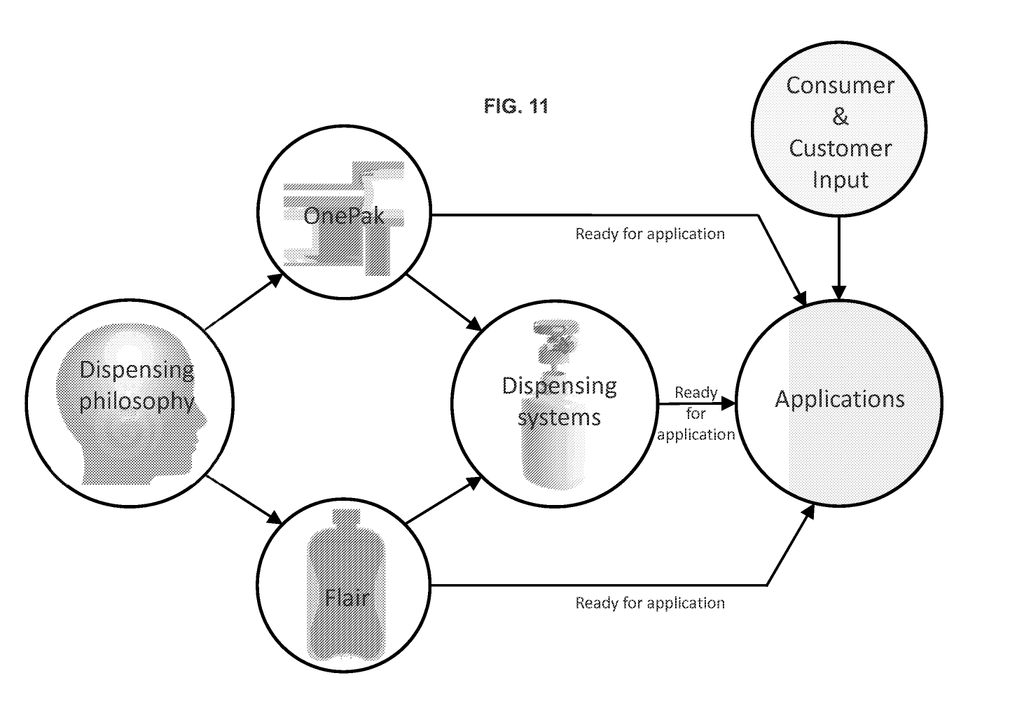

FIG. 10 illustrate how the propellant/venting medium, when properly controlled, can be used for other functionalities besides such propulsion. FIG. 10A shows liquid being dispensed through a spout of an exemplary dispensing device. FIG. 10B shows how after the dispensing device has closed (note the valve here is vertically oriented at the left side of 10B) air or propellant can be shot through the outlet spout to clear any residue of the liquid which has just been dispensed. This can be invaluable for dispensing liquids that are organic such as, for example, foodstuffs that can be subject to rot or growth of molds and other decomposition if residue would be left in the spout. This can be especially useful, for example, in home beer dispensing systems, or home dispensing systems for soda or juice which contain sugar or other readily decomposable organic materials.

FIG. 11 is a general diagram showing the dispensing philosophy upon which various exemplary embodiments of the present invention are based. As shown, a combination of Flair bottles and OnePak type dispensing heads integrated into dispensing systems allows for a variety of applications. Many of these applications are described in the present disclosure, and numerous others are understood to be included within its scope.

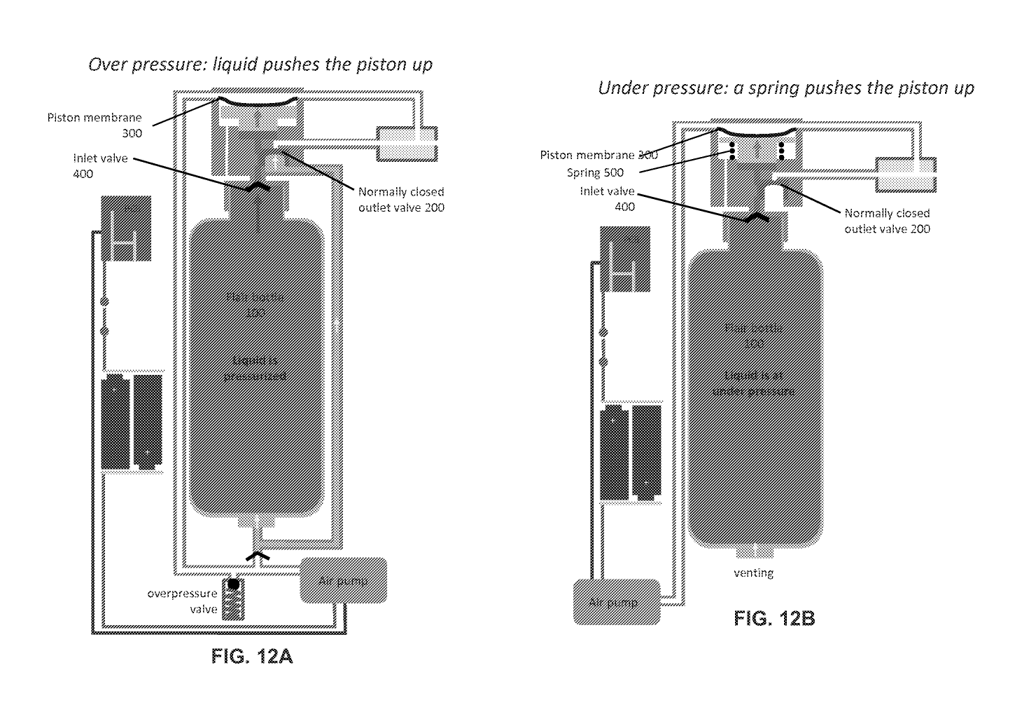

FIG. 12 illustrate a fundamental property of exemplary metered dispensing systems according to various exemplary embodiments of the present invention. It is noted that metered dispensing systems dispense a fixed quantity of soap, cleaning fluid, foam or even beverage, and can be activated, for example, by hand, by electronic sensing of the presence of a hand, or by preprogrammed interval dispensing, such as for air freshener and sanitizer applications. FIG. 12 illustrate that for each metered overpressure system a similar or analogous metered underpressure system can be built, and vice versa. Thus there is a complementarity or parallelism between overpressure systems and underpressure systems according to various embodiments of the present invention. FIG. 12A illustrates an exemplary overpressure system where the liquid in the Flair bottle is pressurized at a certain system pressure by an air pump. There is also an overpressure valve which regulates the pressure so that it does not exceed a defined level. The bottom of the normally closed outlet valve 200 in the dispensing head is also exposed to this same system pressure. The Flair bottle has an integrated one way inlet valve 400, allowing liquid to flow into the dispensing head, but not back into the bottle. A piston membrane is exposed to a propellant circuit which controls it, and thus piston motion, and thus liquid dispensing. The advantage of an overpressure system is product captivity. Thus, a Flair bottle is needed, and competitors cannot make a Flair bottle to fit the system because of proprietary technology. If consumers try to refill the Flair bottle by drilling a hole in it, the bottle becomes useless. The disadvantage of such overpressure systems is that more parts are needed to create them.

FIG. 12B illustrates an exemplary underpressure system. Here the normally closed outlet valve is exposed to atmospheric pressure and the liquid is drawn into the chamber after a compression cycle not by system pressure in the liquid, as in the case of the overpressure example of FIG. 12A, but by a spring 500 underlying the piston which sits under the piston membrane 300 as shown in FIG. 12B. The advantage of such underpressure systems is cost savings. This is because no air connection to the bottle is needed. As shown, In place of a propellant the system is simply vented to the atmosphere, indicated by “venting” in FIG. 12B, as described above, and thus there are less parts. The advantage of an underpressure system is that a Flair bottle is not necessary (a user can switch in a standard single container bottle with a dip tube to reach below the headspace) and therefore there is less product captivity. Additionally, in underpressure systems priming is more difficult as there is no system pressure which can easily be adjusted upwards to push liquid into the chamber; therefore a user or a system needs to pump a number of times initially to prime the system.

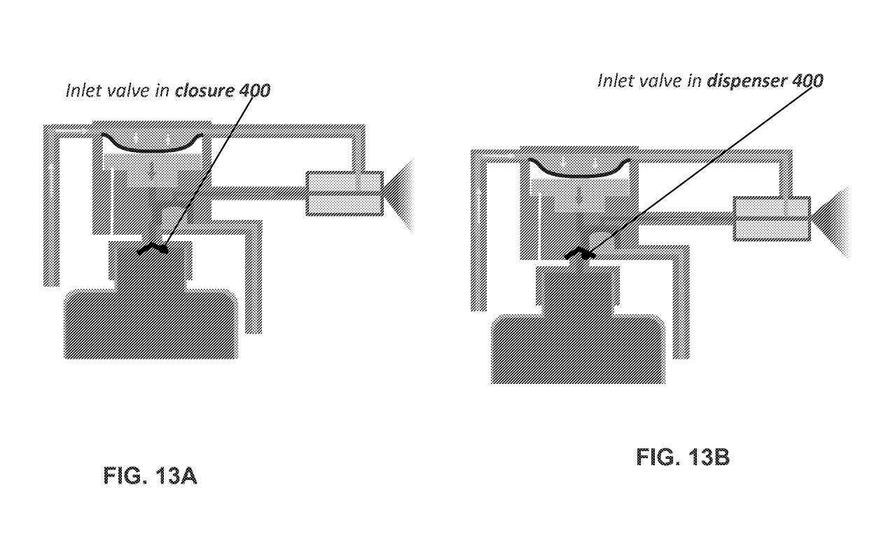

FIG. 13 illustrate how for each dispensing system type (i.e., underpressure and overpressure) an inlet valve 400 can be located either in the refill closure or in the dispensing head. The refill closure is part of the refill bottle, which can be a replaceable Flair type bottle. The systems shown in FIG. 13B are overpressure systems, as can be discerned by the pressure circuit pipe providing propellant to the underside of the normally closed valve. However, the same considerations apply to underpressure systems. Thus, for an inlet valve integrated in the closure, i.e., in the bottle, the advantages are several relating to product captivity. A replacement bottle without an integrated closure cannot be used in its place, as competitors would need to make a closure with the right interface and integrated inlet valve in order to allow fluid to flow into the dispensing head. Moreover, if the consumer were to try to refill the bottle on his own, in so doing the inlet valve would likely become damaged, ruining the bottle. The disadvantage of the inlet valve integrated in a closure is that more parts are needed to create such a closure.

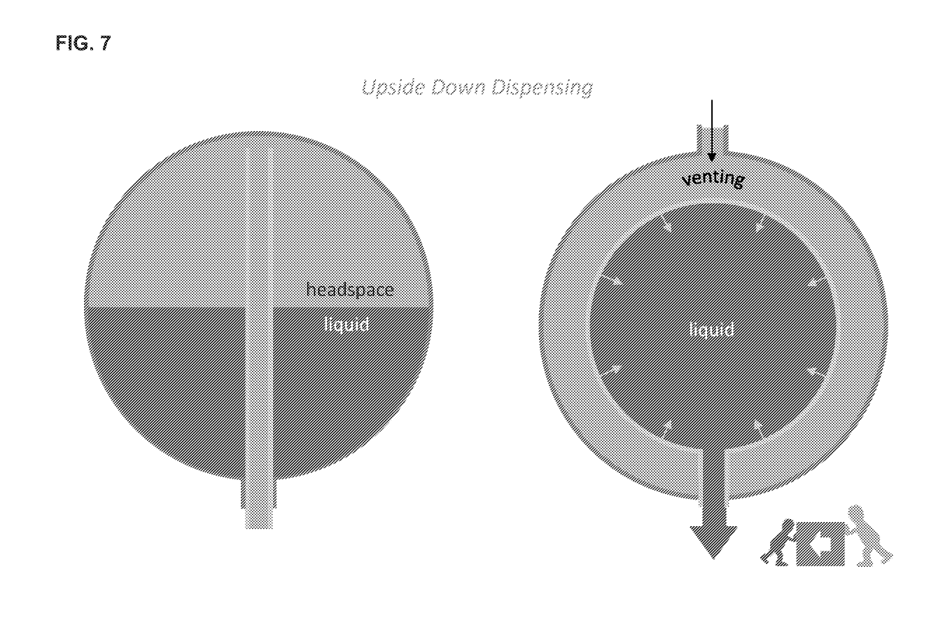

FIG. 13B shows an exemplary embodiment where the inlet valve is provided in the dispenser or dispensing head. The advantage to this configuration is cost reduction. The closure does not have to be fitted with an inlet valve and this saves at least one part. The disadvantage is that if the closure is not fitted with a valve, air can enter the bottle when the bottle is removed from the system. This can create head space in the bottle—a phenomenon illustrated above in FIG. 7—and thus a dip tube is needed to be able to reprime the dispensing device.

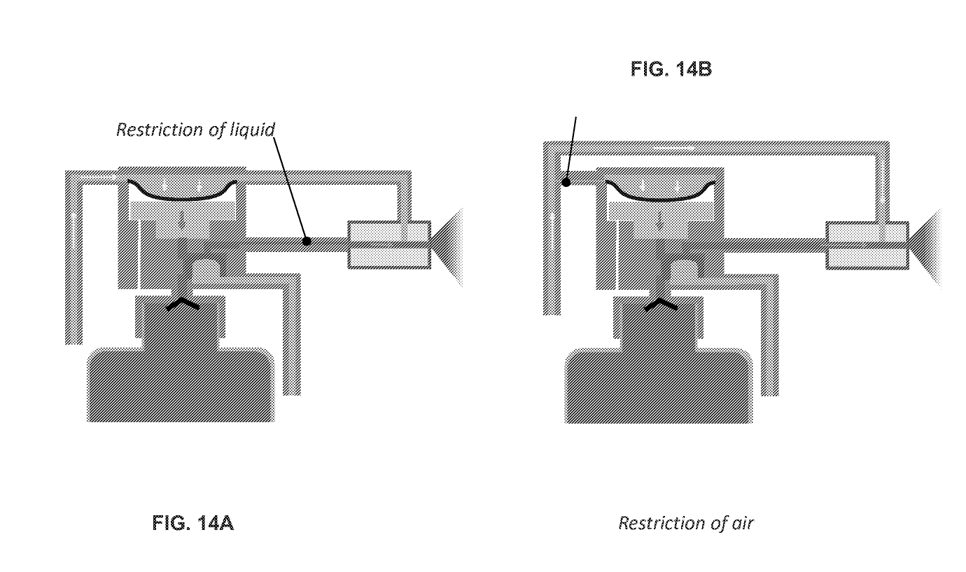

FIG. 14A illustrates another fundamental aspect of various exemplary embodiments of the present invention—restrictions. Restrictions are very small reductions in size of tubing or conduit by which either air or liquid is conveyed to slow down the speed of the flow, or to otherwise regulate it. FIG. 14A shows an exemplary restriction of liquid in the outlet line which is controlled by the normally closed valve. FIG. 14B illustrates a restriction of air, where air on top of a piston membrane is restricted to control pressure above such membrane, as described below. In both examples of FIG. 14 this dispensing system mixes air or propellant with the dispensed liquid to create a foam or spray of some type. It is noted that both systems illustrated here are also overpressure systems. Thus, with reference to FIG. 14, in order to get the right liquid/air mix and/or the right dispensing speed, restrictions can be used. The restrictions can either (i) restrict the flow of liquid to the nozzle or (ii) restrict the air flowing to the piston membrane, for example.

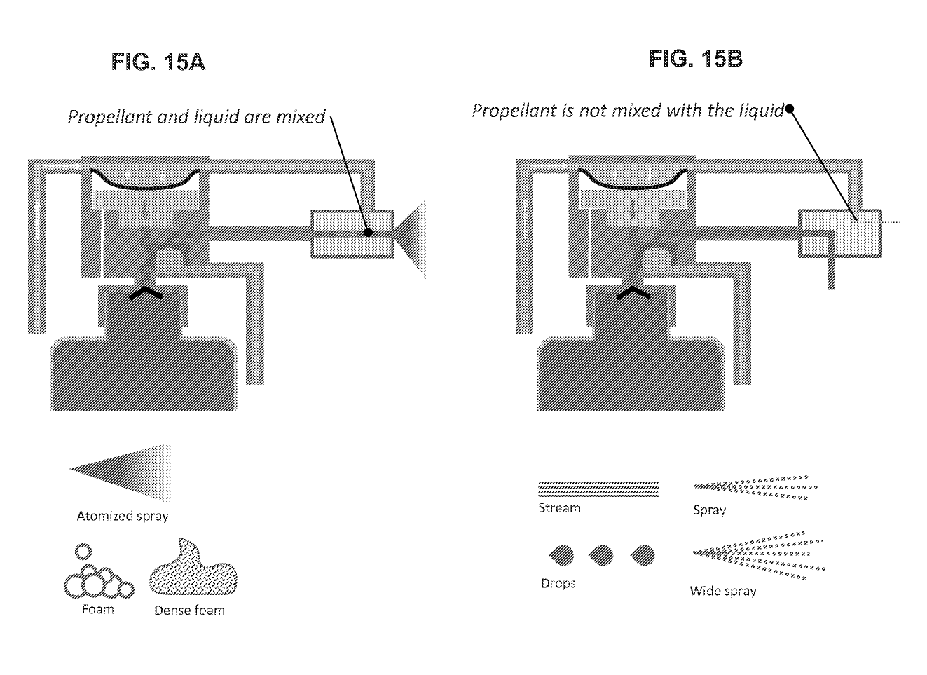

FIG. 15 illustrate mixed propellant/liquid output versus purely liquid output. FIG. 15A shows how the propellant and liquid are mixed, and how this mixed output can be in the form of an atomized spray, a foam or a dense foam. FIG. 15B shows an exemplary system where the propellant is not mixed with the liquid and therefore they are maintained as completely separate throughout the dispensing cycle. In such systems, liquid can be dispensed in a variety of ways such as, for example, a stream, a spray, a wide spray, or droplets as shown, depending upon nozzle shape, pressure, and other parameters.

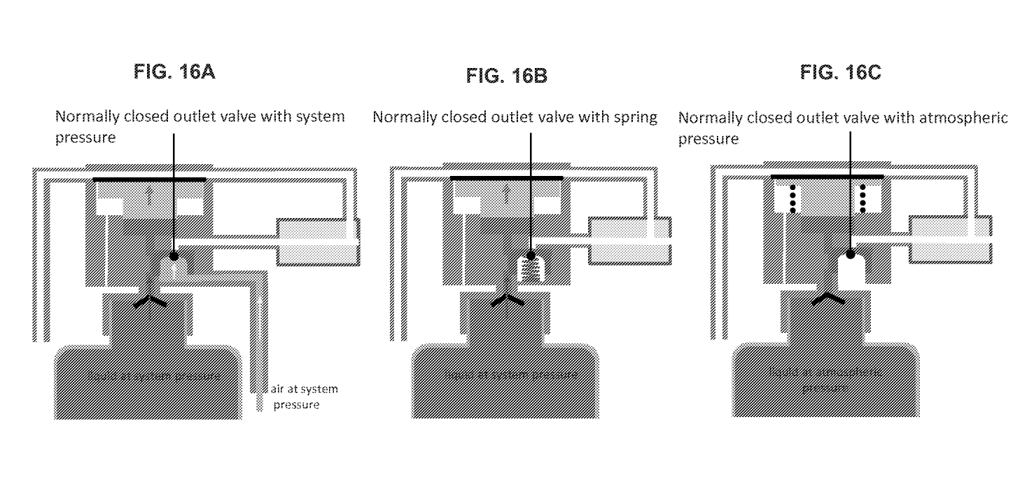

Finally, FIG. 16 illustrate normally closed outlet valves, a feature of exemplary embodiments of the present invention. With reference to FIG. 16A there is shown a normally closed outlet valve via system pressure. This is an overpressure system, as described above. Here the system pressure is put behind, or on the underside of, the normally closed outlet valve. This prevents creep of the valve's material as there is rarely a pressure differential across it and then only when dispensing. The pretension, or precompression, of the valve, keeps it closed when it is not dispensing. In FIG. 16B there is a normally closed outlet valve held in place not by system pressure but by a spring. The spring provides a constant cracking pressure threshold. Such a spring is a logical spring, and it can be actually integrated into the elasticity of the elastomeric valve or there can actually be a separate physical spring. The spring prevents creep of the valve's material and keeps the valve closed when not dispensing. However, there will often be a nonzero pressure differential between the liquid at system pressure and the actual pressure acting on the normally closed outlet valve by such spring. FIG. 16C is the same as FIG. 16B, except the spring is removed and it is only atmospheric pressure that is on the other side, or backside, of the outlet valve. The pretension of the valve keeps it closed when not dispensing but again there will be random temporary pressure differentials between atmospheric pressure and the liquid and thus this can cause more creep of the outlet valve. It is noted that creep denotes a gradual weakening of the elasticity of an elastomeric valve due to it experiencing a pressure differential across it for long periods of time or intermittent periods of time which in the aggregate add up to a significant time.

Exemplary Overpressure Dispensing Heads

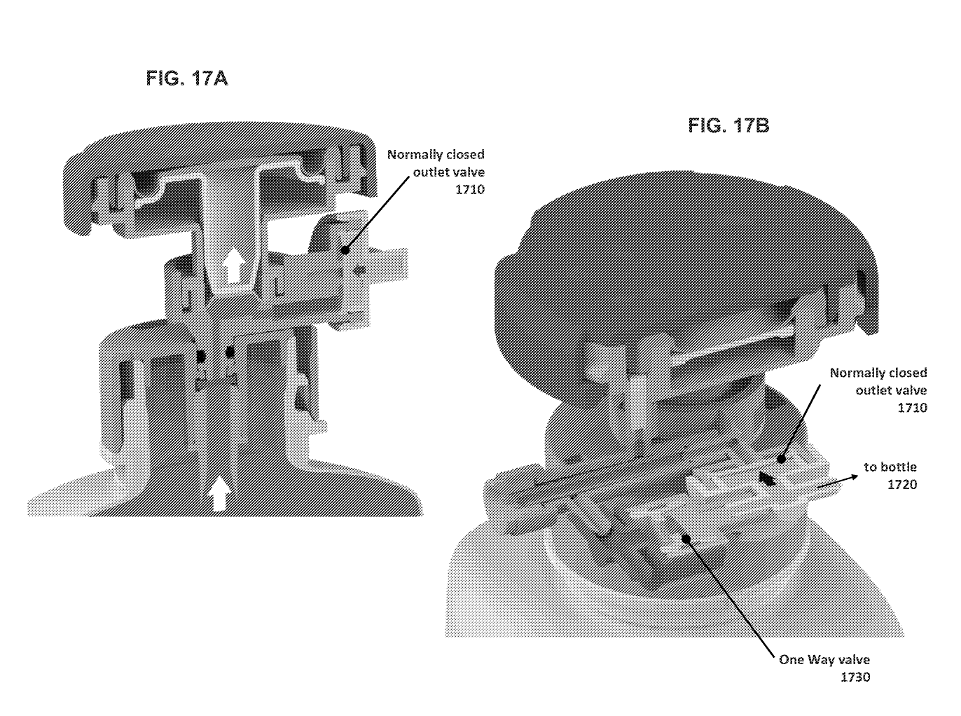

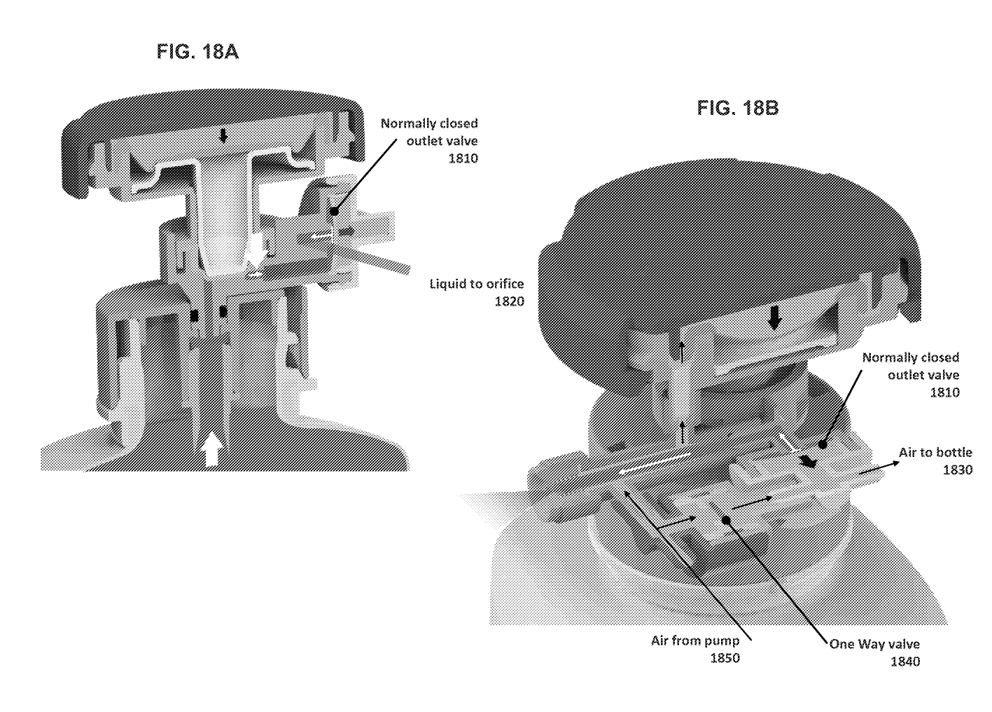

FIGS. 17-19, next described, illustrate exemplary OnePak type overpressure dispensing heads. FIG. 17 illustrate standard overpressure dispensers, according to exemplary embodiments of the present invention, in a “ready for dispensing” mode. FIG. 17A shows a vertical cross sectional slice through a dispenser and bottle closure as attached to an exemplary Flair type bottle. FIG. 17B is a horizontal cross sectional slice through a variant dispenser with a vertical cut-out through the piston chamber of the dispensing head.

With reference to FIG. 17A, the dispensing head is placed within a receptacle in the center of the bottle cap such that there is a fluid connection between the inner container of the bottle and the dispensing head. Therefore, the dispenser is now in the position for dispensing, where the liquid in the bottle is pressurized, the liquid has pushed the piston upwards as shown by the upper white arrow, the liquid chamber is filled, and the normally closed outlet valve 1710 remains closed.

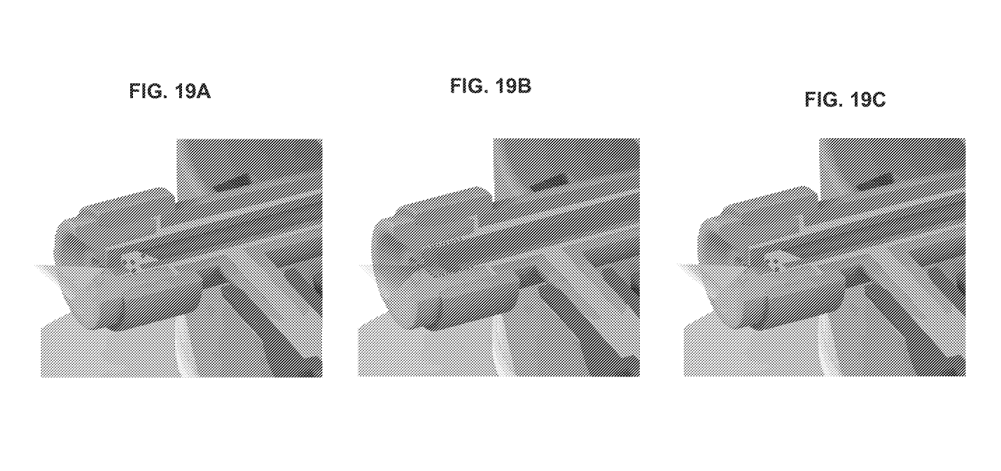

FIG. 18 show the exemplary overpressure dispensers in dispensing mode. As shown in FIG. 18A, this occurs when air pressure is put behind (on top of) the piston membrane, the piston thus moves downward (see arrow), the inlet valve closes (here a shuttle valve in bottle closure), the normally closed outlet valve 1810 is now opened, and liquid is pushed out of the liquid chamber towards nozzle 1820. As seen in FIG. 18B, air from the pump 1850 can be fed to the nozzle for mixing with the liquid, and the air and liquid can mix and create a spray. Air from pump 1850 is fed both to the nozzle and to bottle 1830 to maintain system pressure in the bottle. The air and liquid circuits are completely separate, except at the nozzle in 18B.

FIG. 19 show details of the nozzle of the exemplary overpressure dispenser shown in FIGS. 17B and 18B while dispensing. With reference to FIG. 19A, in the first fractions of a second air is pushed through the nozzle, nebulizing microscopic drops that may possibly be left from a prior dispensing cycle. As shown in FIG. 19B, after the liquid arrives at the nozzle, it mixes with the air creating a fine spray. As shown in FIG. 19C, after all the liquid is dispensed, the pump still runs for a few fractions of a second pushing air through the nozzle. This final blast of air is what cleans the nozzle, making it ready once again for another dispensing cycle, thus returning the dispenser to the “ready for dispensing” mode, shown in FIG. 17. It is understood that the nozzle can be cleared via air even where no mixing of air and liquid occur, in which case only the functionality of FIG. 19C would operate.

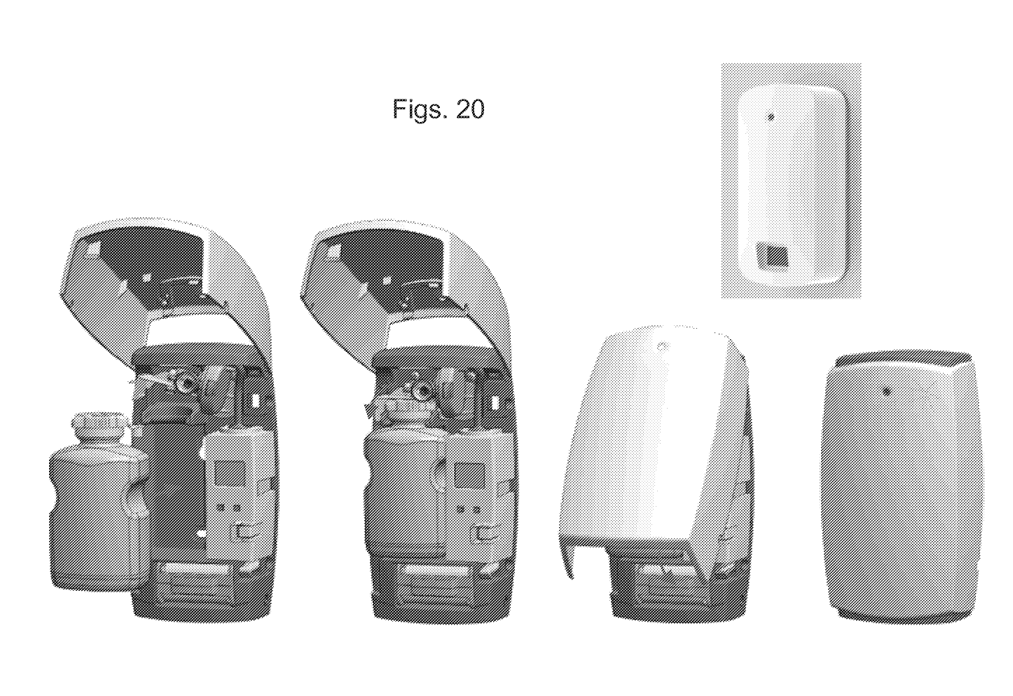

FIG. 20 show an exemplary air freshener according to exemplary embodiments of the present invention built using a combination Flair bottle and an overpressure dispensing head similar to that shown in FIGS. 17 and 18. With reference to FIG. 20 there are cycles in setting up such an air freshener, including (1) replacing a Flair type bottle, (2) rotating the control valve to connect to the bottle, (3) closing the cover, and (4) being ready for use. As can be seen in frame 4, the air freshener product is sprayed out of the top of the air freshener device in a fine spray of liquid and that is where the nozzle, as shown in FIG. 19, is placed.

Exemplary Underpressure Dispensing Heads

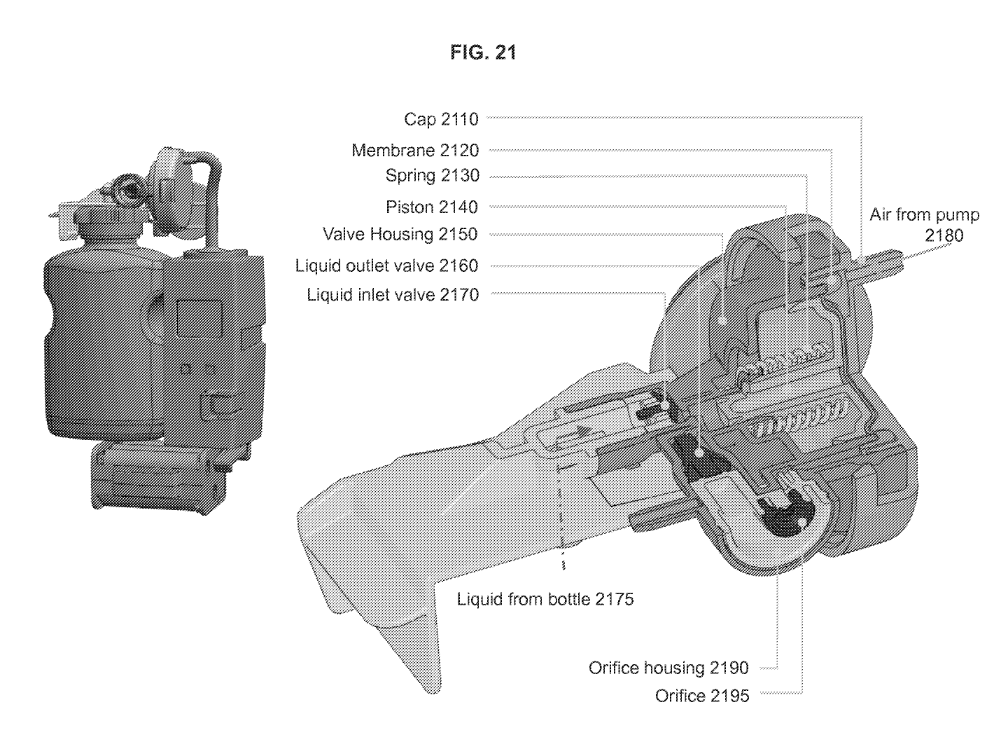

FIGS. 21-25 show details of an exemplary under pressure dispenser which can be used in various exemplary embodiments of the present invention. With reference to FIG. 21, there can be seen a cap 2110, membrane 2120, spring 2130, piston 2140, valve housing 2150, liquid outlet valve 2160 and a liquid inlet valve 2170. These components are all in the dispensing head which attaches to the top of the Flair bottle, as shown. The liquid flows from the bottle as shown at 2175, and the air from a pump as shown at 2180. As detailed below, there is an orifice 2195 in an orifice housing 2190.

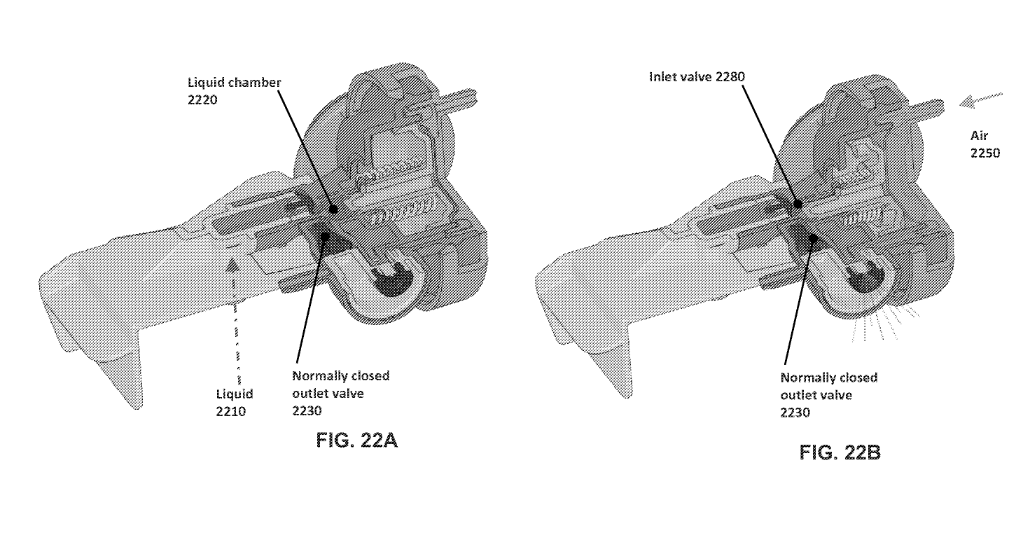

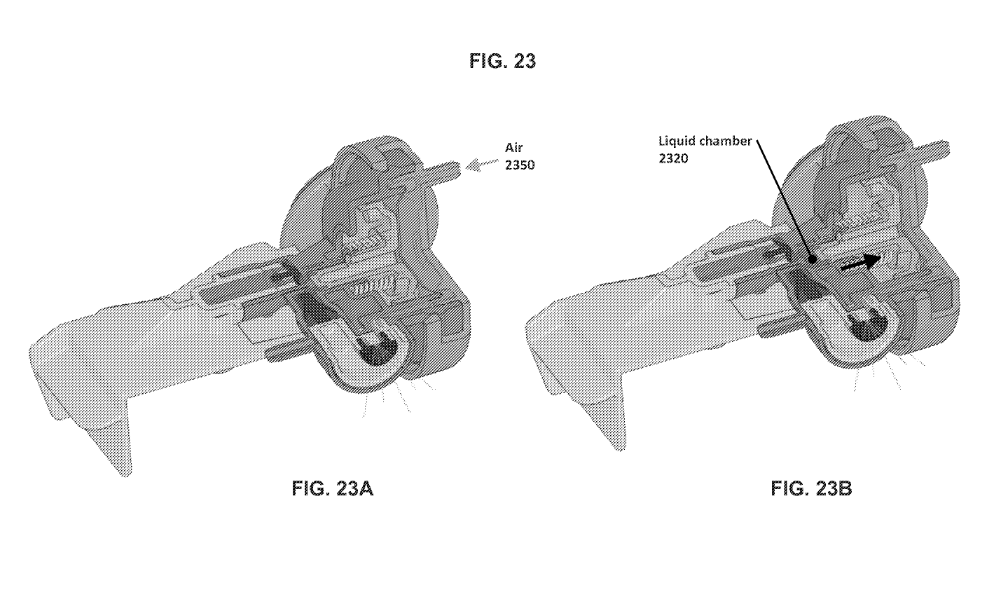

FIGS. 22 and 23 illustrate the four dispensing cycles using an underpressure dispensing head as shown. Beginning with FIG. 22A the device is ready for dispensing. Thus, the piston has moved upwards, liquid 2210 is sucked into liquid chamber 2220, and normally closed outlet valve 2230 remains closed. With reference to FIG. 22B, in a dispensing mode, air pressure 2250 is put behind the piston membrane as shown in the top right of FIG. 22B. The piston thus moves downward, the inlet valve 2280 closes, liquid is pushed out of liquid chamber 2220 towards the nozzle, and normally closed outlet valve 2230 is now opened and the air and liquid can mix and create a spray as shown at the exit of the nozzle. With reference to FIG. 23A, in a nozzle cleaning phase, essentially identical to that shown in FIG. 19C, the liquid chamber is empty, the pump still runs for a fraction of a second, and air 2350 travels through the nozzle and cleans it. Finally, in a re-setting phase, as shown in FIG. 23B, the pump stops running, thus the piston moves up under the now released pressure of spring 2130, liquid is sucked into liquid chamber 2320 and any air remaining above the piston membrane is pushed out through the nozzle, as shown. As noted, this is an underpressure system so normally closed outlet valve 2230 (FIG. 22) is exposed on one side to atmospheric pressure. There is no system pressure on the liquid higher than atmospheric to push the piston back upwards. Thus, when the air pump is used to push down the piston, once the pump stops running, the spring underneath the piston, now seeing no opposition from the piston as pump is off, pushes the piston back upwards to again fill liquid chamber 2320, as shown in FIG. 23B.

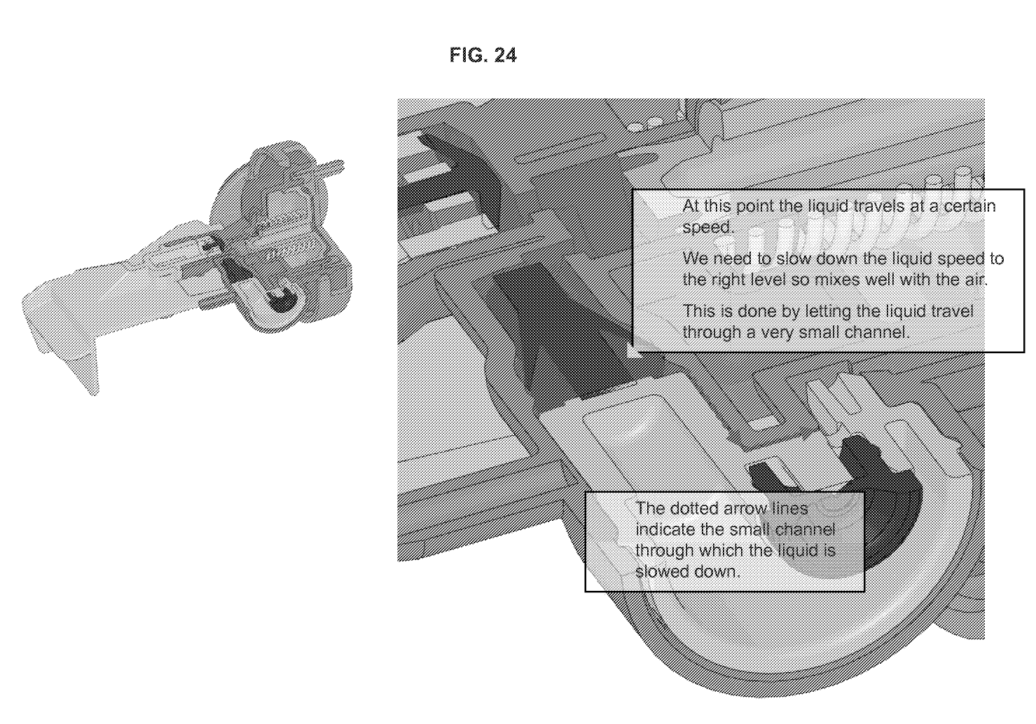

FIG. 24 shows detail of the nozzle of FIGS. 22 and 23. With reference thereto, it is noted that liquid reaching the nozzle travels at a certain speed. It is often necessary to slow down this speed to the right level so that the liquid mixes well with the air. This can be done by letting the liquid travel through a very small channel, as is shown by the dotted arrows in FIG. 24. As noted, the dotted arrow lines indicate the small channel through which the liquid is slowed down prior to its mixing with the air so as to achieve the exact type of output desired, in any given application.

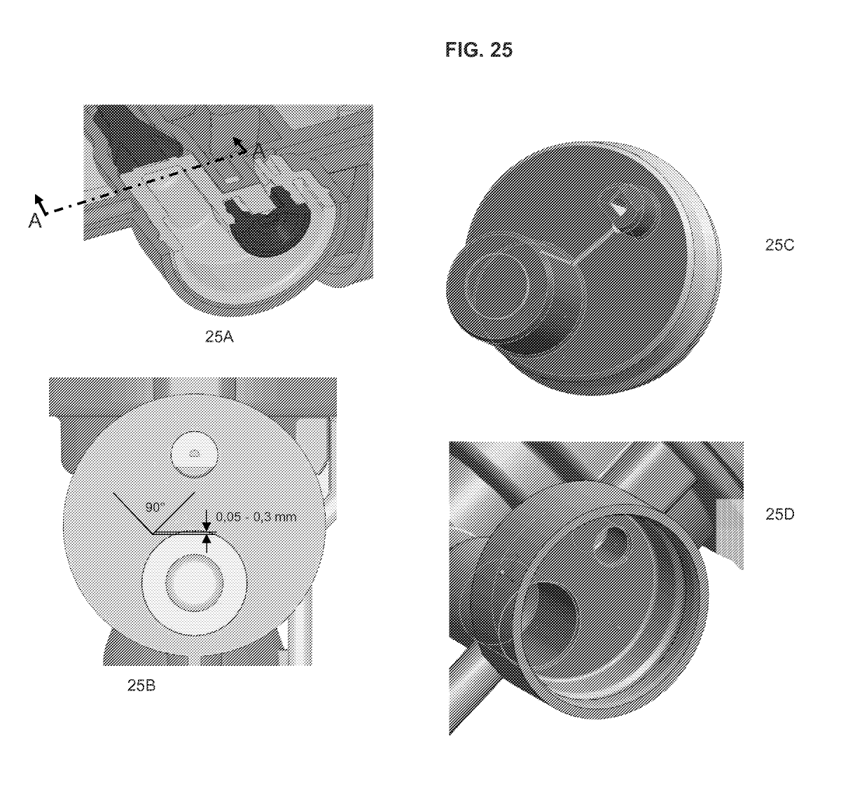

FIG. 25 shows further detail of the tiny channels shown in FIG. 25A. These channels are so small, they can be optimally created by assembling two parts. FIG. 25B, which is a section along the line A-A in FIG. 25A, shows exemplary dimensions, and the tiny channels. These dimensions are exemplary for the groove, which can be, as shown, a V-groove with an angle of 90 degrees and a depth of 0.3-0.5 mm. Of course the groove could have another profile or other depth in various other embodiments.

FIG. 25C shows how in one part very small grooves are created and in FIG. 25D it is shown how the two parts are pressed together leaving only the grooves as an area through which air or liquid can travel. This illustrates an example of restrictions, as described generally above in connection with FIG. 14.

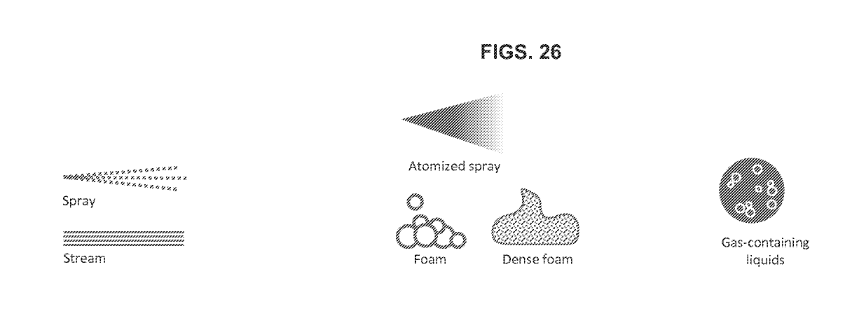

FIG. 26 present in summary form the various types of overpressure systems. Beginning with the left column, these include liquid only, which does not mix with air. Such liquid can be dispensed as a spray or as a stream, and for a metered liquid, it can be dispensed in a number of possible systems, such as, for example, piston actuation system where there is no release membrane, a piston actuation system where there is a release membrane, a manual air pump with a release membrane. It is also noted that a non-metered liquid can be dispensed with the following systems: a release valve actuation system, and a release valve and micro switch actuation system.

Similarly a metered mix of air and liquid can be dispensed with any of the following systems: piston actuation with no release membrane, piston actuation with a release membrane, manual air pump with release membrane. Similarly, a non-metered mix can be dispensed using, for example, release valve actuation, and release valve and micro switch actuation. Finally, gas containing liquids can be dispensed in metered doses using an electro air pump carbonator.

Summary of Underpressure Systems

For underpressure systems, a metered mix of air and liquid can be dispensed with any of the following systems: piston actuation with no release membrane, piston actuation with a release membrane, manual air pump with release membrane. Similarly a metered liquid can be dispensed with piston actuation system where there is no release membrane, a piston actuation system where there is a release membrane, a manual air pump with a release membrane. As noted above, for each metered over pressure system a similar metered under pressure system can be built, and vice versa. The main difference between these two system types is that in the over pressure system liquid pressure pushes the piston upwards to fill the liquid chamber, while with the under pressure system a spring is needed to push the piston upwards. Once the piston is pushed upwards, this creates an underpressure in the chamber which sucks liquid into the liquid chamber.

Exemplary Soap/Foam and Fragrance/Sanitizer Dispensing Devices

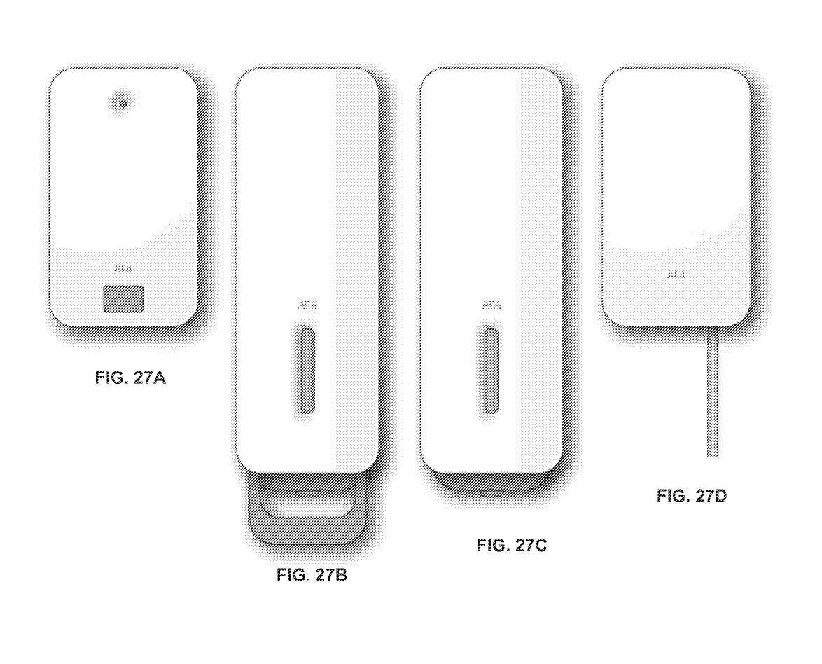

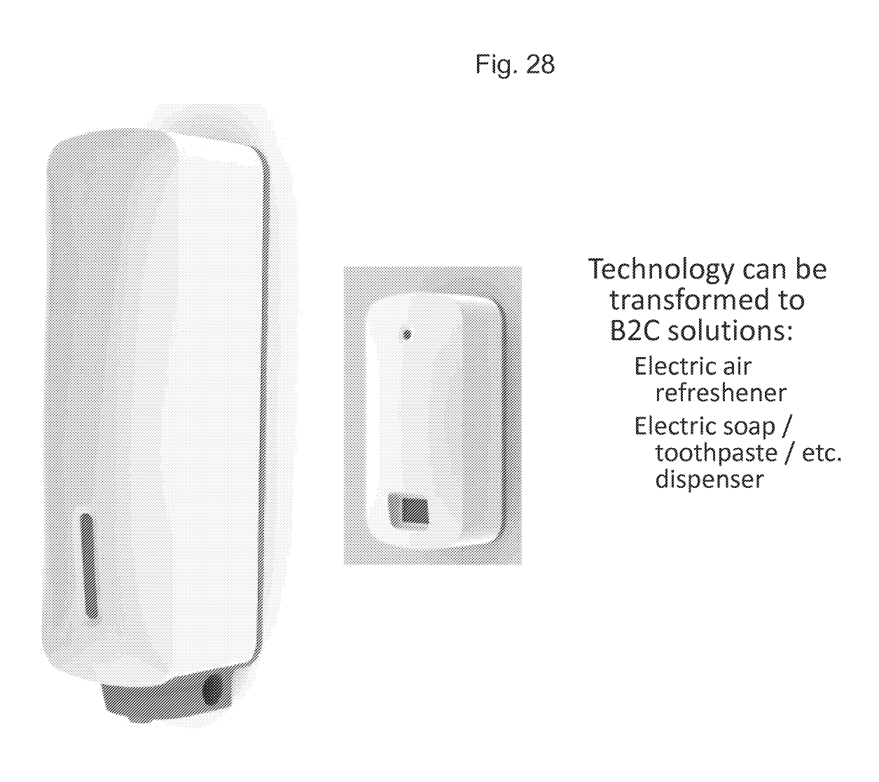

FIG. 27 generally illustrate various exemplary soap/foam, fragrance and sanitizer dispensers according to exemplary embodiments of the present invention, both manually operated as well as automatically actuated. These devices share a similar physical platform, and embody the dispensing approach and various basic elements and functionalities described above. These devices are sometimes collectively referred to herein (or identified in the figures) by the trademark “FlairFresh.” FIG. 27A is an air freshener device, FIGS. 27B and 27C depict manually operated, and automatically operated, soap/foam dispensers, respectively, and FIG. 27D depicts a sanitizer, such as can be used in public restrooms. Such devices combine Flair type bottles with OnePak type dispensing heads, and maintain propellant and liquid completely separately except, possibly, at dispensing. FIG. 28 illustrates how such devices can be adapted to business to consumer type devices, such as, for example, electric air refresheners and electric soap/toothpaste/condiment, etc. dispensers.

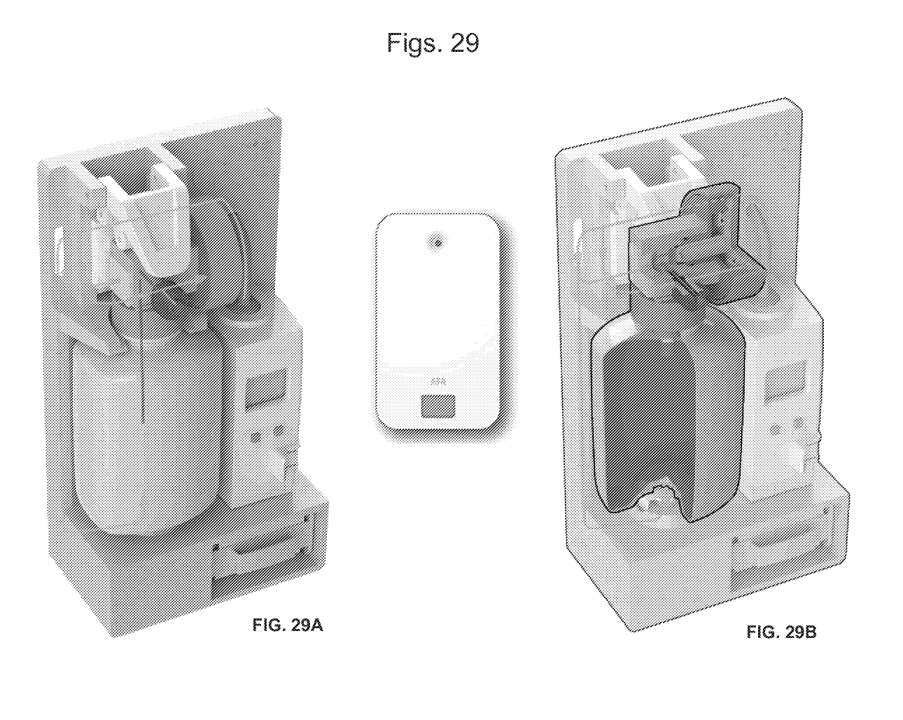

FIG. 29 illustrate details of an exemplary air freshener platform (such as is shown in FIG. 27A) according to exemplary embodiments of the present invention. FIG. 29A shows the physical platform under the cover, and FIG. 29B is a cut away of the Flair bottle as well as of the dispensing head.

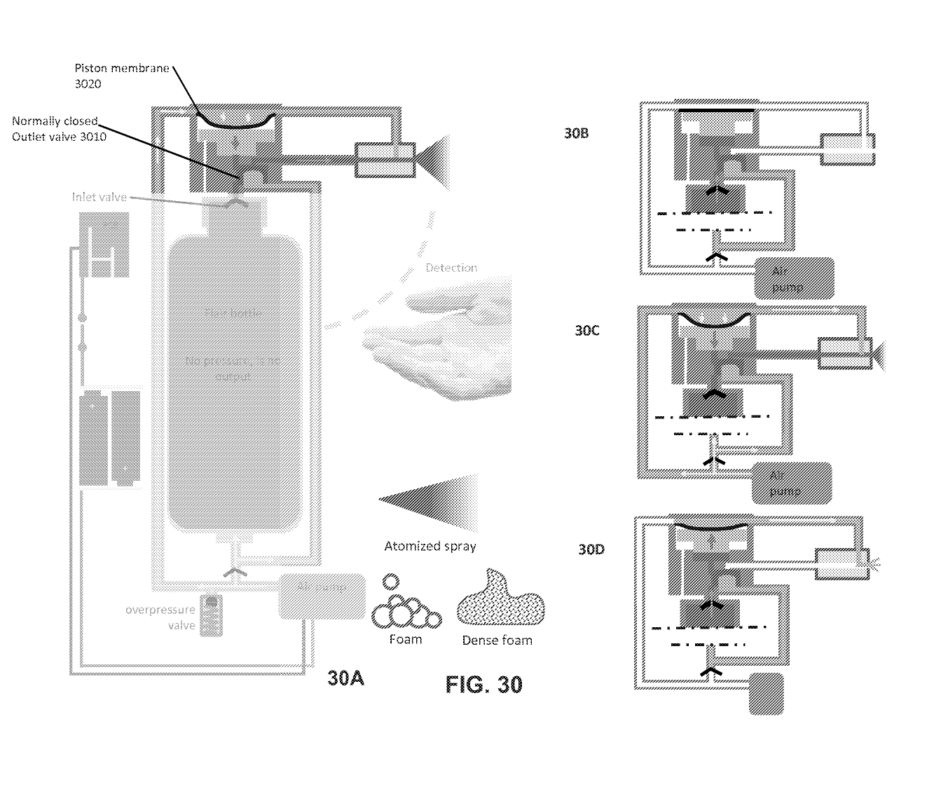

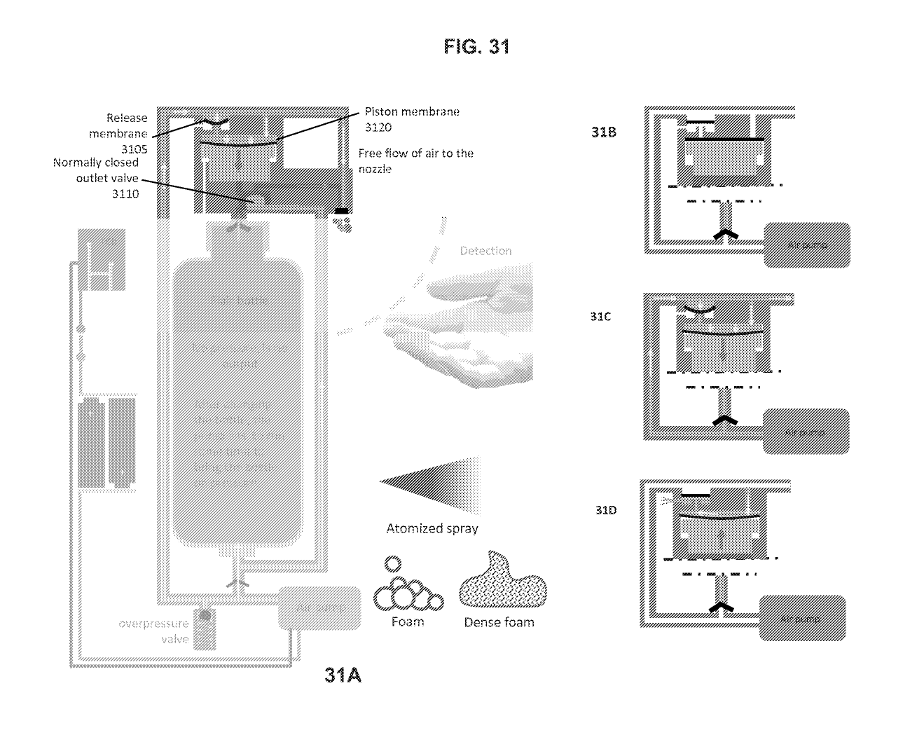

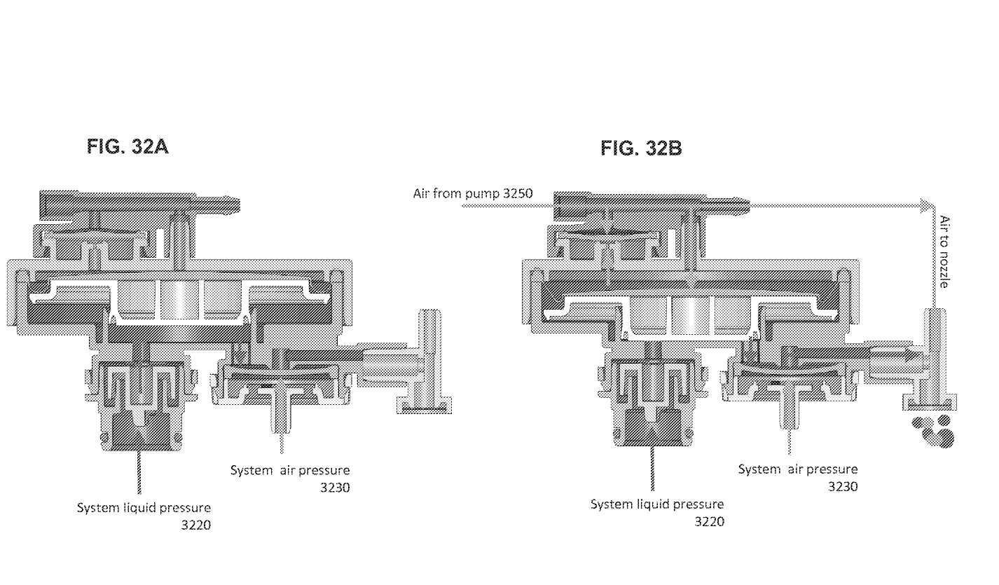

FIGS. 30 and 31 show two variations of piston actuated overpressure-based systems for dispensing metered doses of a mixed liquid/air output. It is convenient to illustrate the various liquid and propellant/venting circuits using schematics. However, in the real world, the actual devices used for the dispensing head look a bit different. Thus, in many examples herein, both are presented. FIG. 32 thus illustrate actual exemplary devices used in dispensing systems represented schematically in FIG. 31. Therefore, FIG. 32A is analogous to FIG. 31A and FIG. 32B is analogous to the dispensing system in the mode shown in FIG. 31C.

FIG. 30A shows a Flair bottle combined with an overpressure dispensing head. The Flair bottle has an integrated inlet valve. Thus, the “pump” here is actually a combination of the dispensing head and the valve in the bottle. The dispensing head has a piston and a piston membrane 3020, and a liquid chamber below the piston which is connected to a normally closed outlet valve 3010. With reference to FIG. 30B, in a default state, the system is at operating pressure which means that the liquid inside the bottle is pressurized and the same pressure is behind the normally-closed outlet valve 3010. In FIG. 30C, in a dispensing cycle, the pump runs, pumping air behind the membrane and simultaneously towards the nozzle. The piston membrane pushes the piston downwards and the piston thus pushes the liquid from the liquid chamber towards the nozzle. Air and liquid mix, creating a spray, foam or dense foam, as shown in FIG. 30A. Finally, in FIG. 30D, an end-of-dispensing-cycle mode is shown where the pump stops running and the pressure behind the membrane drops. Remaining air on top of the membrane is released through the nozzle and the liquid chamber fills up again.

FIG. 31 depict the identical system as shown in FIG. 30, except for the addition of release membrane 3105 above piston membrane 3120. The system operates similarly to that of FIG. 30 except that, at FIG. 31C, in a dispensing mode, the pump runs, pumping air behind the membranes. Here the release membrane closes, and the piston membrane pushes the piston downwards. At FIG. 31D, at an end of dispensing cycle, after dispensing, the pressure drops. The release membrane opens, letting off all pressure rapidly. This feature prevents air bubbles to form at the nozzle, for example, due to the air line still being under pressure when the liquid flow abruptly stops. This release valve provides rapid depressurization for the air line as well.

With reference to FIG. 32A, the liquid at system pressure 3220 enters through the bottom of an interface with the bottle. It passes through to the liquid chamber underneath a piston, as shown in FIG. 31. Also underneath the piston is an outlet channel which passes by, and must overcome the tension of, a normally-closed outlet valve which is exposed on its underside to system air pressure 3230. So the bottom of FIG. 32A actually has both the bottle and the system pressure fed to the underside of the normally closed outlet valve in the same configuration as is shown in FIGS. 30 and 31. For dispensing, as shown in FIG. 32B, in response to a hand being placed near the sensor, the pump turns on, air is introduced from the pump at the top of the air circuit 3250 and is introduced via the tube, both above the release valve and on top of the piston membrane. It also is fed through, in parts not shown, to the nozzle. The operation is exactly as described above in connection with FIG. 31.

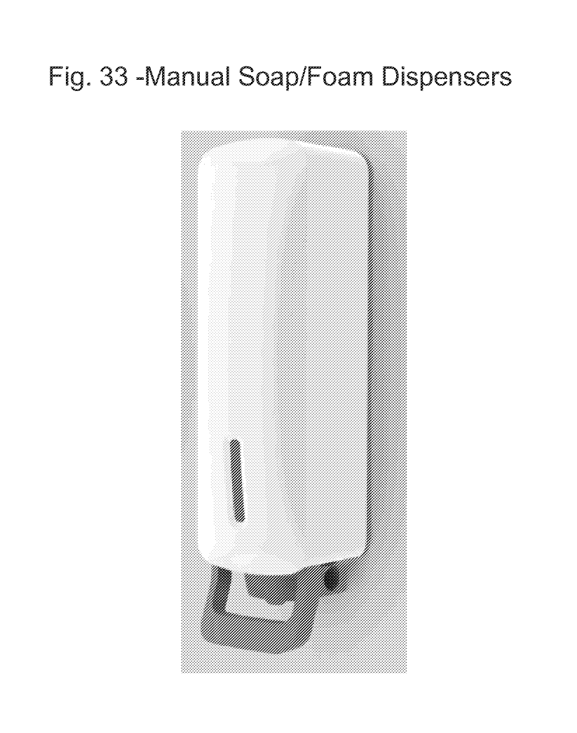

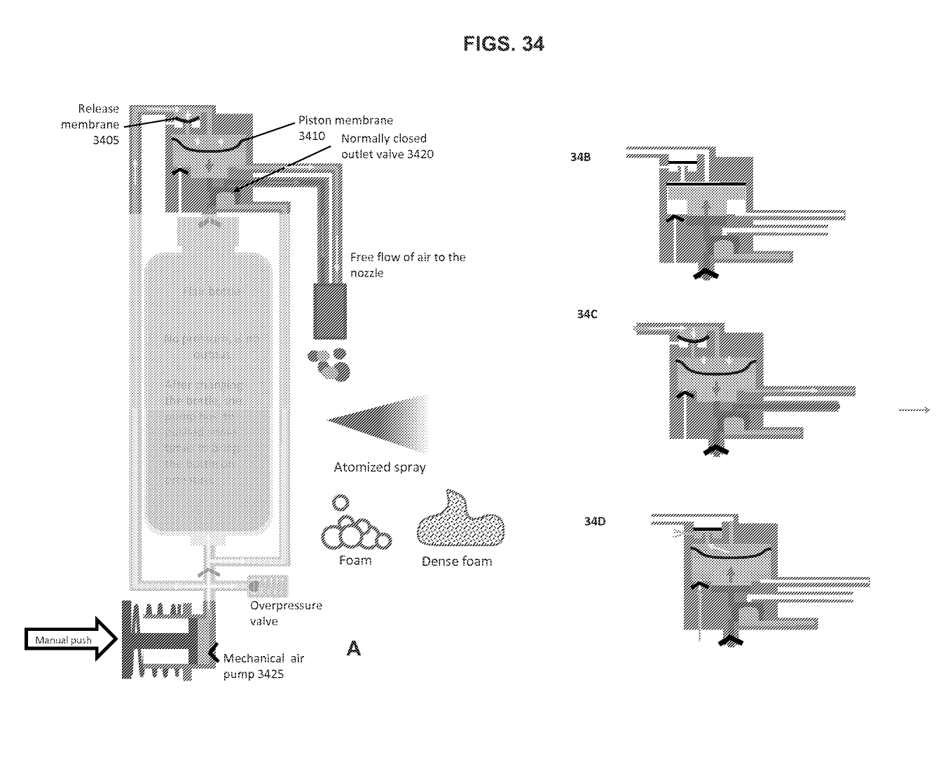

FIG. 33 shows an exemplary manually-operated soap/foam dispenser of the type shown in FIG. 27B. FIG. 34 schematically describes exactly such a manually-operated system. With reference to FIG. 34A, the system is essentially the same as the system shown in FIG. 31, except that instead of a pump operated by a sensor and a PCB card, there is a bellows which a human pushes on to pressurize the piston membrane, as shown in mechanical air pump 3425. This has the same function as the pump turning on in automatic systems, that is, to create a pressure above release membrane 3405 and piston membrane 3410, which causes the piston to move downward and the liquid in the chamber underneath the piston to overcome the pressure of normally-closed outlet valve 3410, which causes the liquid to move to the nozzle. In addition, air is also routed from underneath the piston to the nozzle (by means of a one way valve under piston) and various outputs can be created with such mixing, such as, for example, an atomized spray, foam or a dense foam. The distinction to be noted in FIG. 34 is that because this is a manually-pushed air pump 3405, the air that is routed to the nozzle comes from underneath the piston because, unlike the pump situation of FIG. 31 or 30, there is no propellant line to the nozzle from pump 3425—it is not convenient to require a user to additionally further so that the mix can be created. Thus metered air is sent to the nozzle from under the piston (and thus blocked by one way valve shown on left under piston).

With reference to FIG. 34B, in a default state, the system is at operating pressure, and thus the liquid inside the bottle is pressurized and there is the same pressure behind the outlet valve 3420. With reference to FIG. 34C, in a dispensing mode, the mechanical air pump is activated, pumping air behind both release membrane 3405 and piston membrane 3410. The release membrane closes and the piston membrane pushes the piston downwards. It is noted that the piston has a large surface area on top and a smaller surface area on the bottom. This causes a step up in pressure proportional to the step down in surface area, thus amplifying the pressure on piston membrane 3410. As a result of this step up in pressure exerted by the piston, the liquid is pushed out of the liquid chamber, past outlet valve 3420. Atmospheric air under the piston membrane is also pushed towards the nozzle, as described above. With reference to FIG. 34D, in an end of dispensing cycle mode, after dispensing, the pressure above piston membrane 3410 drops. The release membrane thus opens letting off all pressure rapidly. The liquid chamber then fills with liquid in response to the underpressure created in the liquid chamber.

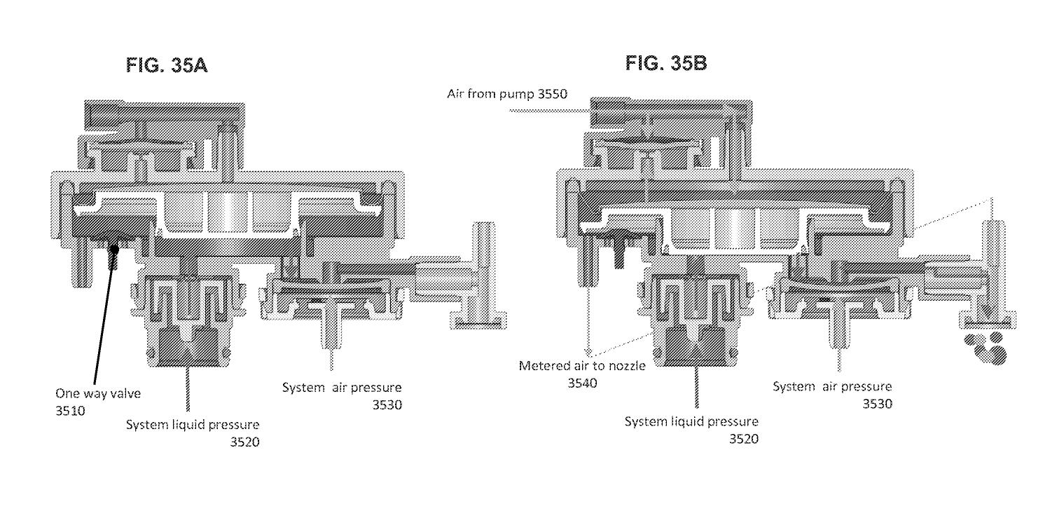

FIG. 35 depict an actual real world exemplary device which can implement the system depicted in FIG. 34. FIG. 35A is the system in default state and FIG. 35B shows the system in a dispensing state. With reference to FIG. 35A, there is a one-way valve 3510 that allows air to enter under the piston. Continuing with reference thereto, system liquid pressure 3520 prevails in the bottle, and system air pressure is on the open or underside of normally-closed valve 3530. This is the default state. FIG. 35B depicts the dispensing state, as shown in FIG. 34C, where air has been generated at the pump. This air 3550 enters the air circuit at the top of FIG. 35B which causes it to pressurize both the release membrane and the piston membrane. This causes the piston to move downward which places pressure on the liquid sufficient to overcome system air pressure 3530 on the normally-closed valve which allows liquid to flow to the nozzle. At the same time, from underneath the piston, metered air to nozzle 3540 is fed to the nozzle (no other outlet due to closed one way valve 3510) through a pathway schematically shown by the dotted arrow, and it mixes with the metered liquid at the nozzle.

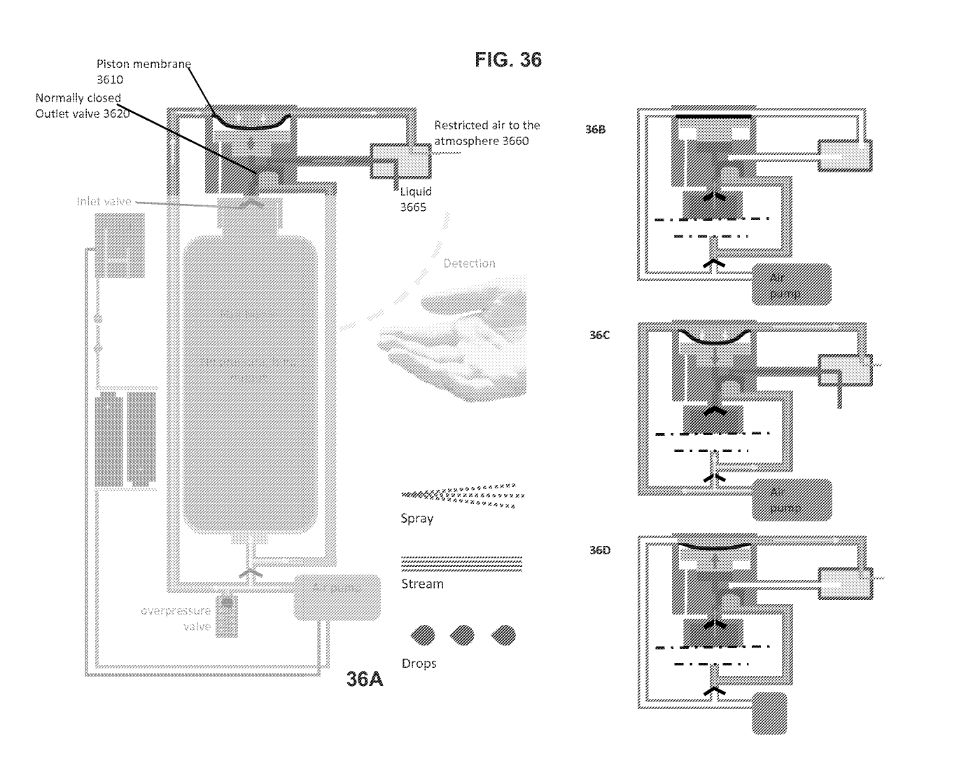

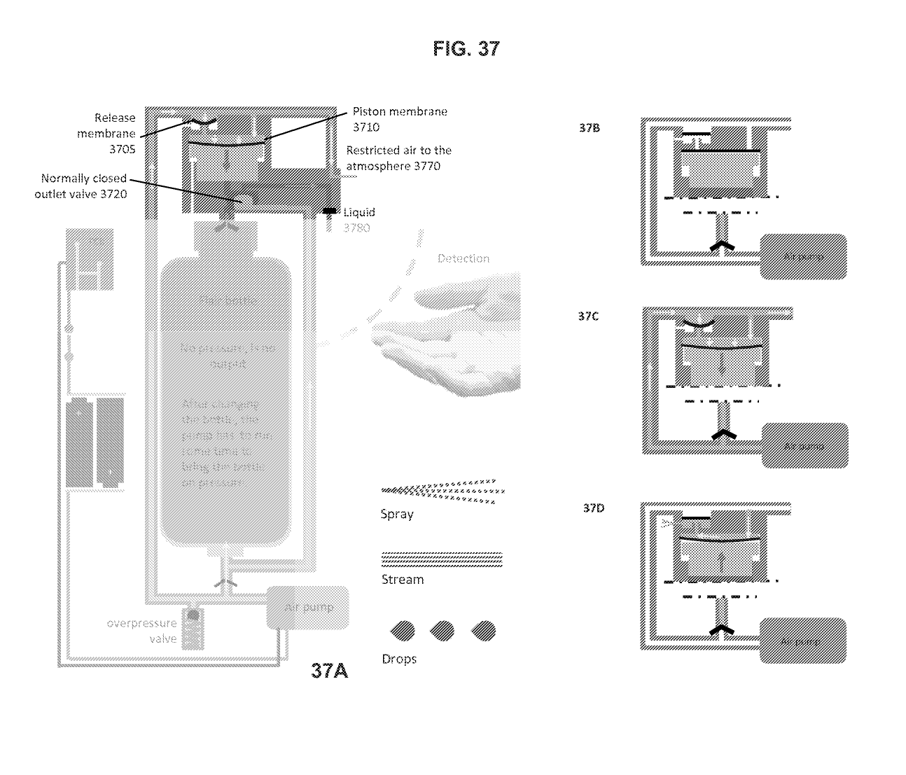

FIGS. 36 and 37 illustrate schematically an overpressure system for dispensing metered liquids (but not spray or foam) and, therefore, the air circuit is not directed to the nozzle at dispensing time. FIG. 36 is analogous to FIG. 30 except that there is no mixing of the air and FIG. 37 is directly analogous to FIG. 31 with the same proviso.

With reference to FIG. 36B, in a default state, the system is at operating pressure which means that the liquid inside the bottle is pressurized and the same pressure is behind the normally-closed outlet valve 3620. In FIG. 36C, in a dispensing cycle or a dispensing mode, the pump runs, pumping air behind the membrane and simultaneously towards the nozzle. Piston membrane 3610 pushes the piston downwards and the piston thus pushes liquid 3665 from the liquid chamber towards the nozzle. No air is mixed with such liquid and the output is, depending upon the nozzle and the liquid used, either a spray, a stream, drops, or somewhere in between. Finally, in FIG. 36D, an end-of-dispensing-cycle mode is shown where the pump stops running and the pressure behind the membrane drops. The air on top of the membrane is released through the nozzle (there being no release membrane) and the liquid chamber fills up again.

FIG. 37 is the identical system as FIG. 36 except for the addition of the release membrane 3705. The system operates in the same way as described above in connection with FIG. 31, except that, once again, at the outlet nozzle, there is no mixing of air and thus the output is either one of a spray, a stream, or drops, or the like.

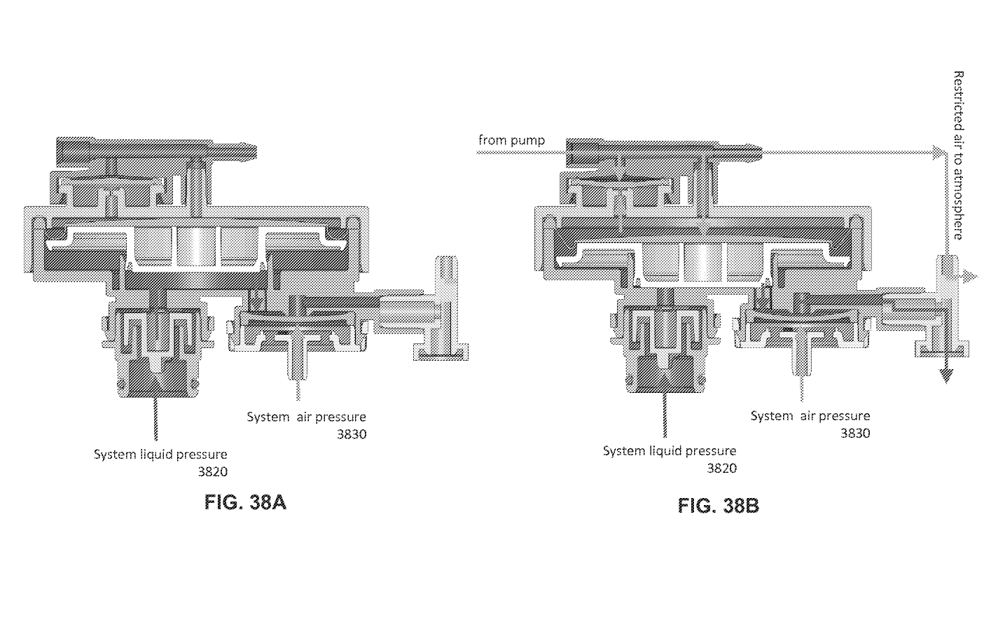

FIG. 38 are an exemplary real world embodiment of the system shown in FIG. 37. They operate in identical fashion to the exemplary devices shown in FIG. 35 except that because there is no mixing of air, there is no need to route air from the separate air circuit as shown in FIG. 32 and, therefore, when the air is released, it simply dissipates to the atmosphere through the nozzle. It is noted that in FIGS. 36D, 37D, and 38B, at the end of dispense cycle, when the pump stops running and the pressure behind the membrane drops, the air on top of the membrane is released through the nozzle but via a restricted path, using an air restriction, so that it does not happen in an erratic fashion. Were it not for this restriction, the system could have difficulty building up pressure on top of either the release membrane or the piston membrane because the air pumped in would have an unfettered exhaust directly open to the atmosphere, not being redirected within the nozzle to mix, as in metered mix dispensing systems.

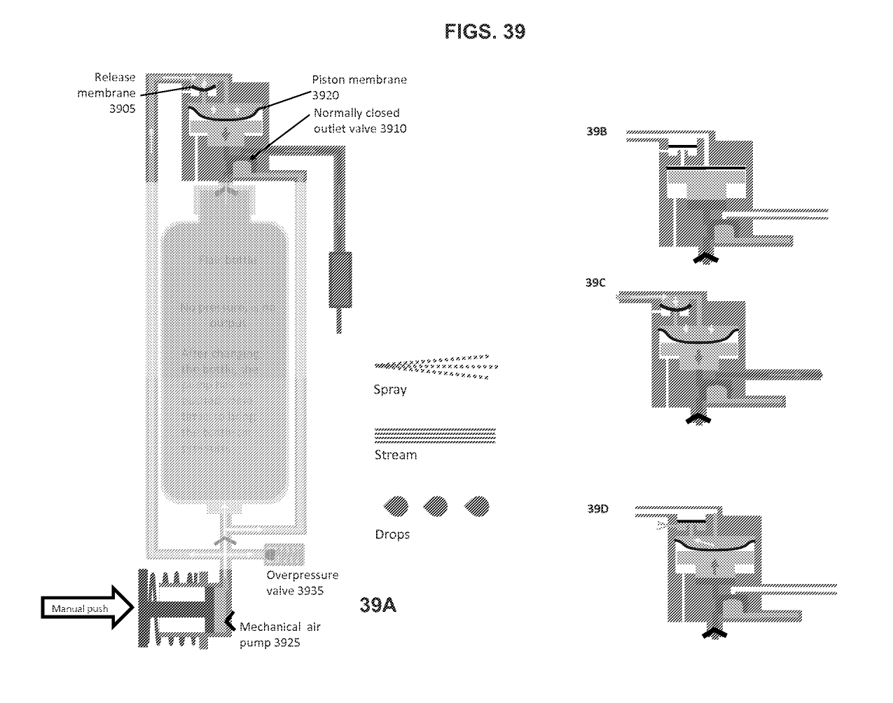

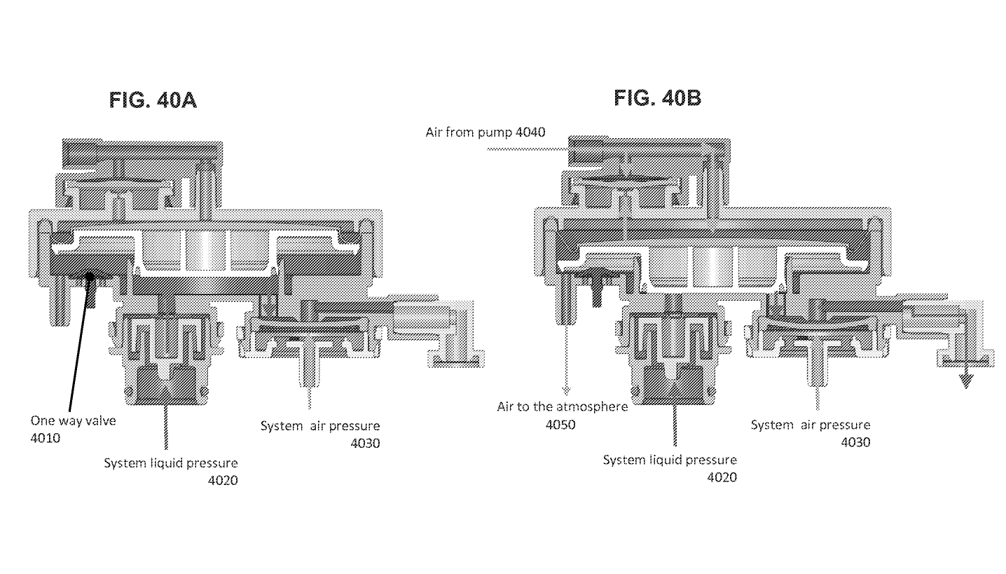

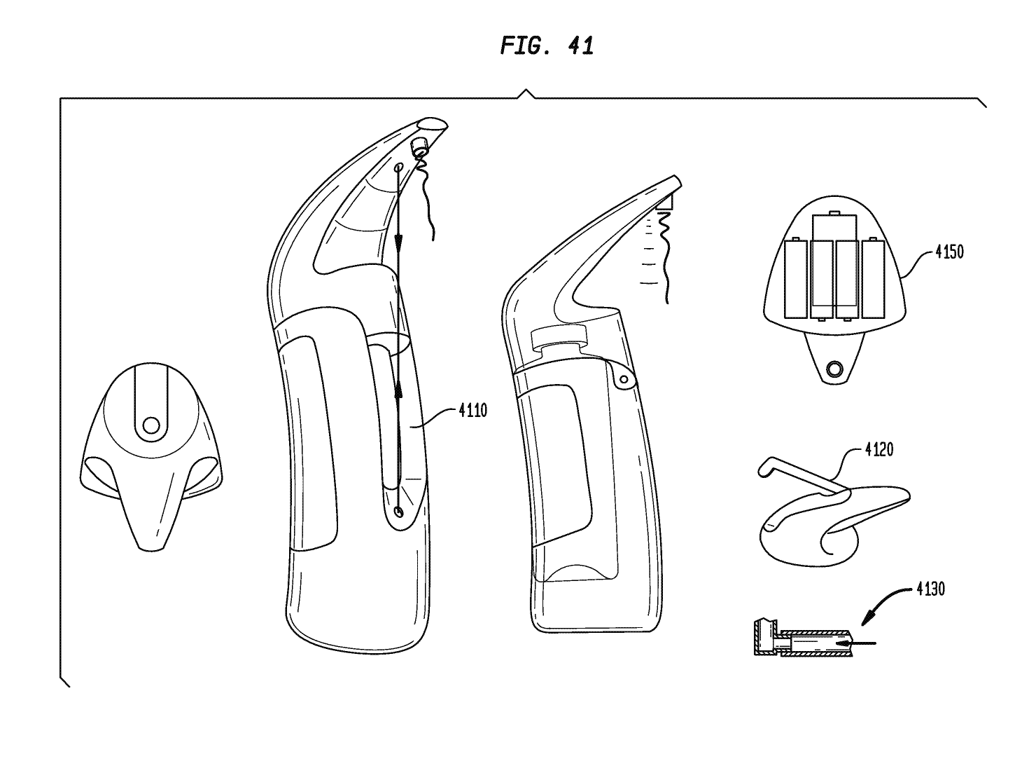

FIGS. 39 and 40 also show a related version of the metered liquid dispensing system, using an overpressure based system, but here again, using a manually-operated pump, as in the case of FIG. 34. FIGS. 39 and 40 are thus directly analogous to FIGS. 34 and 35 with the exception that there is no mixed output, but just a metered quantity of liquid as next described.

With reference to FIG. 39B, the system is at default and, therefore, the system is at operating pressure which means that the liquid inside the bottle is pressurized and the same pressure is behind the normally-closed outlet valve 3910. With reference to FIG. 39C, in a dispensing configuration, mechanical air pump 3925 is activated, thus pumping air behind release membrane 3905 and piston membrane 3920. As a result, release membrane 3905 closes and piston membrane 3920 pushes the piston downwards. Liquid is pushed out of the liquid chamber, past normally closed outlet valve 3910, and atmospheric air under piston membrane 3920 is exhausted in the canal under the piston (see left side). [and NOT pushed towards the nozzle. FIG. 39C should have the last text sentence deleted]. With reference to FIG. 39D, in an end-of-dispense cycle mode, after dispensing the pressure drops above the release membrane and above the piston membrane. Therefore, the release membrane opens, letting off all pressure rapidly as shown in FIG. 39D. The liquid chamber fills with liquid due to the underpressure.

FIG. 40 illustrate the system depicted schematically in FIG. 39 in both the default state and a dispensing state. Thus, FIG. 40A is directly analogous to FIG. 39B and FIG. 40B is directly analogous to FIG. 40C. This system is essentially identical to that shown in FIG. 38 except that because it is a manually-operated system, instead of exhausting the air from the air circuit through a restriction to the atmosphere out the nozzle, it is exhausted from underneath the piston at 4050 at the end of a dispensing cycle, as described above. [It is noted that there should not be a one way valve at the bottom left of FIGS. 40A and 40B; this is a liquid only dispensing system. Right is reserved to correct the error in these figures].

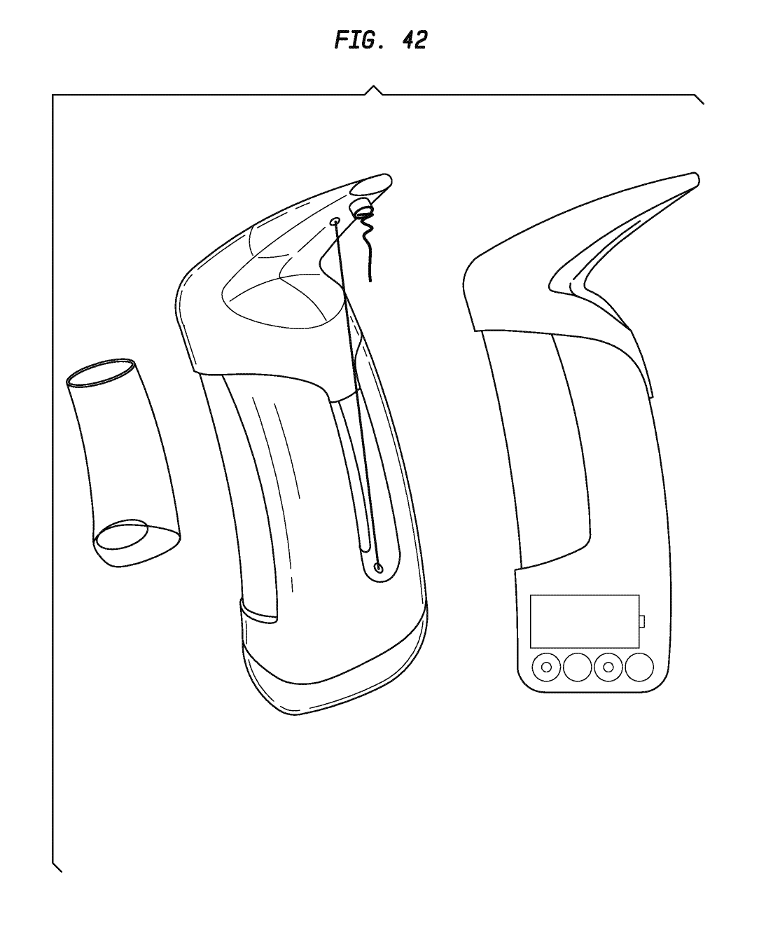

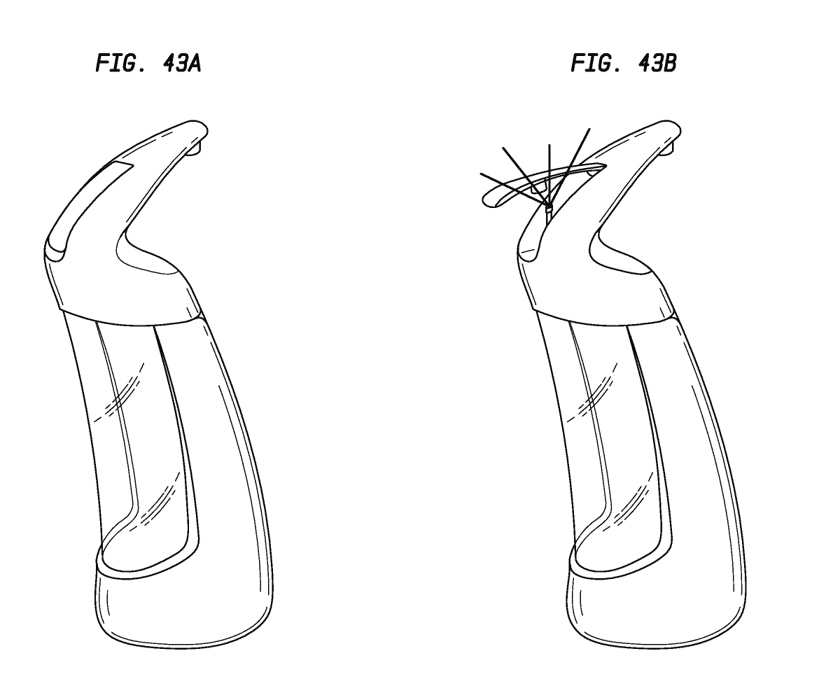

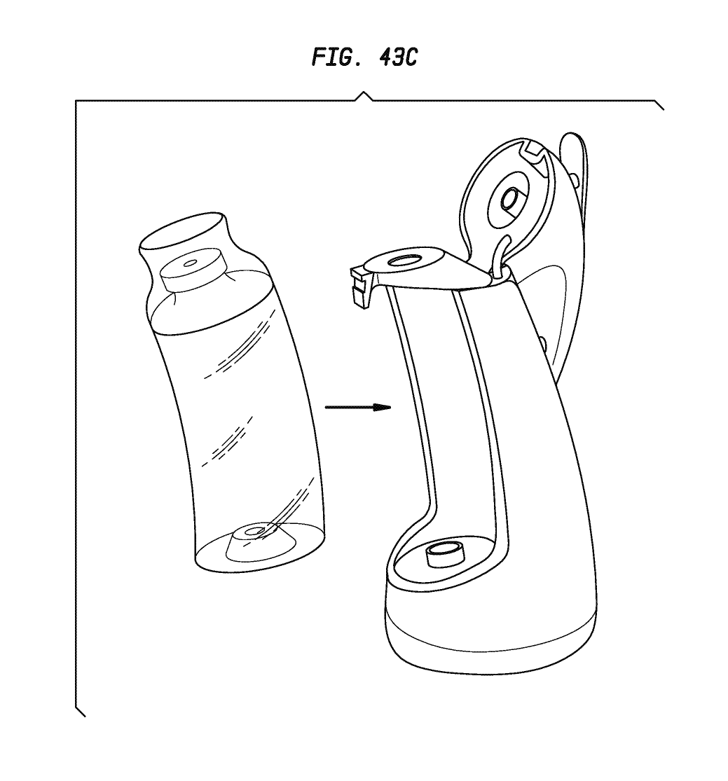

FIGS. 41-43 depict an exemplary system for dispensing soap, shaving foam, or shaving cream, shaving gels or other gels including toothpaste and the like. Such a device is adapted to be used in bathrooms or kitchens and the like to conveniently dispense such items. Essentially, it is similar to the devices schematically shown in FIG. 31 or if no air is desired, in FIGS. 36 and 37. With reference to FIG. 41, there is shown at the far left a device in a side view having dispensing orifice at the top (where a small squiggly blue line is drawn representing the shaving cream exiting the device and a sensor light line which when broken can cause the device to begin dispensing. That sensor light line is drawn between two openings, one at the top and one at the bottom of an opening 4110 which is used to allow user to see the contents of the bottle and also to provide a space for the hinge-top and sensor when the device is closed. It is noted that the device has no circular base because of the batteries in the pump which must be integrated in the bottom 4150. On the back of the device there is a release for the hinged top 4120 and an air plug 4130 which releases air pressure when replacing a bottle. These are over-pressure systems and when one releases a bottle one needs whatever remaining liquid there may be in the inner container to be depressurized while removing it or while replacing a new refill container. The air plug allows that to occur. FIG. 42 shows side views of the device of FIG. 41. FIG. 43 shows the operation of inserting a refill bottle for the device. With reference thereto, FIG. 43A shows a bottle inside the device. FIG. 43B shows when pulling of the lever to released the hinged top that the compressed air from the bottle is released. FIG. 43C shows insertion of a new bottle in the now hinged back top which can be replaced to once again assume the configuration of FIG. 42 for dispensing. It is noted that additional features can be added to the systems of FIGS. 41-43, such as heating elements, for example, to heat the shaving cream for a hot shave. Similarly, where dispensing systems are used to dispense foodstuffs, such as soup, similar heating elements can be added to provide hot soup, or hot chocolate, as the case may be. Such heating elements can be located within the housing, and maintain the heat in the bottle until dispensing, for example. Or, for example, to propellant can be heated, and as it circulates around the liquid in the Flair bottle, it can heat it.

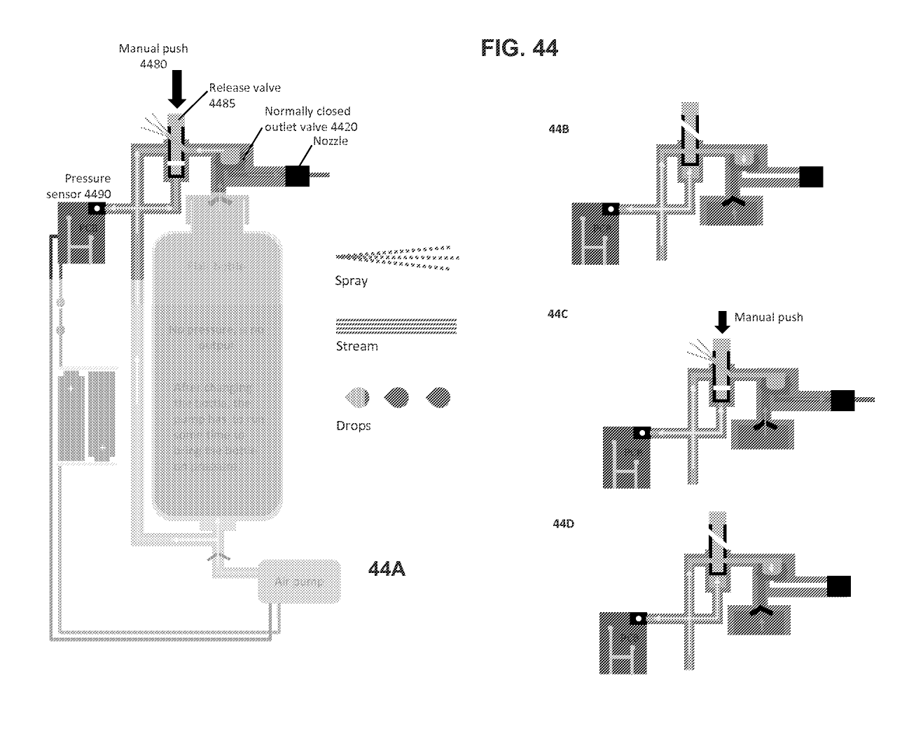

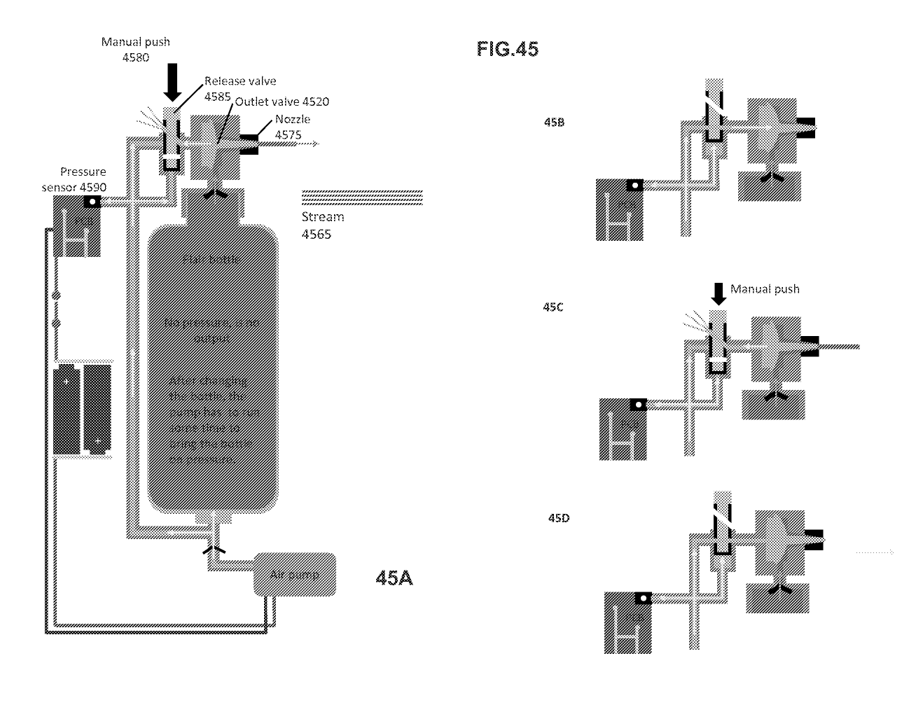

FIG. 44 illustrate an exemplary dispensing device, overpressure based, for non-metered (continuous stream while actuated) liquid. Such an exemplary device is activated by a release valve and a pressure sensor, as next described. With reference to FIG. 44A there is seen a pressure sensor 4490 which senses pressure in the air circuit. There is also a manual push button 4480 which engages a release 4485. The release valve when activated releases system pressure on top of normally closed outlet valve 4420. This allows normally closed outlet valve 4420 to move upwards allowing the fluid circuit line running from the bottle out to the nozzle to have an open path and dispensing of either spray, stream or drops can occur, as shown. It is noted that in the configuration of FIG. 44 the normally closed outlet valve 4420 is upside down relative to its normal position as shown, for example, in FIGS. 34, 36, 37 and others. This is done in order to allow release valve 4485 to operate and therefore the back or underside of normally closed outlet valve 4420 now has to be in direct line with release valve 4485. With reference to FIG. 44B, in a default configuration, the system is at operating pressure. Thus, the liquid inside the bottle is pressurized and the same pressure pertains behind (above) normally closed outlet valve 4420 and release valve 4485. The pressure sensor, which can, for example, be integrated in a PCB board, activates the pump whenever the system pressure drops below a specified level, thus maintaining system pressure, and thus holding normally closed outlet valve 4420 in a closed position. FIG. 44C illustrates a dispensing configuration. Here the release valve has been pushed by a manual activation device 4480. As a result, system pressure above normally closed outlet valve 4420 is released and normally closed outlet valve 4420 opens, allowing liquid to flow. In FIG. 44D an end-of-dispense-cycle configuration is illustrated. Here, the release valve is no longer pushed, thus air now at system pressure pushes up the release valve and the system pressure air can also now pass through the release valve to the outlet valve which thereupon closes, stopping fluid flow. FIG. 45 illustrate a similar system. This is a non metered liquid overpressure based system, with a needle type closing dome valve. Outlet valve 4520 in FIG. 45A is notably different than normally closed outlet valve 4420 of FIG. 44. As shown in FIG. 45, in FIG. 45A outlet valve 4520 is shown which allows a vertical path across it from Flair bottle to nozzle 4575 when it is opened. In the depicted configuration of FIG. 45A, it is closed as a result of system pressure behind it. With reference to FIG. 45B, this is the default configuration where the system is at operating pressure and the liquid inside the bottle is pressurized and the same pressure pertains behind outlet valve 4520 to (the left in this drawing) and in release valve 4585. As above, pressure sensor 4590 activates the pump whenever the system pressure drops. In FIG. 45C, in a dispensing configuration, release valve 4585 is pushed by manual actuation. System pressure air behind outlet valve 4520 is released. This causes outlet valve 4520 to open and fluid to flow past it out to nozzle 4575. In FIG. 45D is depicted an end of dispensing cycle, where the release valve is no longer pushed. System pressure air pushes up the release valve and system pressure air can now pass to outlet valve 4520 which closes it.

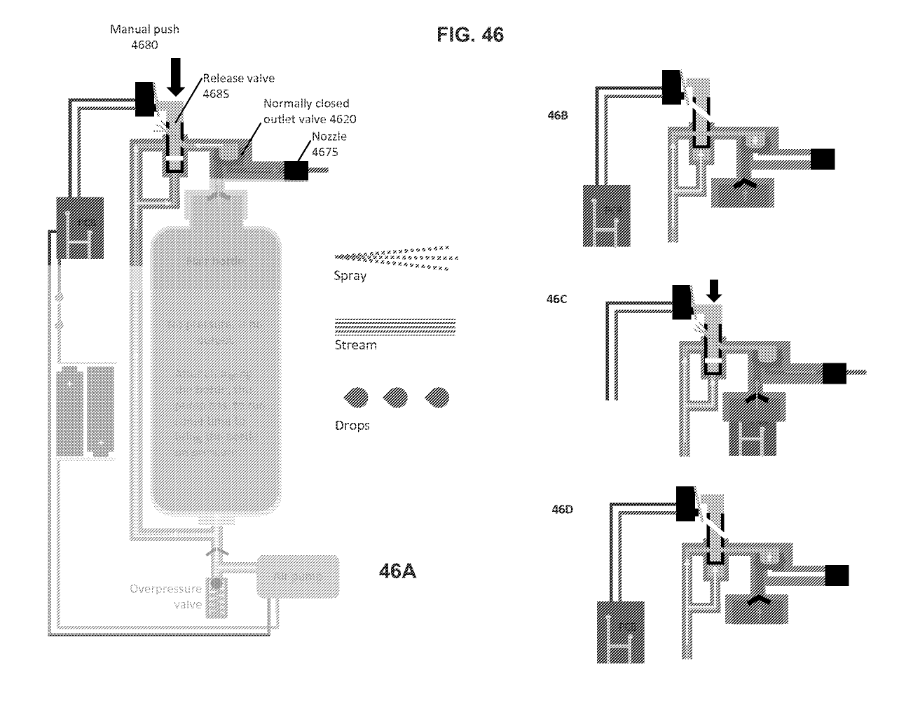

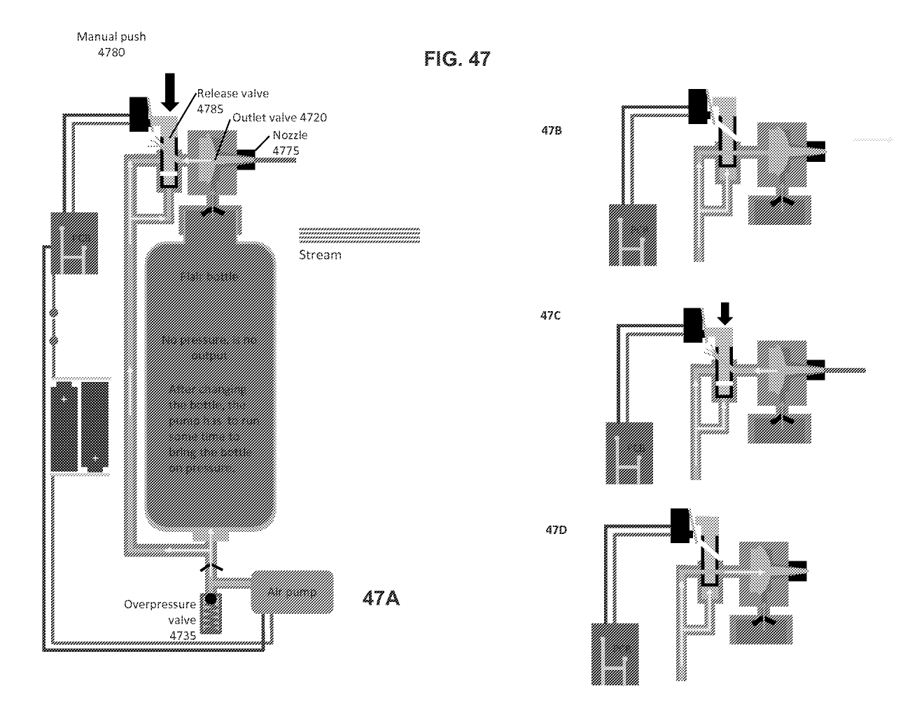

FIG. 46 are directly analogous to FIG. 44, and FIG. 47 are directly analogous to FIG. 45, except for the fact that in FIGS. 46 and 47, instead of a pressure sensor such as shown in FIGS. 44 and 45, there is a micro-switch which turns on to activate the pump when the release valve is pressed. Thus with reference to FIG. 46C the release valve is pushed by a user, the micro-switch activates the pump, and as a result, system pressure air behind the outlet valve 4620 is let off, and outlet valve 4620 opens. With reference to FIG. 46D, at an end of dispense cycle the release valve is no longer pushed, the pump stops, the system pressure air pushes up the release valve and system pressure air can thus pass through outlet valve 4620, which now closes. The micro switch is used to sense the motion of the release valve and turn on the pump as opposed to using a pressure sensor to maintain system pressure. This alternative is less reliable, but the savings in part cost due to the lack of the pressure sensor can be worthwhile in certain applications and contexts.

The system of FIG. 47 operates in exactly the same way as that of FIG. 45, except that instead of a pressure sensor there is, again, a microswitch. This microswitch senses the motion of the release valve, as pushed by a user, and thus causes the dispensing.

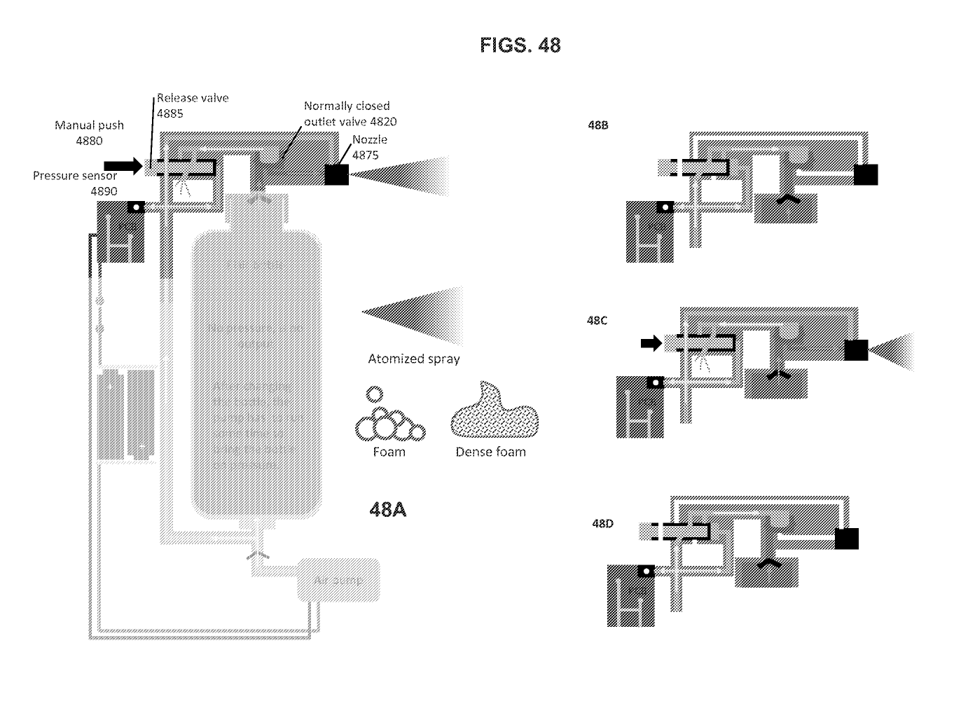

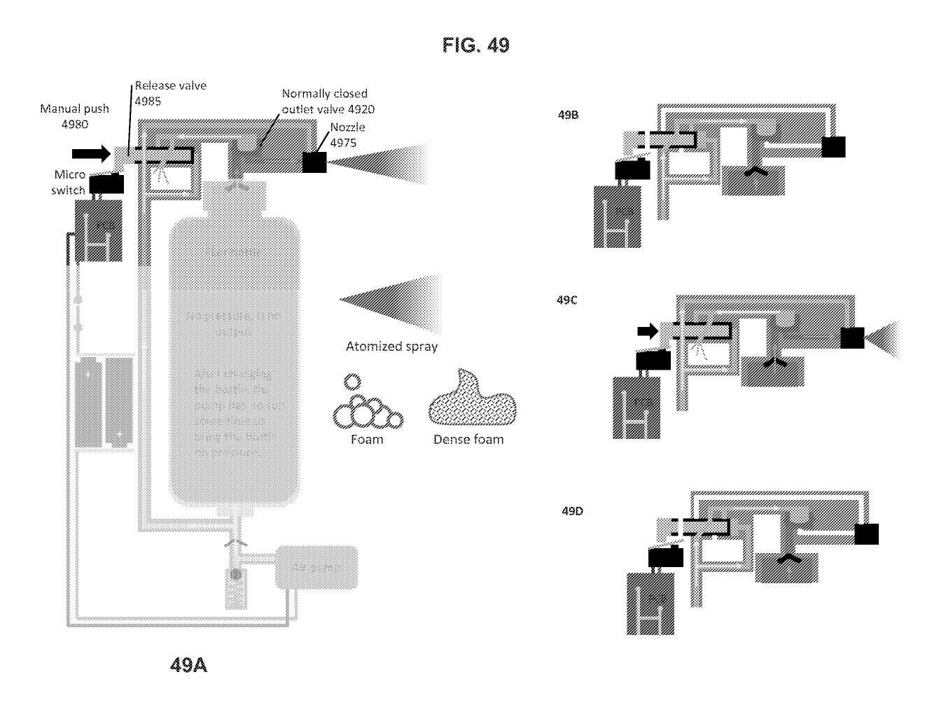

FIGS. 48 and 49 are two overpressure non-metered (i.e., flow continuous until user releases actuator) mix dispensing systems. In the case of FIG. 48 a pressure sensor is used in combination with a release valve, and in FIG. 49 a microswitch is used in connection with a release valve, and no pressure sensor is used, as described above. FIGS. 48 and 49 are thus analogous to FIGS. 44 and 46, respectively, but address a non metered mix as opposed to a non metered liquid only dispensate. Thus FIG. 44 depicts an exemplary overpressure system for dispensing a non-metered liquid (non-mix) which operates by release valve manual actuation and a pressure sensor to sense a drop in system pressure, and FIG. 46 is an overpressure-based, non-metered liquid (not mix) system which operates with a manually-actuated release valve and a microswitch in place of the pressure sensor. Similarly, FIGS. 48 and 49 are analogous systems used to dispense a non-metered mix which requires the air or propellant circuit to be mixed at the nozzle with the dispensed liquid so as to create an atomized spray, a foam, or a dense foam as shown.

Thus, with reference to FIG. 48A there can be seen the manual push 4880 here oriented slightly differently so as to allow a complete air circuit to go across the top of the dispensing head, and a release valve 4885 which is actuated by the push 4880. Additionally visible is pressure sensor 4890 which senses system pressure as described above. Normally closed outlet valve 4820 is here again, in its “upside down” configuration. With reference to FIG. 48B, in a default configuration, the system is at operating pressure. Thus, the liquid inside the Flair bottle is pressurized and the same pressure is maintained behind the outlet valve and the release valve. The pressure sensor activates the pump whenever the system pressure drops, thus maintaining system pressure. In FIG. 48C, in a dispensing cycle, the release valve is pushed, and system pressure air behind the outlet valve is let off. Outlet valve 4820 thus opens, allowing liquid to proceed to nozzle 4875 and now mix with the air from the separate propellant circuit to create a spray foam or dense foam. Finally, in FIG. 48D, in an end of dispense cycle, the release valve is no longer pushed. System pressure air pushes up the release valve, and system pressure air can pass to outlet valve 4820 which thus causes it to close.

It is noted with reference to FIG. 49A that there is a microswitch in place of a pressure sensor of FIG. 48A. With reference to FIG. 49B, the system is at operating pressure and thus the liquid inside the Flair bottle is pressurized and the same pressure is seen behind both the outlet valve (in this case above) and the release valve. Thus, the outlet valve is in a closed position. With reference to FIG. 49C, in a dispensing cycle, release valve 4985 is pushed, the microswitch activates the air pump being triggered by the release valve, and the system pressure air behind outlet valve 4920 (i.e., above it here) is let off thus opening outlet valve 4920 allowing liquid to flow to nozzle 4975 and mix with air from the air circuit. Finally, in FIG. 49D, at the end of a dispensing cycle, release valve 4985 is no longer pushed and the air pump stops. System pressure air pushes up release valve 4985, or in the case of FIG. 49—pushes it to the left to its home position—and system pressure air can, once again, pass to normally-closed outlet valve 4920 which, once again, closes, thus completing dispensing.

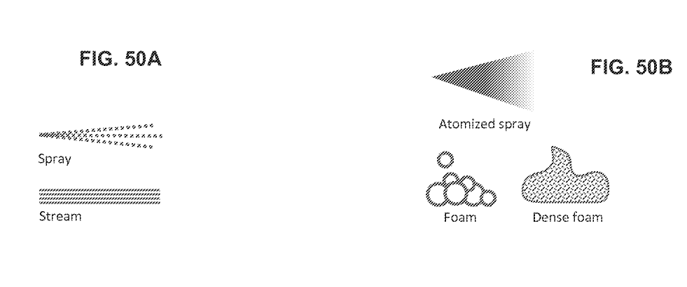

FIG. 50 depict a summary of the different types of underpressure systems. It is noted that most of the systems described in the preceding figures have been overpressure systems but it was also noted that for every overpressure system an analogous underpressure system using the same principles and built on the same platforms with slight modifications can be created. Thus, in exemplary embodiments of the present invention, for metered liquids an underpressure system can be used to create either a spray or a stream and such systems can have, for example, piston actuation with no release membrane, piston actuation with a release membrane, a manual air pump with a release membrane. On the metered mix side, shown in FIG. 50B, such underpressure systems can be used to dispense, for example, an atomized spray, a foam, or a dense foam. Such metered mix dispensing systems using underpressure platforms can include, for example, piston actuation with no release membrane, piston actuation with a release membrane and, for example, a manual air pump with a release membrane.

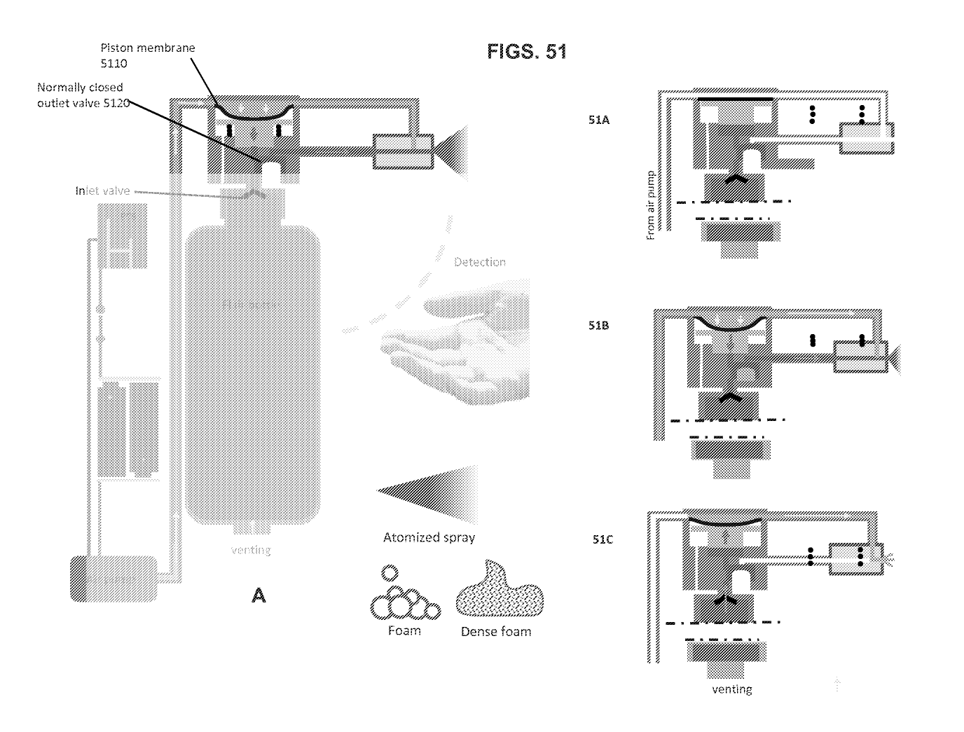

FIG. 51 illustrates one example of a piston actuation with no release membrane underpressure system. It is noted that this is but an example, and the principles shown in FIG. 51, and the corresponding modifications relative to the analogous overpressure system (in this case that of FIG. 30), can be replicated from any of the six exemplary systems as shown in the summary of FIG. 50.

Thus, with reference to FIG. 51, in FIG. 51A there is seen piston membrane 5110 and normally-closed outlet valve 5120. Here, once again, it is in its normal configuration. It is noted that FIG. 51 are essentially analogous to FIG. 30 except for the fact that FIG. 30 depict an overpressure system and FIG. 51 depict an exemplary underpressure system. With reference to FIG. 51B, in a default configuration, the piston is pushed upwards by the spring and liquid is, or has been, sucked into the liquid chamber. There is an air circuit shown from the air pump leading to the nozzle which is also shown in FIG. 51B. With reference to FIG. 51C, in a dispensing configuration, the air pump runs pumping air behind (above) piston membrane 5110 and simultaneously towards the nozzle. Piston membrane 5110 pushes the piston downwards against the spring and the piston thus pushes the liquid from the liquid chamber towards the nozzle. As described above, the piston creates a higher pressure in the liquid chamber due to the step-down in surface area of the piston which creates a step-up in pressure. Air and liquid mix in the nozzle creating a spray. In FIG. 51D, an end-of-dispense cycle configuration is shown. Here, the pump stops running and the pressure behind piston membrane 5110 drops. As a result, the air on top of piston membrane 5110 is released through the nozzle and the liquid chamber fills up again due to the underpressure created putting it back into the default position shown in FIG. 51B.

Exemplary Interfaces

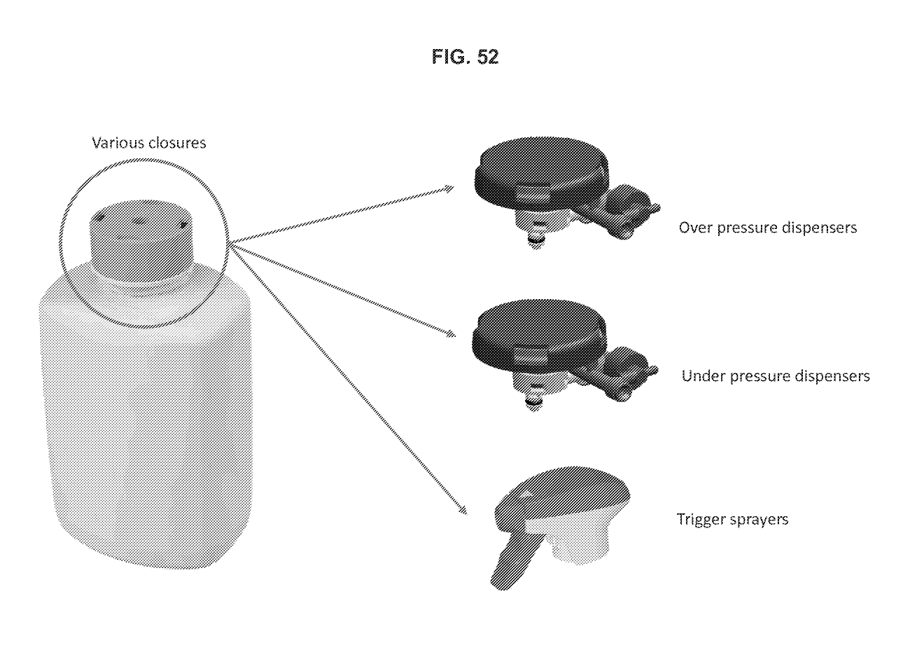

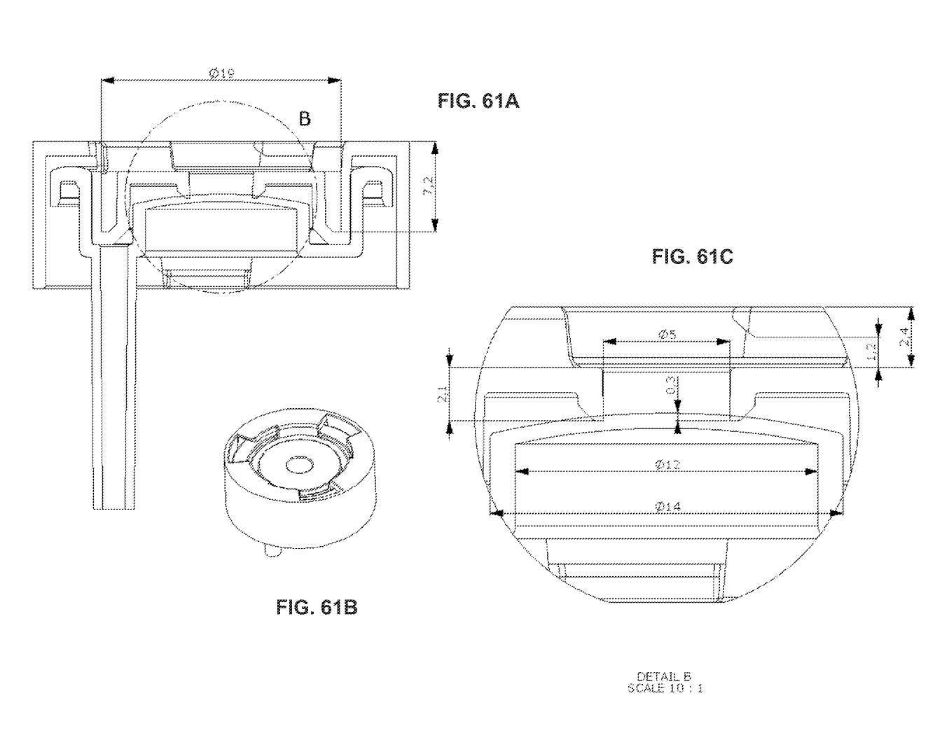

FIGS. 52-66, next described, relate to interfaces between a Flair bottle and a dispensing head of various possible types. FIG. 52 illustrate how each closure type can be used in combination with various dispensing heads such as, for example, over-pressure dispensers, under-pressure dispensers, and trigger sprayers. Thus, the closure is a platform independent type device which can be used in combination with a variety of different dispensing heads as an application, is customized, designed or assembled.

Closure with Shuttle Inlet Valve

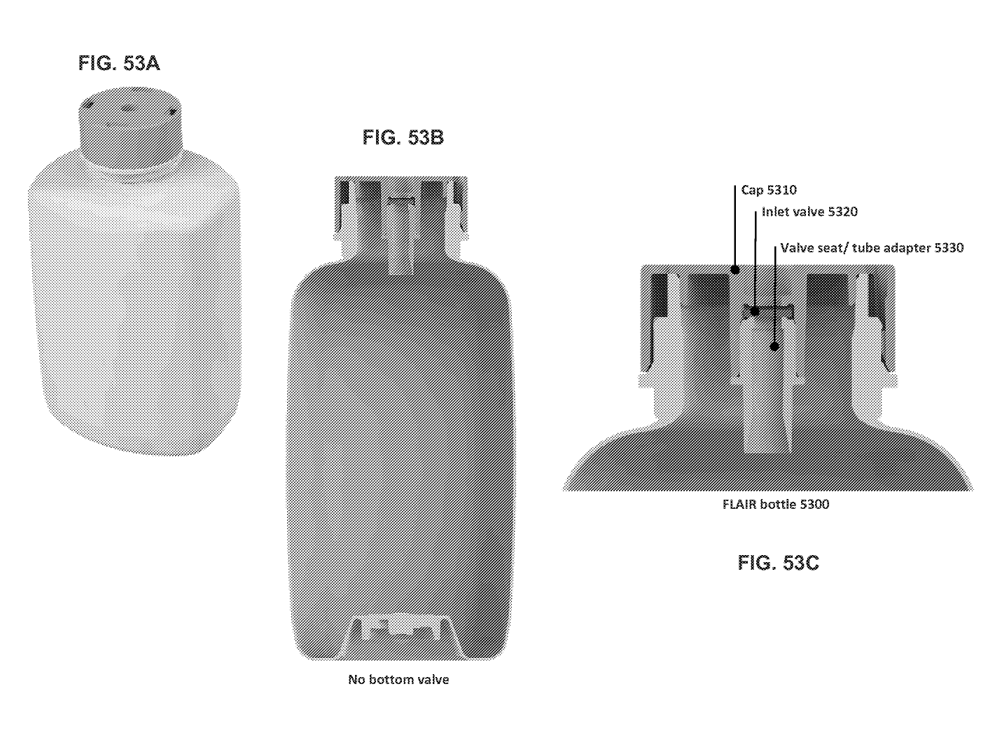

FIG. 53 provide details of an exemplary closure with an integrated shuttle inlet valve according to exemplary embodiments of the present invention. FIG. 53A shows a perspective view of a bottle with this type of closure and FIG. 53B is a cross-section along the long axis of the bottle showing FIG. 53B. As can be seen in FIG. 53B, there is no bottom air valve needed to be used with the bottle inasmuch as an appliance will provide this type of valving.

FIG. 53C is a magnified depiction of the top portion of FIG. 53B wherein one can see a cap, the inlet valve and the valve seat/tube adaptor. It is also noted that the bottle of FIG. 53 is a Flair-type bottle and thus has an inner container and an outer container and the propellant is introduced between the inner container and the outer container to exert pressure on the contents of the inner container. As illustrated above in numerous variations, this pressure can be an over-pressure or an under-pressure depending on the type of system desired. It is also important to note that the inlet valve can move or “shuttle” between a top position where it abuts the bottom of the cap and a bottom position where it abuts the top of the valve seat/tube adaptor. It is precisely this gap or distance which allow this shuttle inlet valve to do its job.

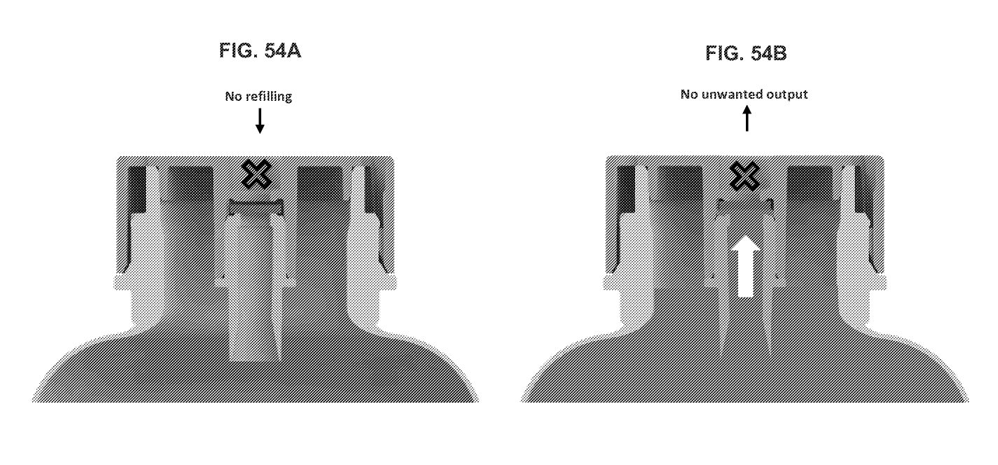

FIG. 54 illustrate certain features of the shuttle inlet valve according to exemplary embodiments of the present invention. With reference thereto, in FIG. 54A the application of pressure on top of the cap will not allow the bottle to be refilled inasmuch as the shuttle valve in response to the pressure immediately seats at its lowest position on top of the valve seat/tube adaptor. Thus if someone tries to refill the bottle the inlet valve closes. If someone tries to circumvent this design by damaging or removing the inlet valve then the bottle becomes useless and cannot maintain the Flair functionality. As shown in FIG. 54B, at the same time, using the other position of the shuttle inlet valve when the bottle is pressurized or squeezed the inlet valve closes again by the shuttle moving to the uppermost position which is abutting the bottom of the cap as shown. Thus the bottle cannot dispense any liquid unless is attached to a dispensing head of some kind, such as shown in FIG. 52. It is those dispensing heads which when properly attached to the closure with shuttle inlet valve that allow the inlet valve to be maintained open neither at the uppermost position or the lowermost position in which it would be closed.

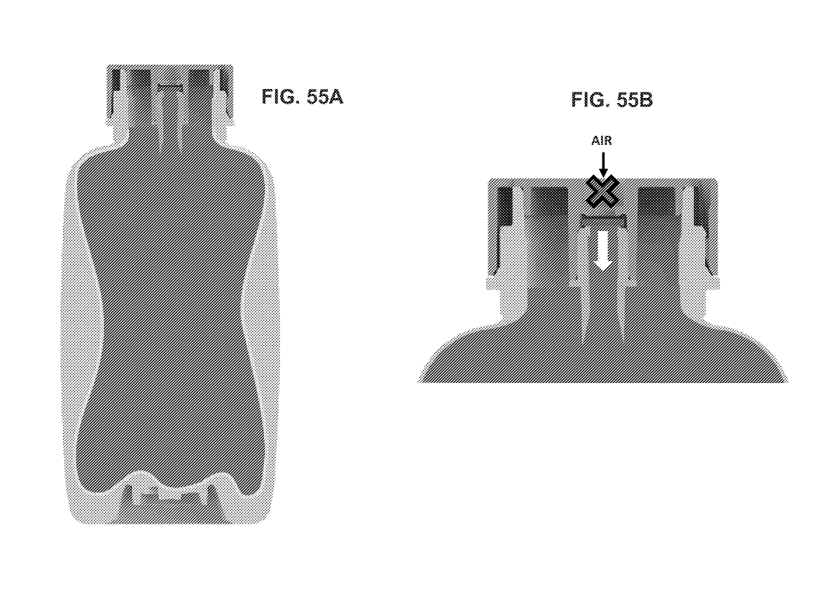

FIG. 55 illustrate how the inner layer does not sag in exemplary embodiments of the present invention. With reference to FIG. 55B, it is noted that when the refill is taken out of the device or when the refill refillable container, i.e., the bottle of FIG. 52, the inner layer would tend to sag. However, because the inlet valve drops to its lowest position, discloses any pathway to the inside layer, the air cannot enter and therefore the inner layer of the bottle does not sag.

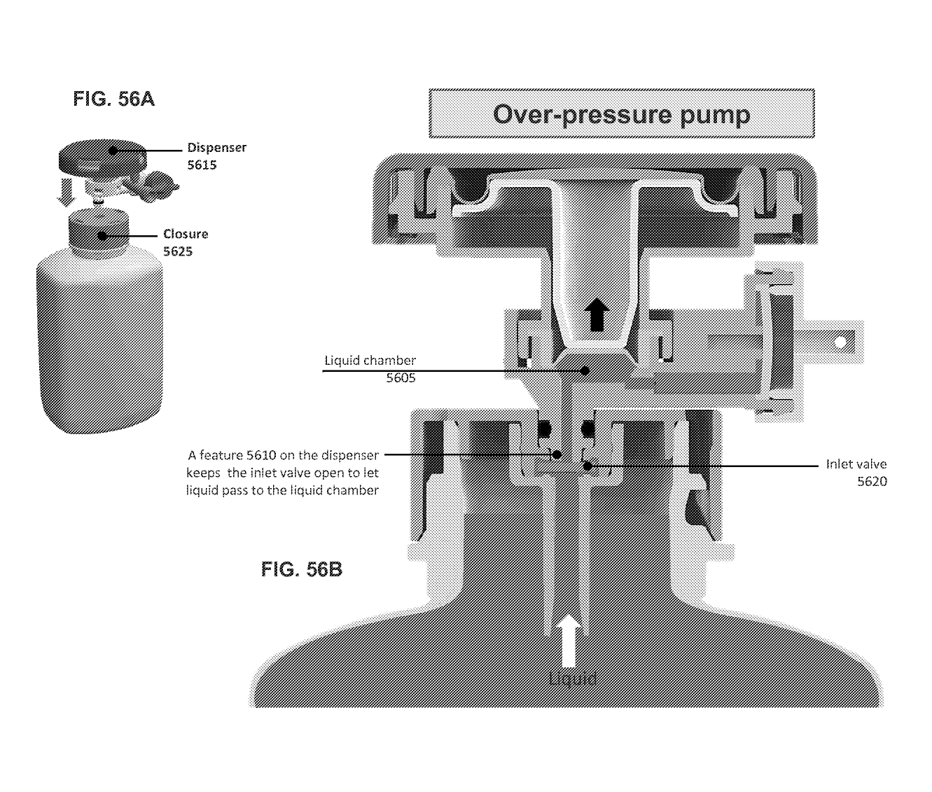

FIG. 56 show how the exemplary shuttle inlet valve can interface with the dispensing head. The left drawing or the left image of FIG. 56 illustrates generally the positions of a bottle with closure and a dispenser cap or dispenser head of any type being pushed down into the center hole of the closure mechanism. This is shown in much greater detail in FIG. 56b which shows, for example, an over-pressure pump-type dispensing head. Thus, the dispensing head, as shown and described above, is provided with a liquid chamber in its lower portion and it has a feature on the bottom 5610 which keeps the inlet valve 5620 open so as to let the liquid in the bottle pass to the liquid chamber. As can be seen the dispenser or the feature 5610 keeps the inlet valve open precisely by forcing it to rest or seat lower than its uppermost position in which case it would close off as shown in FIG. 54A but not all the way down to its lowest position where it would also close off as shown above in FIG. 54A. Precisely by holding it midway within its physical range or vertical range the feature 5610 allows an appropriately configured dispensing head to in fact have fluid communication with the bottle. It is noted that the same interfacing between the Flair-type bottle and the dispensing head can be used, in exemplary embodiments of the present invention, for both overpressure type pumps such as shown in FIG. 56, or under-pressure pumps as shown in various other figures.

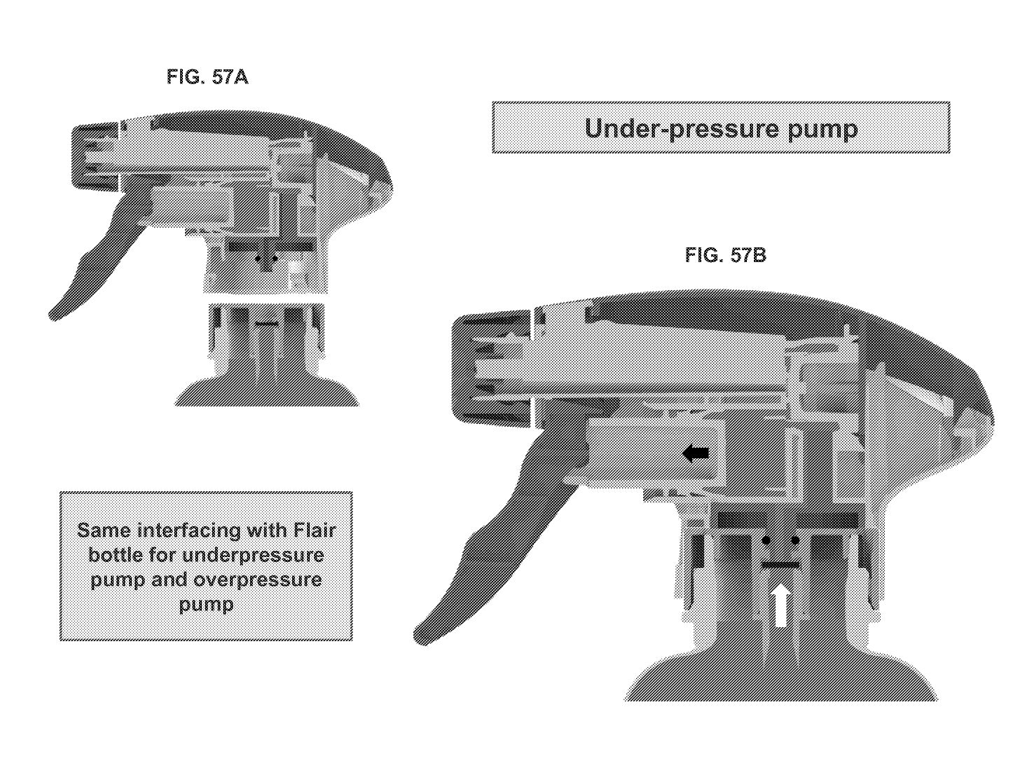

FIG. 57 illustrate use of a Flair bottle such as shown in FIG. 53 with an under-pressure pump such as one used in a trigger sprayer as shown in FIG. 52. Because both the under-pressure pump, as shown in FIG. 57, and the over-pressure pump, as shown in FIG. 56, have the similar feature 5610 that interfaces with the central hole of the closure with shuttle inlet valve, the same interfacing can be used between a Flair bottle and any under-pressure pump or over-pressure pump as included within various exemplary embodiments of the present invention.

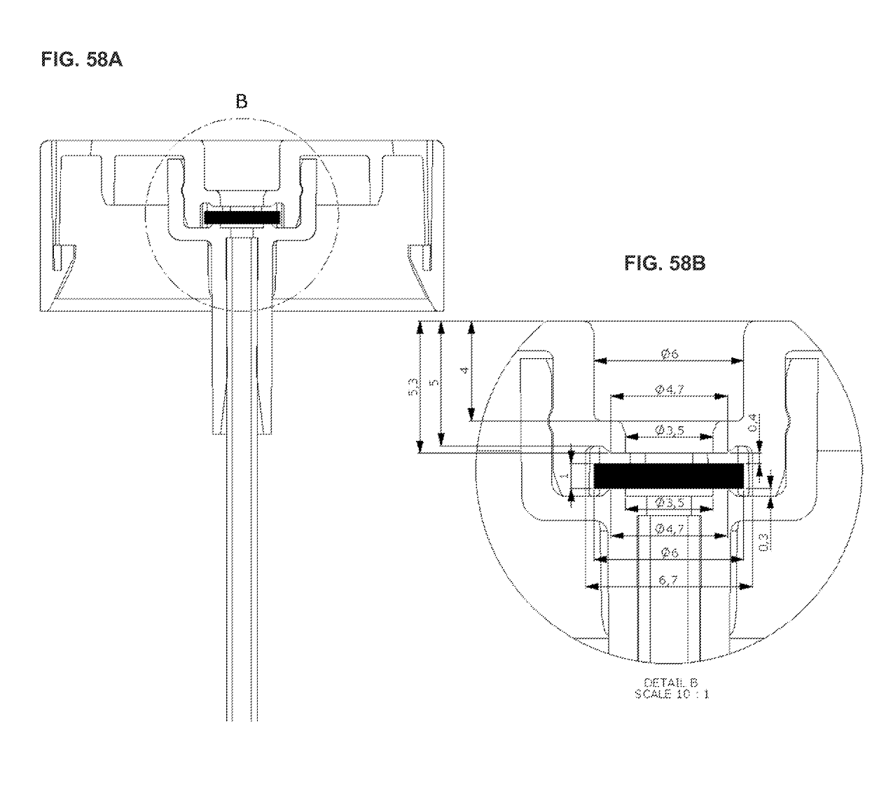

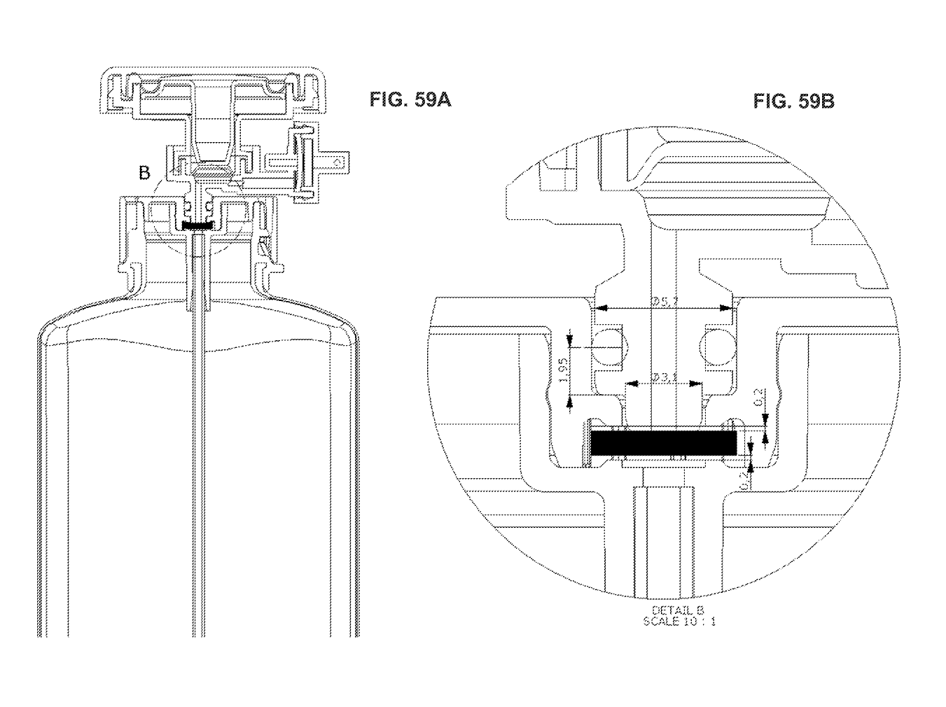

FIG. 58 show exemplary dimensions of the shuttle inlet valve, as do FIG. 59.

Normally Closed Valve

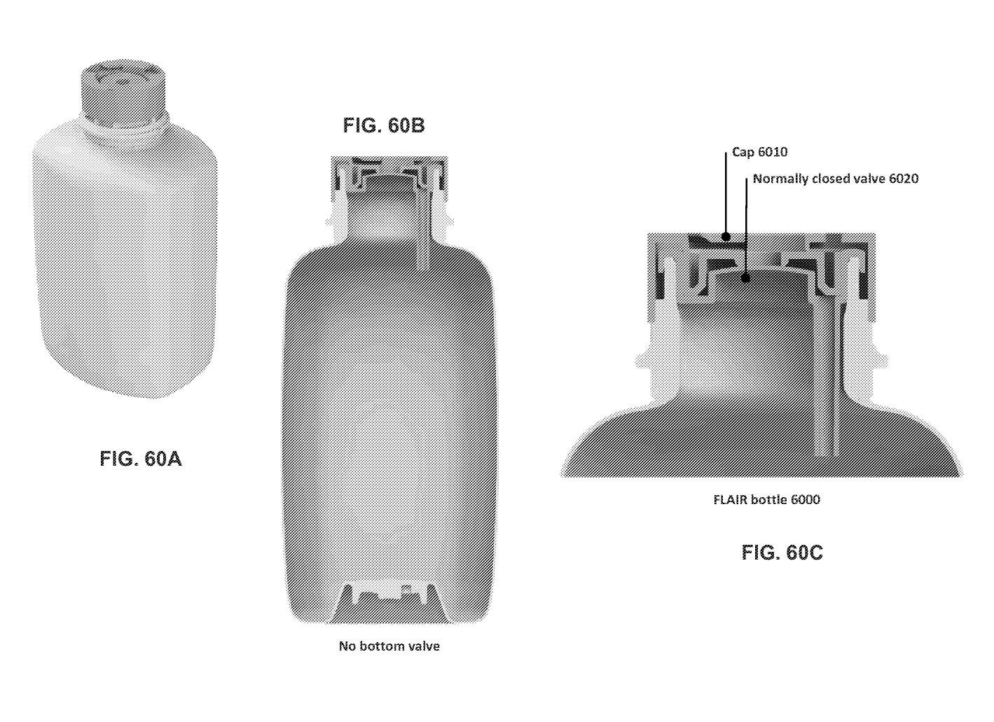

FIG. 60 show a different type of valve which can be used in a closure according to various exemplary embodiments of the present invention. The valve shown in FIG. 60 is a closure with a normally closed valve. That means a valve that is in general closed unless pressure is applied from above to allow fluid to flow. As can be seen in FIG. 60B, similar to the case of the bottle of FIG. 53B, there is no bottom valve provided in the bottle. FIG. 60C shows a magnified view of the cap and normally closed valve where the valve is pushed up against the bottom of the cap by various means such as, for example, pre-compression as described above.

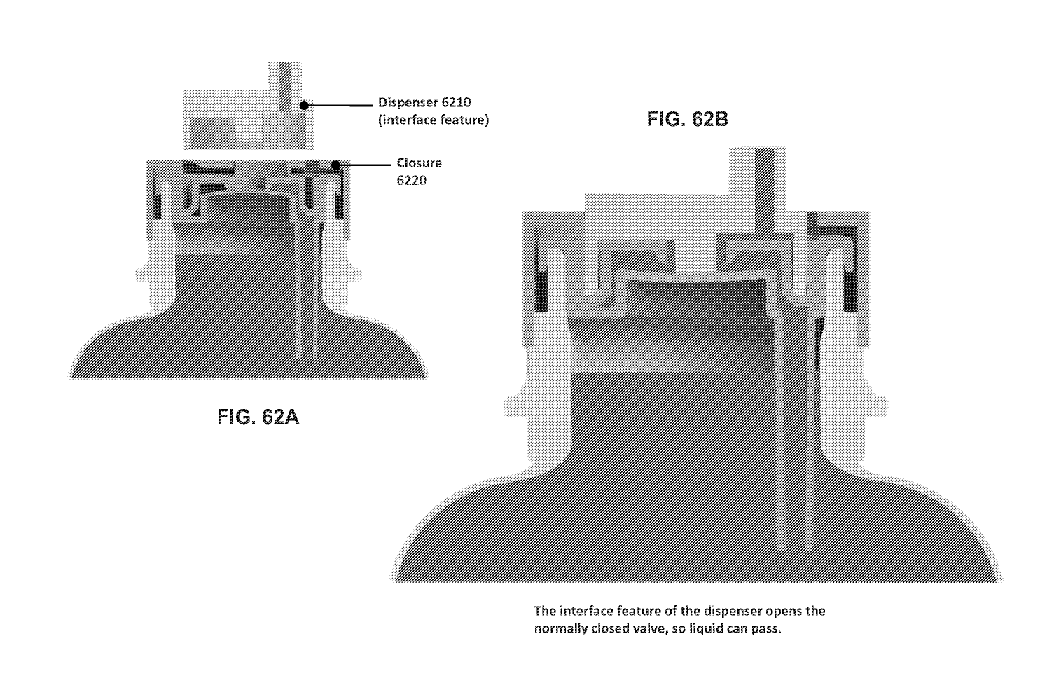

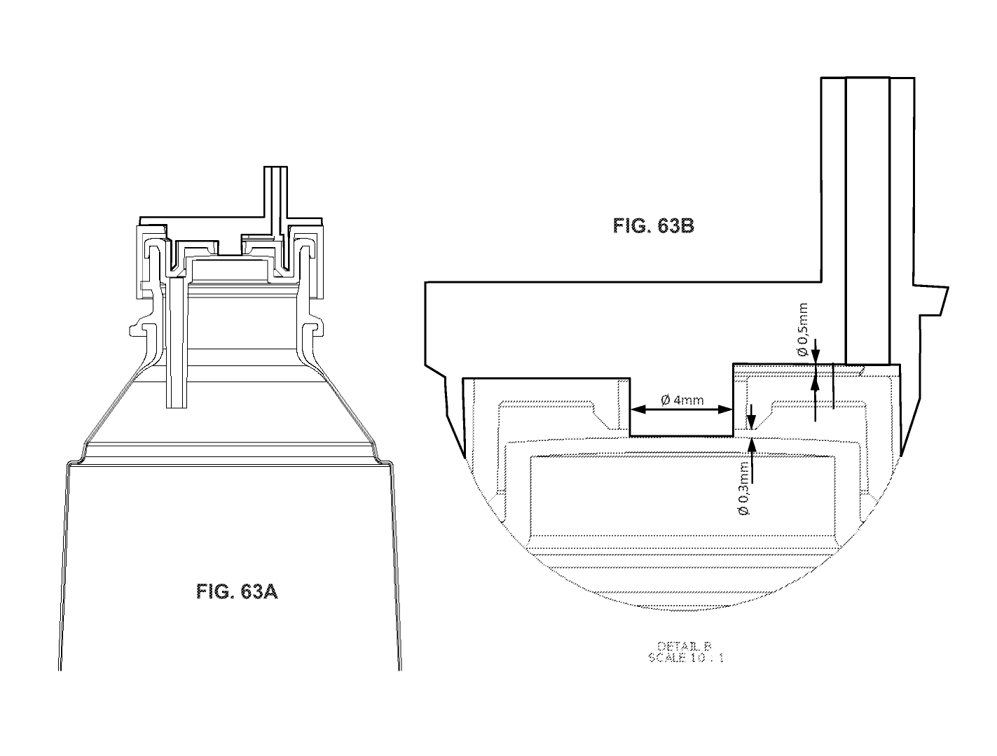

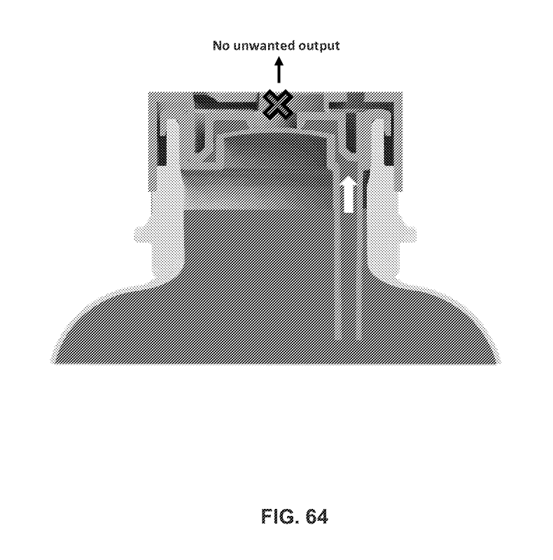

FIG. 63 illustrate exemplary interfacing dimensions of the closure with normally closed valve of FIG. 62. Next, FIG. 64 illustrate some of the features and functionalities of the closure with normally closed valve. As shown, when the Flair bottle is squeezed or held upside down, no liquid will leave the bottle because the valve is normally closed and requires a pressure on top of it to open it. Therefore, a feature integrated in a dispensing head, of the various types described above, is needed to push the valve open.

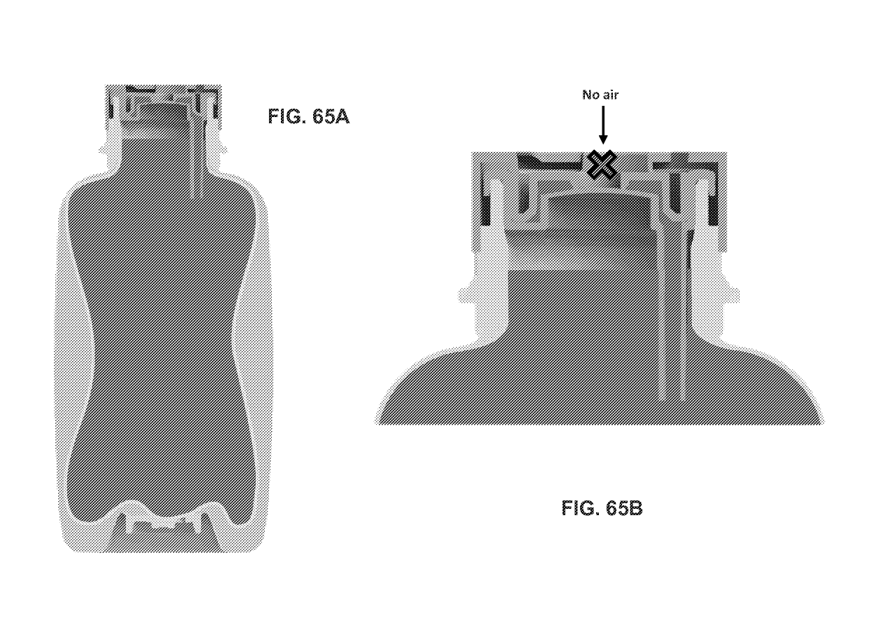

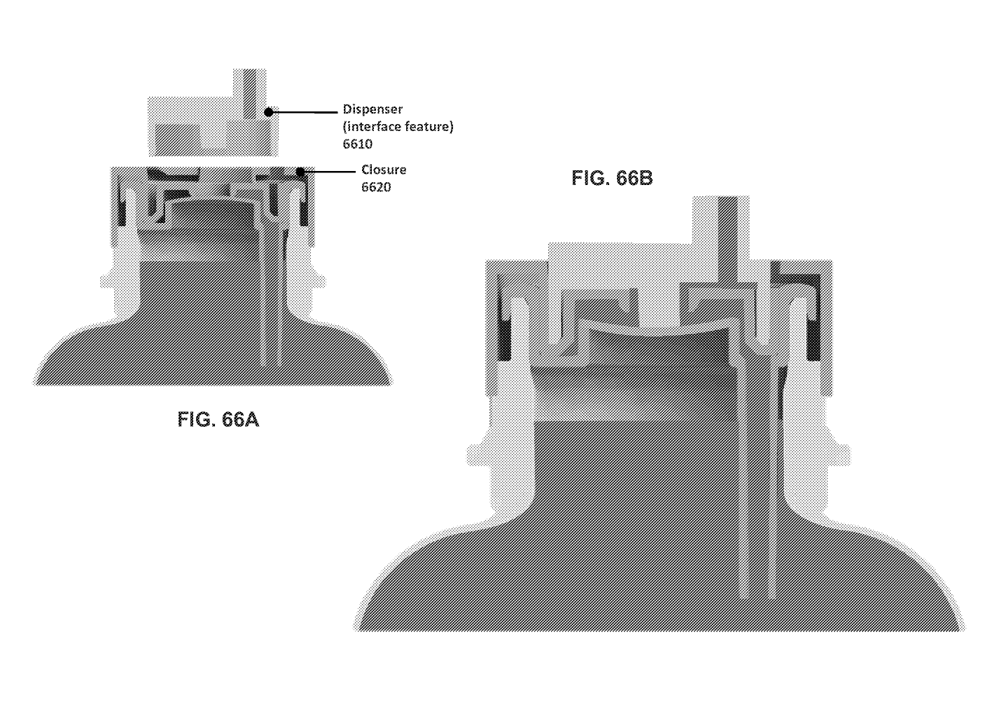

FIG. 65 further elaborate on this functionality. Thus, as shown in FIG. 65A, the inner layer will never sag because, as shown in FIG. 65B, the normally closed valve closes off the outlet due to pretention or pre-compression. When the refill bottle is taken out of the device the normally closed valve immediately closes. As a result air cannot enter the inside layer and therefore the inner layer of the Flair bottle will not sag. Similarly, FIG. 66 show how the closure with normally closed valve can interface with an exemplary dispenser according to exemplary embodiments of the present invention. As shown, a dispenser or interface feature 6610 pushes down on the central hole of the closure or the cap of closure 6620 and the result is shown in FIG. 66B where there is a protrusion from the interface feature similar to that described above in connection with the shuttle valve and thus in FIG. 66B the interface feature of the dispenser opens the normally closed valve so that liquid can pass through the dip tube up through the valve into the dispenser or the dispensing head. As noted above in connection with the closure with integrated shuttle inlet valve, the same interfacing can be used between a Flair bottle provided with the closure with normally closed valve and any over-pressure or under-pressure pump or dispensing head according to the various exemplary embodiments of the present invention.

Trigger Flair

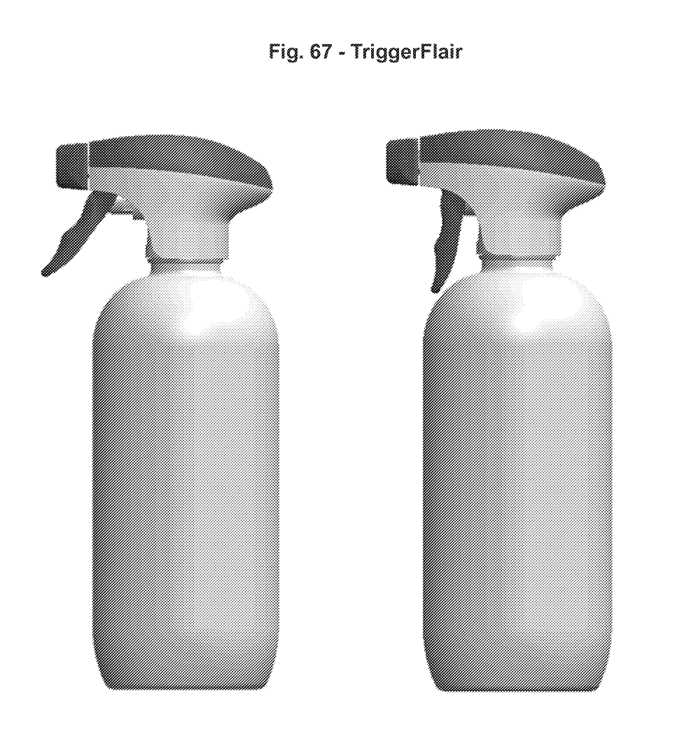

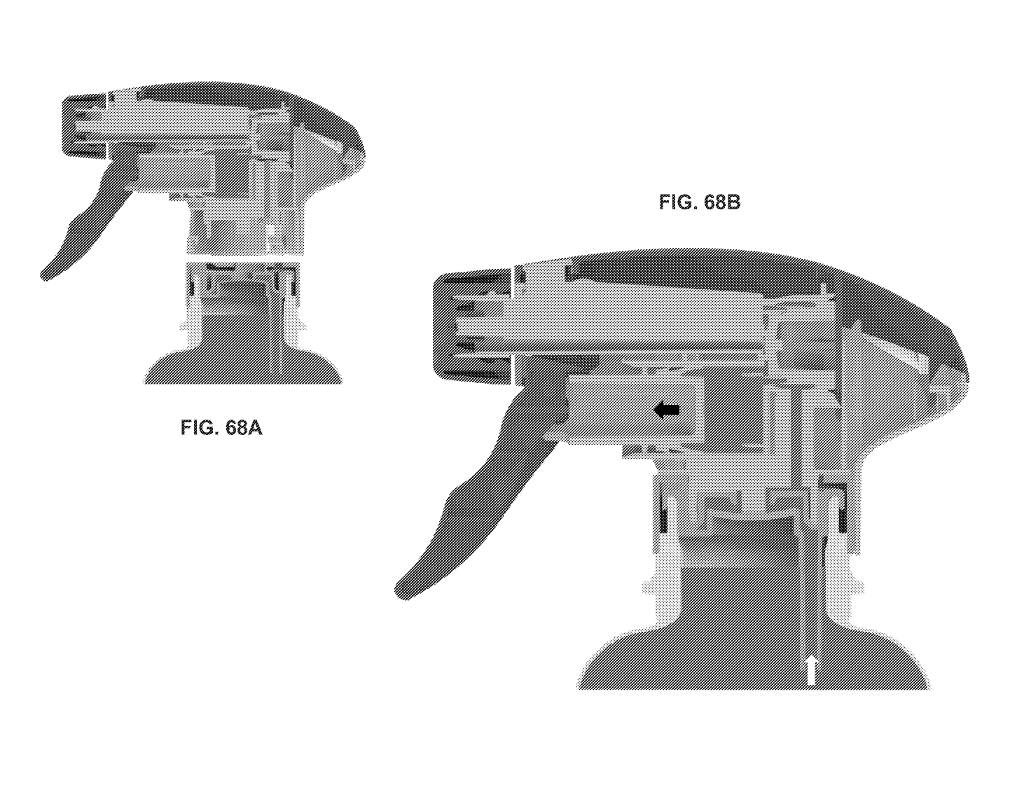

FIGS. 67-68 illustrate a trigger Flair type sprayer comprising a bottle with a trigger Flair type dispensing head and as shown in FIG. 68 the bottles provided with a normally closed valve as described above in connection with FIGS. 60 through 66. Thus in FIG. 68 a trigger sprayer head is put on the bottle with an integrated normally closed valve and as shown in FIGS. 68b the interface feature protrudes touching the center of the normally closed valve, here a dome type lastomeric valve and a fluid communication canal is open.

Multi-Liquid Dispensing

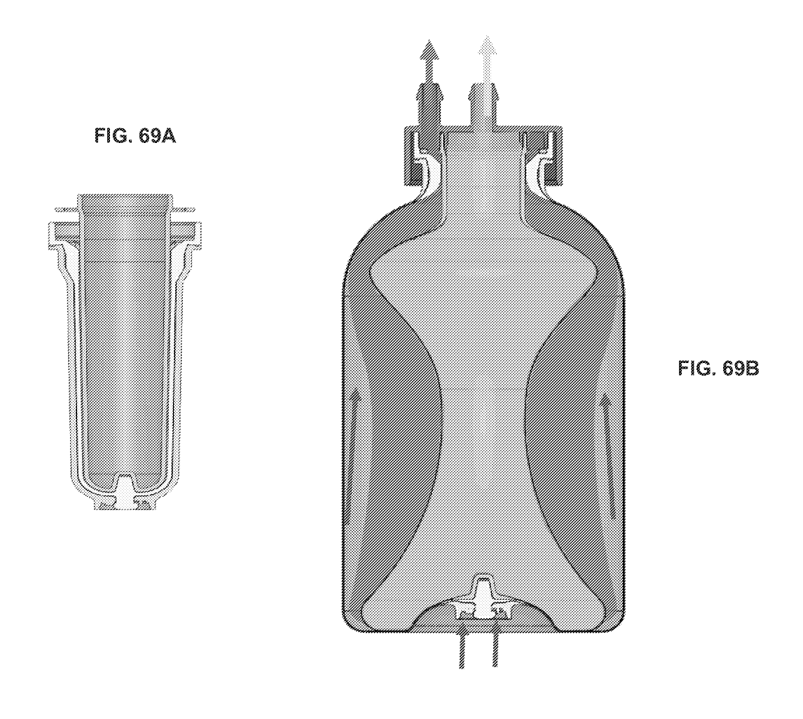

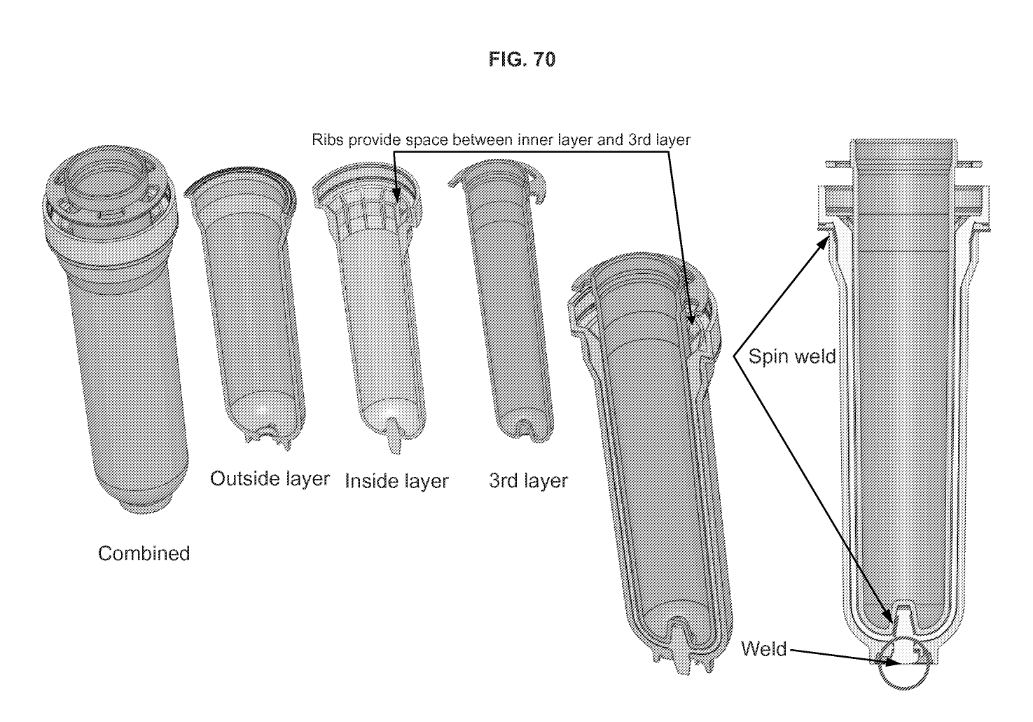

Finally, FIGS. 69-73 illustrate details of multi-liquid dispensing according to exemplary embodiments of the present invention. With reference to FIG. 69A, there is shown a pre-form which is constructed to be ultimately blows into the bottle of FIG. 69B. It is noted that this is a Flair bottle with two nested inner containers. There is a central inner container depicted in light green and an outer inner container depicted in pink and outside of that is the normal gap between the outer container and the inner container where the propellant is introduced. FIG. 70 show details of the various layers of the pre-form of FIG. 69A. Thus, moving from left to right in FIG. 70 one first sees the combined pre-form as fully assembled and then the outside layer, inside layer, third layer which is the innermost inner container layer, are shown. Additionally, it is shown how there are ribs that provide the space between the inner layer and the third layer and there is a combined cross-section shown to the right of the third layer. It is noted that the inside layer can be attached to the outside layer by spin-welding and a fully assembled cross-section of the preform is shown at the far right of FIG. 70.

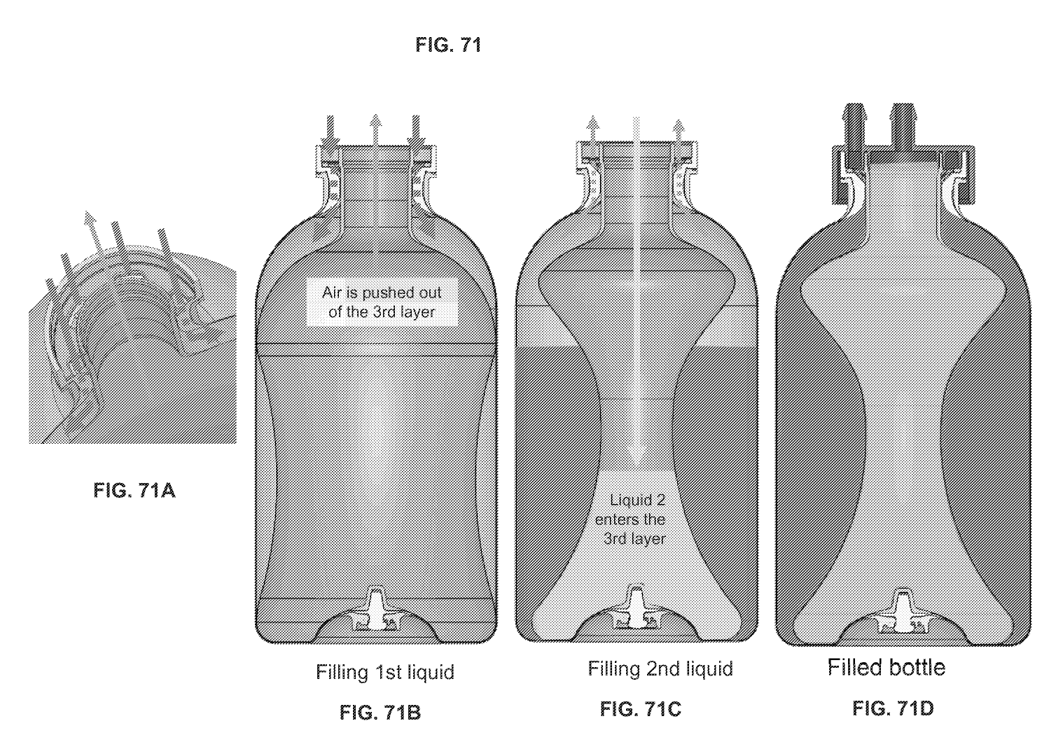

FIG. 71 illustrate the process of filling the double inner-container Flair bottle according to exemplary embodiments of the present invention. As shown in FIG. 71A, first a liquid 1 or first liquid is introduced between the inner layer and the third layer. As shown in FIG. 71B, as a result air is pushed out of the third layer (the third layer being, again, the inner-most layer of the Flair bottle). It is noted that the air is depicted with the vertical blue arrow and the liquid 1 is depicted with the pink arrows in FIG. 71. Continuing with FIG. 71C, the second liquid (shown in yellow) is introduced into the third layer. This further pushes out air from the inner layer where the pink liquid or liquid 1 has been filled. When this process is completed the third layer is filled with the liquid 2 and that squeezes the liquid 1 all the way to the top and we see the fully filled bottle of FIG. 71D.

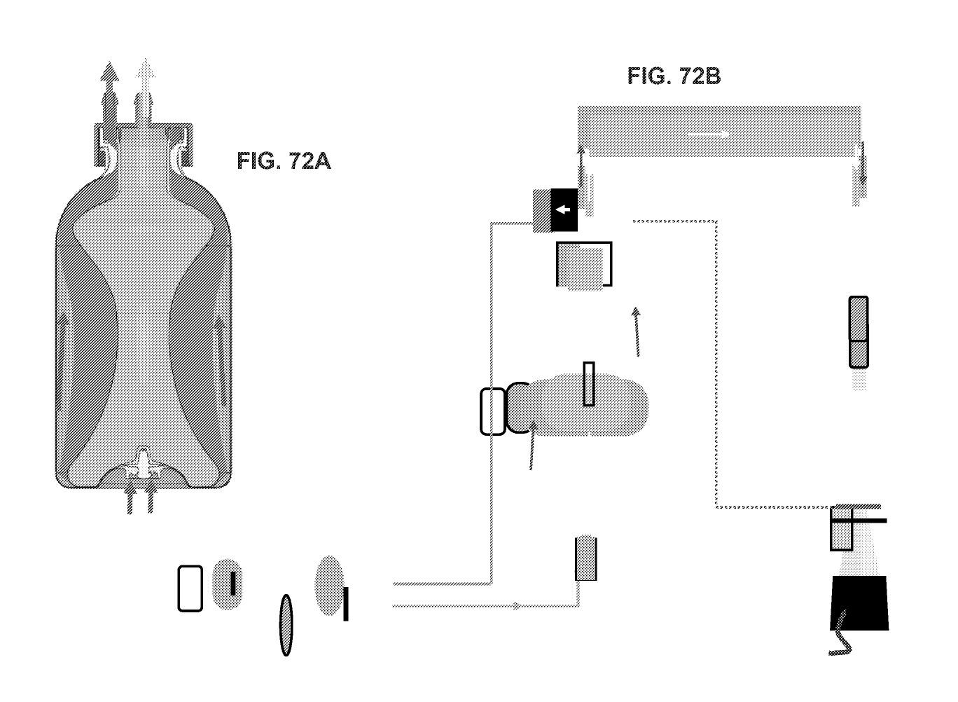

Finally, FIG. 72 illustrate the two applications where the multi-liquid Flair bottle can be used; one is a standard multi-liquid Flair bottle which can be provided in combination with a two-liquid dispensing head as shown in FIG. 72A, and additionally there is a FIG. 72B which depicts a paint Flair automatic painting liquid dispensing system, where the multi-liquid Flair bottle is automatically pressurized by a pump and there is a paint brush handle out of which the two liquids can be mixed and dispensed.

The above-presented description and figures are intended by way of example only and are not intended to limit the present invention in any way except as set forth in the following claims. It is particularly noted that the persons skilled in the art can readily combine the various technical aspects of the various exemplary embodiments described.

What is claimed is:

1. A dispensing system, comprising:
a bottle comprising an inner container and an outer container, the inner container arranged to hold a fluid;
a valve integrated in the bottle;
a dispensing head removably attached to the bottle above the valve, said dispensing head being in fluid communication with the inner container through said integrated valve, and said dispensing head containing:
a fluid chamber;
a normally closed outlet valve, a first side of said outlet valve closably connected between said fluid chamber and an outlet channel, and a second side of said outlet valve exposed to a pressure circuit;
a piston communicably connected on a first end to the fluid chamber and on a second end to the pressure circuit,
wherein a propellant in the pressure circuit and the fluid are at all times separated upstream of the outlet channel.

2. The dispensing system of claim 1, wherein the propellant in the pressure circuit and the fluid are at all times separated.

3. The dispensing system of claim 1, wherein the fluid is output as one or more of a stream, a spray, a wide spray and drops.

4. The dispensing system of claim 1, wherein the propellant in the pressure circuit is mixed with the fluid in the output channel at dispensing, so as to create one of an atomized spray, a foam and a dense foam.

5. The dispensing system of claim 1, wherein in operation the air first reaches a nozzle provided at the end of the outlet channel, then the liquid reaches the nozzle and mixes with the air.

6. The dispensing system of claim 5, wherein the air/liquid mix leaves the nozzle as an aerosol-like spray.

7. A method of dispensing a fluid, comprising:
providing a bottle comprising an inner container and an outer container, the inner container arranged to hold a fluid;
providing a dispensing head removably attached to the bottle, said dispensing head being in fluid communication with the inner container;
providing a fluid circuit and a propellant circuit in the dispensing head, the fluid circuit in fluid communication with the inner container, the propellant circuit in fluid communication with the outer container;
separately controlling the fluid circuit and the propellant circuit, and only optionally allowing them to mix in a nozzle at dispensing; and
using propellant from said separately controlled propellant circuit to control one or more of cleaning a spout or output channel, making foam or spray, controlling valves, pistons or pumps, and making noise.

8. The method of claim 7, further comprising making the bottle captive.

9. The method of claim 8, wherein said captivity is facilitated by an integrated one-way valve in a closure of said bottle.

10. The method of claim 9, wherein said one way valve is one of a normally closed valve and a shuttle valve.

11. The system of claim 1, wherein the bottle's valve is a one way valve, and the dispensing head is attached to the bottle in such manner so as to open the integrated one way valve and allow fluid flow from the bottle to the dispensing head.

12. The system of claim 11, wherein said one way valve is one of a shuttle valve, a dome valve and an elastomeric valve.

13. The system of claim 11, wherein propellant in the pressure circuit is used to control one or more of cleaning a spout or output channel, making foam or spray, controlling valves, pistons or pumps, and making noise.

14. The system of claim 11, wherein propellant in the pressure circuit is maintained at a defined pressure by a pump.

15. The system of claim 1, wherein in a default state normally closed outlet valve has no pressure difference across it, and in a dispensing state normally closed outlet valve has a pressure difference across it.

16. The system of claim 15, wherein in said default state the pressure of fluid and the pressure of propellant in the pressure circuit are equal.

17. The system of claim 15, wherein in said dispensing state, as seen by said normally closed valve, the pressure of fluid is greater than the pressure of propellant in the pressure circuit.

18. The system of claim 1, wherein in operation one of non metered fluid, non metered mix of fluid and propellant, metered fluid and metered mix of fluid and propellant are dispensed.

19. The system of claim 18, wherein said dispensing is actuated by one of manually, sensing of presence of body part, pressure sensor, and microswitch.

20. The system of claim 1, wherein said a normally closed outlet valve is one of a dome valve and a needle closing dome valve.
